(19) United States
(12) Patent Application Publication
(10) Pub. No.: US 2012/0084040 A1
(43) Pub. Date: Apr. 5, 2012

(54) Systems And Methods Of Channel Identification Machines For Channels With Asynchronous Sampling

(75) Inventors: Aurel A. Lazar, New York, NY (US); Yevgeniy B. Slutskly, Brooklyn, NY (US)

(73) Assignee: THE TRUSTEES OF COLUMBIA UNIVERSITY IN THE CITY OF NEW YORK, New York, NY (US)

(21) Appl. No.: 13/249,692

(22) Filed: Sep. 30, 2011

Related U.S. Application Data
(60) Provisional application No. 61/388,926, filed on Oct. 1, 2010.

(51) Int. Cl. G06F 19/00

(52) U.S. Cl. 702/108

(57) ABSTRACT

Method for identification of at least one parameter of a sampling system includes transmitting at least one input signal to at least one channel of the sampling system; measuring at least one output signal of the sampling system in response to sampling of the at least one input signal by the receiver; and determining, using a processor, the at least one parameter of the sampling system using the at least one input signal and the at least one output signal of the sampling system. A system for identification of at least one parameter relating to a sampling system in response to at least one input signal is also provided.

### CROSS-REFERENCE TO RELATED APPLICATIONS

This application claims priority to U.S. Provisional Patent Application Ser. No. 61/388,926, filed on Oct. 1, 2010, the entirety of the disclosure of which is explicitly incorporated by reference herein.

### STATEMENT REGARDING FEDERALLY-SPONSORED RESEARCH

This invention was made with government support under National Institute of Health Grant No. R01 DC008701-05. The government has certain rights in the invention.

### BACKGROUND

The present application relates to systems and methods for identification of parameters of Time Encoding Machines (TEMs) or other asynchronous circuits that encode analog information in the time domain.

Many technologies are available for data acquisition, which is the process of converting physical data (for example, sounds and images) into a digital or analog signal. Data acquisition can be used in biological systems using neurons.

TEMs can be a low-power and low-bandwidth alternative to classical samplers that provide an interface between the analog physical world and the digital signal processing stage in many modern electronic devices. They can arise as models of (nonlinear) samplers in signal processing, as models of sensors, analog-to-discrete (A/D) converters and data acquisition systems in communications, as well as models of sensory systems in neuroscience.

While TEMs and other systems are available for data acquisition, there is a need to be able to accurately identify the parameters of these systems.

### SUMMARY

Systems and methods for identification of parameters of a sampling system are provided herein. According to an embodiment of the disclosed subject matter, a method for identification of at least one parameter of a sampling system can include transmitting at least one input signal to at least one channel of the sampling system; measuring an output signal of the sampling system in response to sampling of the at least one input signal by the receiver; and determining, using a processor, the at least one parameter of the sampling system using the at least one input signal and the output signal of the sampling system.

In some embodiments, the sampling system is a time encoding machine (TEM). The TEM can include a filter and the at least one parameter can include an impulse response of the filter. The output can be a time sequence.

In some embodiments, the TEM can include an integrate-and-fire neuron in series with the filter. The TEM can also include an oscillator in series with the filter. The oscillator can be nonlinear, such as a Hodgkin-Huxley neuron. The nonlinear oscillator can have multiplicative coupling.

According to an aspect of the disclosed subject matter, a system for identification of at least one parameter of a sampling system is provided. An exemplary system for identification of at least one parameter relating to a sampling system in response to at least one input signal can include a sampler having at least one input channel and adapted to receive the at least one input signal thereon and an output channel to generate at least one output signal corresponding to the received at least one input signal; and can include a processor, coupled to the sampler, for transmitting the at least one input signal to the sampler, measuring the at least one output signal of the sampler, and determining the at least one parameter of the sampler using the at least one input signal and the at least one output signal.

### BRIEF DESCRIPTION OF THE DRAWINGS

FIG. 1 is a diagram illustrating a method implemented in accordance with some embodiments of the disclosed subject matter;

FIG. 2 is an exemplary system for use with the method of FIG. 1;

FIGS. 3a-3c are diagrams illustrating further embodiments of the system of FIG. 2;

FIG. 4 is a diagram illustrating a further embodiment of the system of FIG. 2;

FIG. 5 is a diagram illustrating a further embodiment of the system of FIG. 2;

FIGS. 6a-6b are diagrams illustrating further details of the method of FIG. 1;

FIGS. 7a-7b are block diagrams illustrating further details of the method of FIG. 1;

FIGS. 8a-8h are diagrams illustrating further details of the method of FIG. 1;

FIGS. 9a-9h are diagrams illustrating further details of the method of FIG. 1;

FIGS. 10a-10h are diagrams illustrating further details of the method of FIG. 1;

FIGS. 11a-11g are diagrams illustrating further details of the method of FIG. 1;

FIGS. 12a-12b are diagrams illustrating further details of the method of FIG. 1;

FIG. 13 is a block diagram illustrating further details of the method of FIG. 1;

FIGS. 14a-14h are diagrams illustrating further details of the method of FIG. 1;

FIGS. 15a-15g are diagrams illustrating further details of the method of FIG. 1;

FIGS. 16a-16h are diagrams illustrating further details of the method of FIG. 1;

FIGS. 17a-17b are diagrams illustrating further details of the method of FIG. 1;

FIGS. 18a-18b are block diagrams illustrating further details of the method of FIG. 1;

FIGS. 19a-19f are block diagrams illustrating further details of the method of FIG. 1;

FIGS. 20a-20b are diagrams illustrating further details of the method of FIG. 1;

FIGS. 21a-21h are diagrams illustrating further details of the method of FIG. 1;

FIG. 22 is a block diagram illustrating a system in accordance with some embodiments of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

One aspect of the disclosed subject matter relates to systems and methods for identification of parameters of a sampling system. Particularly, the disclosed subject matter relates to identification of parameters of Time Encoding Machines (TEMs) or other asynchronous circuits that encode analog information in the time domain. Additionally, the disclosed subject matter can be used to identify aggregate dendritic processing of neurons in biological sensory systems.

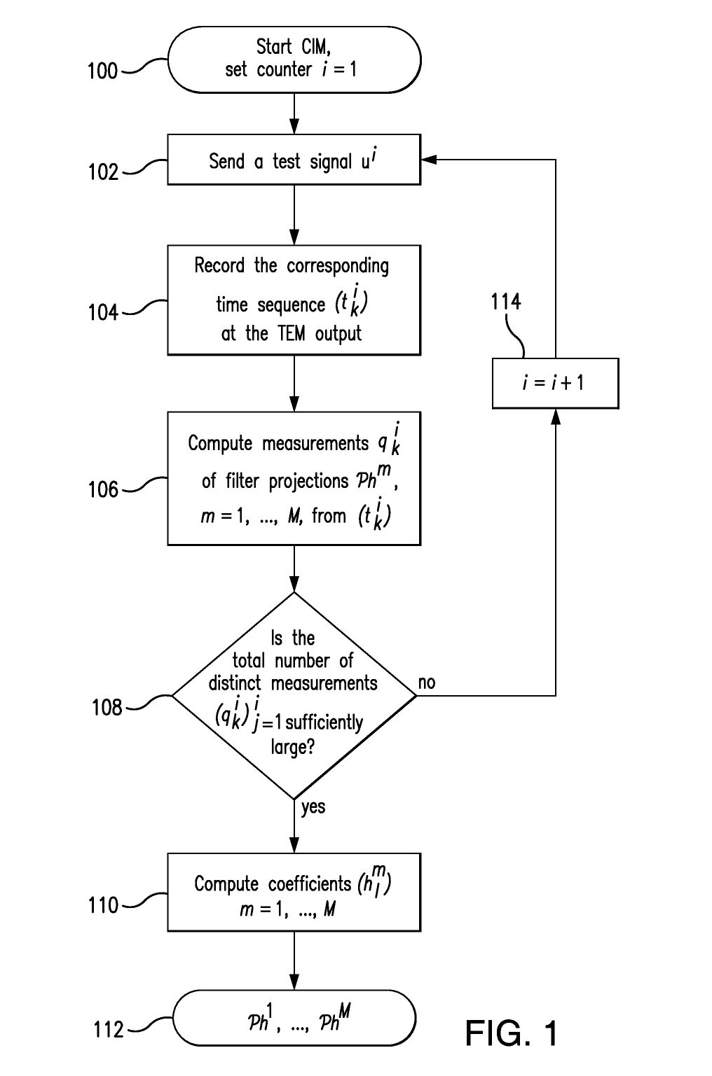

FIG. 1 is a diagram showing an exemplary method for identifying parameters of a sampling system according to the disclosed subject matter. At 100, a channel identification machine (CIM) is started. Starting the CIM can include initializing various components, such as setting a counter to an initial value. At 102, the CIM sends a test signal, or a plurality of test signals, to the sampling system, which can be embodied, for example, as a TEM. At 104, the CIM records an output from the sampling system corresponding to the test signal input. The output can be, for example, a time sequence. At 106, the CIM deter mines measurements of filter projections using the test signal and the corresponding output from the sampling system. At 108, the CIM determines whether the total number of measurements of the filter projections is sufficiently large. Whether the total number of measurements is sufficiently large can be determined, for example, by comparing the number of measurements to a threshold value. If the total number of measurements of the filter projections is not sufficiently large, the CIM can increment a counter (at 114) and repeat steps 102-108 using a new test signal or plurality of test signals. If the total number of measurements of the filter projections is sufficiently large, the CIM can determine coefficients representing a filter or a plurality of filters of the sampling system (at 110), At 112, the CIM can identify a projection of the filter or the plurality of filters onto a desired signal or space of input signals.

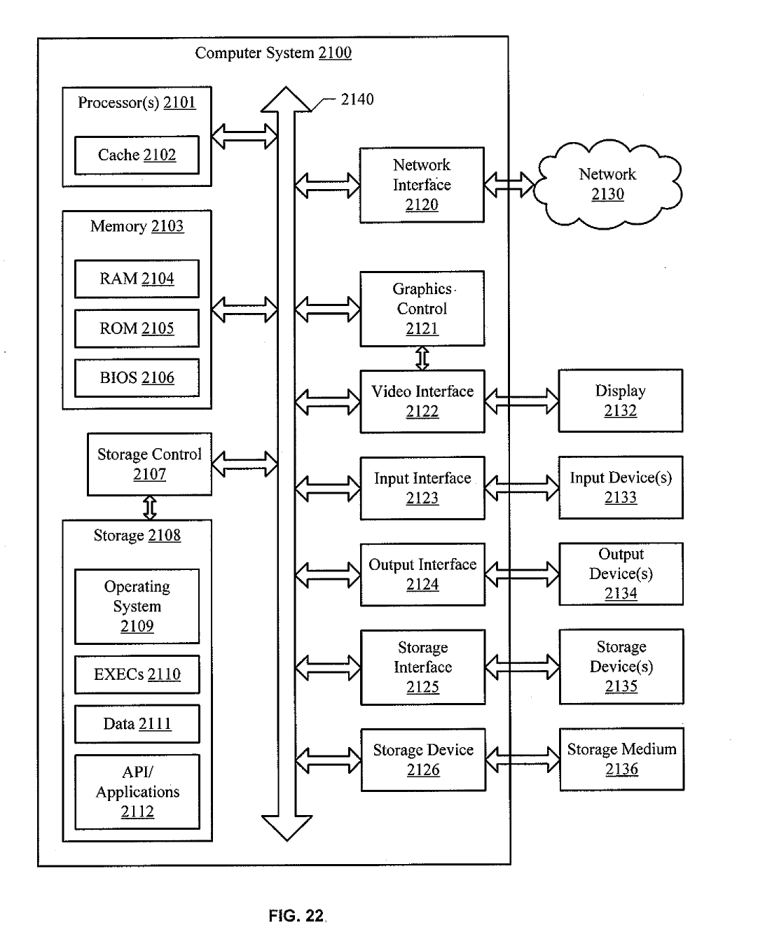

The components of FIG. 1 can be implemented as software modules running on a computer, a processor, or a network of interconnected processors and/or computers that communicate through TCP, UDP, or any other suitable protocol, for example, as shown in FIG. 22. In such an embodiment, each module can be stored in random access memory of a suitable computer, e.g., a workstation computer. The software can be in the form of executable object code, obtained, e.g., by compiling from source code. Source code interpretation is not precluded. Source code can be in the form of sequence-controlled instructions as in Fortran, Pascal or “C,” for example. In addition or as an alternative, the components of FIG. 1 can be implemented as logic hardwired or otherwise embodied in a circuit, including but not limited to an integrated circuit or FPGA, which can operate in place of or together with software to execute particular processes or particular parts of particular processes described herein. Reference to software can encompass logic, and vice versa, where appropriate.

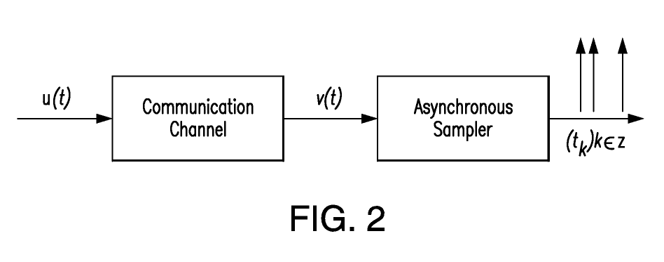

A TEM according to the disclosed subject matter is shown in FIG. 2. An analog (multidimensional) signal u can be passed through a channel (with memory) that models physical communication links. The effect of the channel on the signal u can be described by a linear (multidimensional) filter. The output of the channel v can be then mapped (encoded) by a nonlinear (asynchronous) sampler into the time sequence (tₖ)k∈ [symbol] . An asynchronous sampler can include (asynchronous) A/D converters, such as one based on an asynchronous sigma/delta modulator (ASDM), nonlinear oscillators, such as a van der Poi oscillator in cascade with a zero-crossing detector (ZCD), and spiking neurons, such as an integrate-and-fire (IAF) or a threshold-and-fire (TAF) neuron. The latter can be a threshold crossing device known as a Lebesgue sampler. The above-mentioned asynchronous sampler models can incorporate the temporal dynamics of spike (pulse) generation and can provide, for example, nonlinear spike generation (sampling) mechanisms with biological properties suitable for neuroscience applications.

Channel identification for channels having asynchronous sampling, particularly as in time encoding, includes receiving both the input and the corresponding time sequence at the output of a TEM, and identifying the processing elements of the encoder. Such channel identification can be useful for neural encoding and processing, process modeling and control, nonlinear signal processing, and, in general, methods for constructing mathematical models of dynamical systems. Identification of a TEM having a channel and an asynchronous sampler can include providing input (test) periodic signals belonging to the space of bandlimited functions, a class of functions having a finite support in the frequency domain. Bandlimited signals can be used to model signals in communication systems and to describe sensory stimuli encountered in biological systems. Although bandlimited signals are used as one example for the purpose of discussion herein, systems and methods for channel identification described herein can be applied to a wide variety of input signals or input signal spaces, including Hilbert spaces and Reproducing Kernel Hilbert Spaces such as Paley-Wiener spaces, spaces of trigonometric polynomials, Sobolev spaces, or any other suitable signals or signal spaces. Channel identification according to the disclosed subject matter uses a class of test signals that is not white, which can be in contrast to other known methods.

According to one aspect of the disclosed subject matter, (periodic) bandlimited signals belonging to the finite-dimensional space of trigonometric polynomials can be used to show that the identification of the channel (filter) in a noiseless single-input single-output (SISO) variant of FIG. 2 can become mathematically tractable.

According to another aspect of the disclosed subject matter, A SISO channel identification machine (CIM) is provided. A SISO CIM, under certain conditions, can be used to identify the projection of the filter onto the space of trigonometric polynomials relatively free of loss. Moreover, A SISO CIM algorithm can recover the original filter with arbitrary precision, provided both the bandwidth and the order of the input (test) space are sufficiently high.

According to another aspect of the disclosed subject matter, a multi-input single-output (MISO) variant of the TEM in FIG. 2 is provided, where the input signals are multi-dimensional. A MISO CIM algorithm can demonstrate identification of the vector-valued filter modeling the channel.

According to another aspect of the disclosed subject matter, a class of input (test) signal spaces can be provided and can be used to provide channel identification algorithms for the infinite-dimensional Paley-Wiener spaces. Furthermore, the disclosed subject matter can be applied to noisy systems, where additive noise is introduced either by the channel or the sampler, and a suitable estimate of the channel can be found.

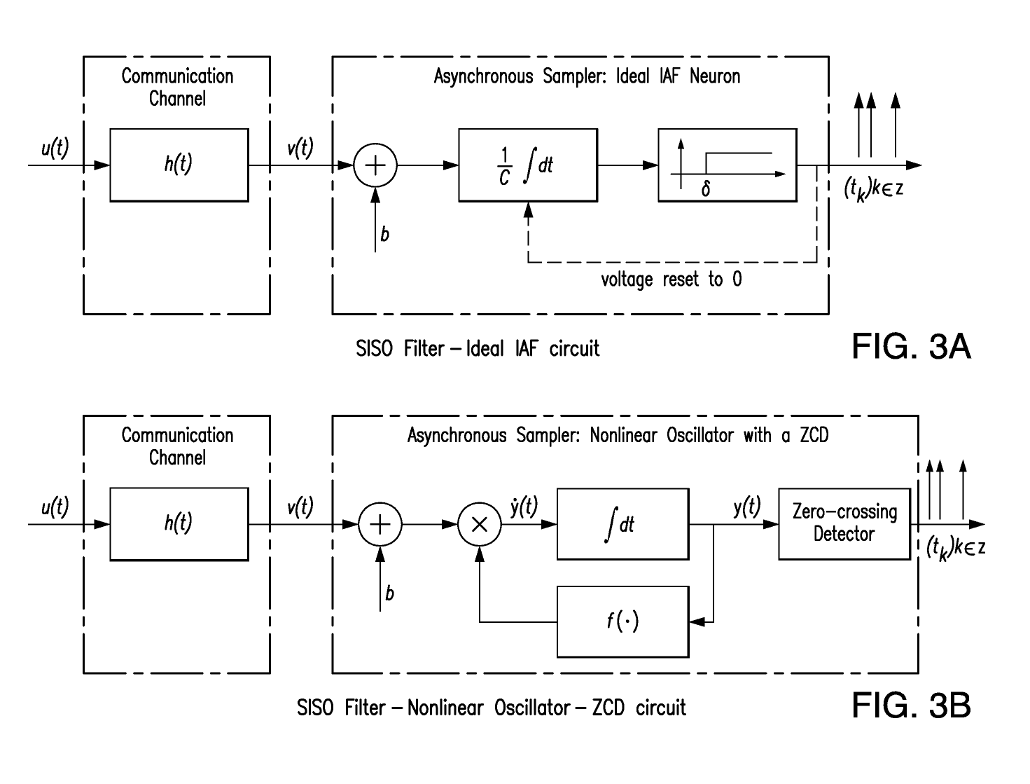

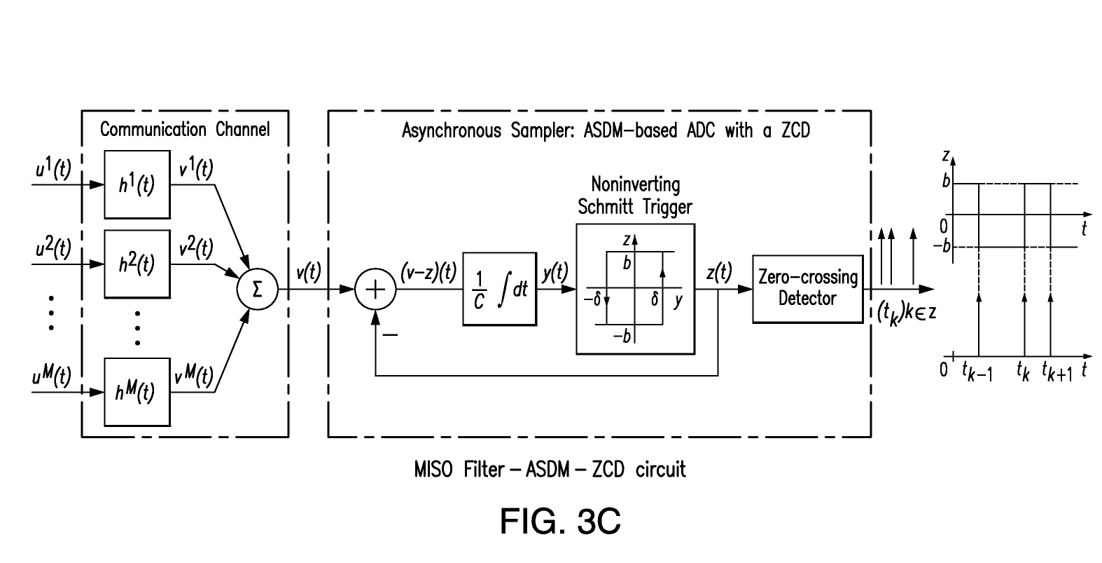

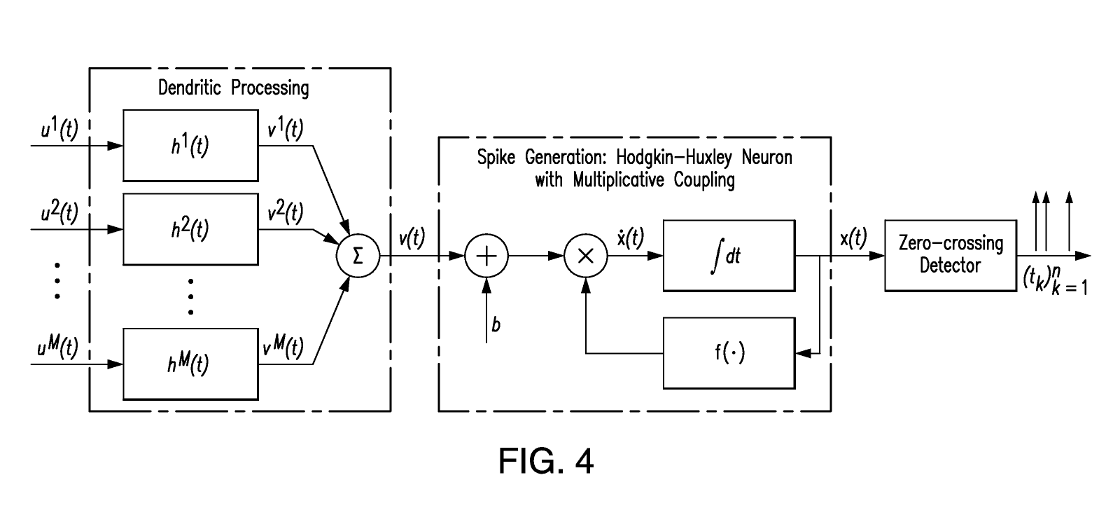

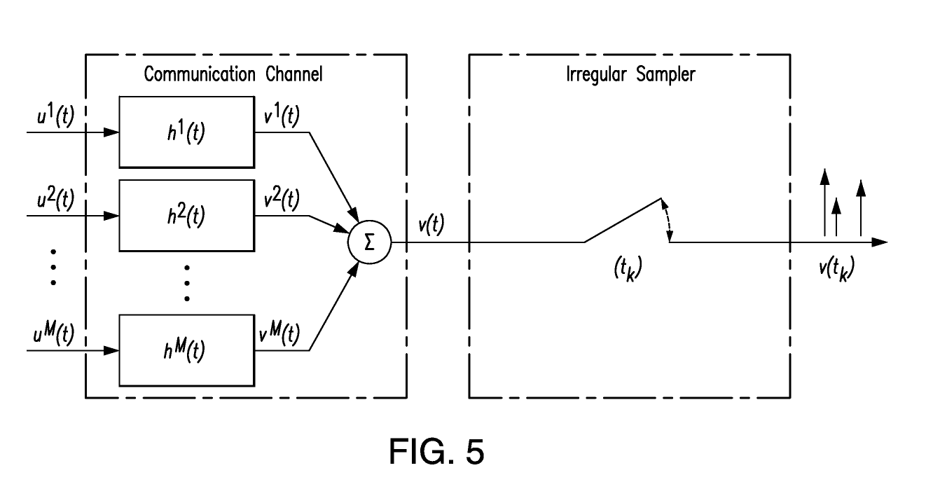

With reference to FIGS. 3a-5, exemplary embodiments of the TEM system of FIG. 2 arising in neuroscience and communications are provided. FIG. 3a shows an exemplary single-input single-output model of a sensory neuron. In this embodiment, the filter can describe dendritic processing. FIG. 3b shows an exemplary single-input single-output nonlinear oscillator in cascade with a zero-crossing detector. In this embodiment, the filter can describe preprocessing on a signal of interest or a communication link. FIG. 3c shows an exemplary multi-input single-output analog-to-discrete converter, which can be implemented with an asynchronous sigma-delta modulator in cascade with a zero-crossing detector. M liner filters can model M different communication links. FIG. 4 shows an exemplary multi-input single-output filter-Hodgkin-Huxley neuron with multiplicative coupling circuit. In this embodiment, the filter can describe dynamical processing. FIG. 5 shows an exemplary system having an irregular sampler. An exemplary TEM system having an irregular sampler is further shown and described in U.S. application Ser. No. 12/645,292, the entirety of the disclosure of which is explicitly incorporated by reference herein. The systems of FIGS. 3a-5 are exemplary embodiments for use with the disclosed subject matter, and are provided for the purpose of discussion. However, a person having ordinary skill in the art would recognize that a wide variety of suitable embodiments of sampling systems exist in accordance with the disclosed subject matter. For example, any of the sensors or samplers used in the above systems can operate with either or both of a single-input single-output (SISO) variant and a multiple-input single-output (MISO) variant in accordance with the disclosed subject matter.

Referring to FIG. 3a, the single-input, single-output (SISO) filter-ideal-integrate-and-fire (Filter-Ideal IAF) neural circuit is shown. The filter can be used to model the aggregate processing of a stimulus performed by the dendritic tree of a sensory neuron. The output of the filter v is encoded into the sequence of spike times (tₖ)k∈z by an ideal integrate-and-fire neuron. Identification of dendritic processing in such a circuit can arise, for example, in systems neuroscience.

Referring to FIG. 3b, the single-input, single-output (SISO) filter-nonlinear-oscillator-zero-crossing-detector (Filter-Nonlinear-Oscillator-ZCD) circuit is shown. In contrast to the embodiment shown in FIG. 3a, where the input was coupled additively, this embodiment provides a TEM with multiplicative coupling that can be encountered in generalized frequency modulation. In this embodiment, the (biased) filter output v is multiplicatively coupled into a (nonlinear) oscillator. The zero-crossing detector can generate a time sequence (tₖ)k∈ [symbol] by extracting the zeros from an observable modulated waveform at the output of the oscillator. Thus, in this exemplary embodiment, the output of the SISO Filter-Nonlinear-Oscillator-ZCD circuit is a time sequence (tₖ)k∈ [symbol] .

Referring to FIG. 3c, a MISO system, embodied as the Filter-Asynchronous-Sigma/Delta-Modulator-Zero-Crossing-Detector (Filter-ASDM-ZCD) circuit is shown. These and similar circuits can be utilized in A/D conversion devices and as front-end components of measurement and communication systems. Each signal u^{m}(t), t∈ [symbol] , m=1, 2, . . . , M, can be transmitted through a communication channel, and the effect of the channel on each signal can be modeled using a linear filter with an impulse response h^{m}(t), t∈ [symbol] , m=1, 2, . . . , M. The aggregate channel output v(t)=Σₘ₌₁^{M}v^{m}(t)=Σₘ₌₁^{M}(u^{m}*h^{m})(t), where u^{m}*h^{M} denotes the convolution of with u^{m} with h^{m}, can be additively coupled into an ASDM. For example, v(t) can be passed through an integrator and a non-inverting Schmitt trigger to produce a binary output z(t)∈{−b,b},t∈ [symbol] . By letting z(t) go through a zero-crossing detector, a sequence of zero-crossing times (tₖ)k∈ [symbol] can be generated. Thus, in this exemplary embodiment, the output of this Filter-ASDM-ZCD circuit is the time sequence (tₖ)k∈ [symbol] .

Referring to FIG. 4, another MISO system, embodied as the filter-Hodgkin-Huxley neuron with multiplicative coupling (Filter-HH/MC) circuit is shown. The Hodgkin-Huxley equations can be written compactly as \dot{x}=f(x), where x=[x₁, x₂, x₃, x₄]^{T}Ξ[V, n, m, h]^{T} and f=[f₁, f₂, f₃, f₄]^{T} is the corresponding vector function. In multiplicative coupling, the biased stimulus u(t)+b>0 modulates the speed of the dynamical system on a stable limit cycle: \dot{x}=(u(t)+b)f(x). A Hodgkin-Huxley neuron with multiplicative coupling can be I/O-equivalent to an ideal IAF neuron with a threshold where δ=T(b), where T(b) is the period of the Hodgkin-Huxley neuron on a stable limit cycle.

Test signals u=[u¹(t), u²(t), . . . , u^{M}(t)]^{T}, t∈ [symbol] can be provided at the input to the exemplary circuits described above as elements of an M-dimensional space of trigonometric polynomials [symbol] ^{M}. More general input spaces are discussed below.

Definition 1. The space of trigonometric polynomials [symbol] is represented as a Hilbert space of complex-valued functions

$$u ( t ) = \frac{1}{\sqrt{T}} {\sum }_{l = - L}^{L} {u}_{l} exp ( \frac{j l Ω t}{L} ) , t ∈ [ 0 , T ] . \qquad ( 1 )$$

where uₗ∈ [symbol] , Ω is the bandwidth, L is the order and T=2πL/Ω, endowed with the inner Product [symbol] •, • [symbol] : [symbol] × [symbol] →

[symbol]

[symbol]

u, ω [symbol] =∫₀^{T}u(t) ω̅(̅t̅)̅dt (2)

Given the inner product in eq. (2), the set of elements

$${ɛ}_{l} ( t ) = \frac{1}{\sqrt{T}} exp ( \frac{j l Ω t}{L} ) . l = - L , - L + 1 , … , L , \qquad ( 3 )$$

forms an orthonormal basis in [symbol] . Thus, any element u∈ [symbol] and any inner product [symbol] u, w [symbol] can be compactly written as u=Σₗ₌₋^{L}uₗeₗ and [symbol] u, ω [symbol] =Σ_{l=-L}^{L}uₗ ω̅ₗ̅. Moreover, [symbol] can be a reproducing kernel Hilbert space (RKHS) with a reproducing kernel (RK) given by

$$\begin{matrix}K ( s , t ) = {\sum }_{l = - L}^{L} {e}_{l} ( s ) \overline{{e}_{l} ( t )} \\ = \frac{1}{\sqrt{T}} {\sum }_{l = - L}^{L} {e}_{l} ( s - t ) \\ = \frac{1}{T} {\sum }_{l = - L}^{L} exp ( \frac{j l Ω}{L} ( s - t ) ) ,\end{matrix} \qquad ( 4 )$$

also known as a Dirichlet kernel.

It is noted that a function u∈ [symbol] can satisfy u(0)=u(T) There can be a natural connection between functions on an interval of length T that take on the same values at interval end-points and functions on [symbol] that are T-periodic: both can provide equivalent descriptions of a similar mathematical object, such as a function on a circle. Herein below, u can denote both a function defined on an interval of length T and a function defined on the entire real line. In the latter case, the function u can be simultaneously periodic with period T and bandlimited with bandwidth Ω, i.e., it can have a finite spectral support supp( [symbol] u)⊂ [−Ω, Ω], where [symbol] denotes the Fourier transform. Herein below, uₗ≠0 for all 1=−L, −L+1, . . . , L, i.e. a signal u∈ [symbol] can contain all 2L+1 frequency components. However, it should be noted that some signals can have some signal components equal to 0, so long as the entirety of the set of signals can contain all 2L+1 frequency components.

As described above, the exemplary embodiments of FIGS. 3a-5 can include a channel and an asynchronous sampler. In the description below, the structure and the parameters of the asynchronous sampler can be known or can be suitably identified.

The channel can be a bank of M filters with impulse responses h^{m}, m=1, 2, . . . , M. Each filter can be linear, causal, BIBO-stable and have a finite temporal support of length S≦T i.e., it can belong to the space H={h∈ [symbol] ¹( [symbol] )| supp(h) ⊂ [0,T]}.The length of the filter support can be smaller than or equal to the period of an input signal, and thus for a given S and a fixed input signal bandwidth Ω, the order L of the space [symbol] can satisfy L≧S•Ω/(2π). The aggregate channel output can be given by v(t)=Σₘ₌₁^{M}(u^{m}*h^{m})(t). The asynchronous sampler can map the input signal v into the output time sequence [symbol] =(tₖ)ₖ₌₁ⁿ where n denotes the total number of spikes produced on an interval t∈[0,T].

Definition 2. A signal u∈ [symbol] ^{M} at the input to a Filter-Asynchronous Sampler circuit together with the resulting output [symbol] =(tₖ)ₖ₌₁ⁿ of that circuit is called an input/output (I/O) pair and is denoted by (u, [symbol] ).

Channel identification of channels having asynchronous sampling can be defined below.

Definition 3. Let (uⁱ), i=1, 2, . . . , N. be a set of N signals from a test space [symbol] ^{M}. A Channel Identification Machine can estimate the impulse response of the filter from the I/O pairs (uⁱ, [symbol] ⁱ), i=1, 2, . . . , N, of the Filter-Asynchronous Sampler circuit.

Remark 1. A CIM can recover the impulse response of the filter based on the knowledge of I/O pairs (uⁱ, [symbol] ⁱ), i=1, 2, . . . , N, and the sampler circuit. In contrast, a Time Decoding Machine can recover an encoded signal u based on the knowledge of the entire TEM circuit (both the channel filter and the sampler) and the output time sequence [symbol] .

With reference to the exemplary embodiment of FIG. 3a, an input signal u∈ [symbol] can be passed through a filter with an impulse response (or kernel) h∈H and then encoded by an IAF neuron with a bias b∈ [symbol] ₄ a capacitance C∈ [symbol] ₄ and a threshold δ∈ [symbol] ₄. The output of the circuit is a sequence of spike times (tₖ)ₖ₌₁ⁿ on the time interval [0,T] that is available to an observer. This neural circuit is an instance of a TEM and its operation can be described by a set of equations (formally known as the t-transform):

∫ₜ_{ₖ}^{t}^{_{k−1}}(u*h)(s)ds=qₖ, k=1, 2, . . . , n−1, (5)

where qₖ=Cδ−b(tₖ₊₁−tₖ). At each spike time tₖ₊₁ the ideal IAF neuron can provide a measurement qₖ of the signal v(t)=(u*h)(t) on the time interval [tₖ, tₖ₊₁) .

Definition 4. The operator [symbol] : H→ [symbol] can be given by

( [symbol] )(t)=∫₀^{T}h(s) K̅(̅s̅,̅t̅)̅ds, (6)

which is also referred to as the projection operator.

The operator [symbol] can map a function h∈H into a function [symbol] h∈ [symbol] and [symbol] ²= [symbol] .

Theorem 1 (Conditional Duality). For all u∈ [symbol] a Filter-Ideal IAF TEM with a filter kernel h is I/O-equivalent to a Filter-Ideal IAF TEM with the filter kernel [symbol] . Furthermore, the CIM algorithm for identifying the filter kernel [symbol] , can be equivalent to the TDM algorithm for recovering the input signal [symbol] , encoded by a Filter-Ideal IAF TEM with the filter kernel u.

Proof: Since u∈ [symbol] , u(t)= [symbol] u(•), K(•, t) [symbol] by the reproducing property of the kernel K(s,t). Hence,

$$\begin{matrix}( u * h ) ( t ) {=}^{( a )} {\int }_{R} h ( w ) u ( t - w ) d w \\ {=}^{( b )} {\int }_{0}^{T} h ( w ) {\int }_{0}^{T} u ( z ) \overline{K ( z , t - ω )} d z d ω = \\ {=}^{( c )} {\int }_{0}^{T} u ( z ) {\int }_{0}^{T} h ( ω ) \overline{K ( w , t - z )} d w d z \\ {=}^{( d )} {\int }_{0}^{T} u ( z ) ( 𝒫 h ) ( t - z ) d z = \\ {=}^{( e )} ( u * 𝒫 h ) ( t ) .\end{matrix} \qquad ( 7 )$$

where (a) can follow from the commutativity of convolution, (b) can follow from the reproducing property of the kernel K and the assumption that supp(h)⊂ [0,T], (c) from the equality K(z,t−w)=K (w,t−z). (d) from the definition of [symbol] in eq. 6, and (e) from the definition of convolution for periodic functions. It follows that on the interval t ∈[0,T], eq. 5 can be rewritten as

$${\int }_{{t}_{k}}^{{t}_{k + 1}} ( u * 𝒫 h ) ( s ) d s {=}^{( f )} {\int }_{{t}_{k}}^{{t}_{k + 1}} ( 𝒫 h * u ) ( s ) d s = {q}_{k} , \\ k = 1 , 2 , … , n - 1. \qquad ( 8 )$$

where (f) comes from the commutativity of convolution. The right-hand side of eq. 8 can represent the t-transform of a Filter-Ideal IAF TEM with an input [symbol] and a filter that has an impulse response u. It follows that a TDM can identify [symbol] , given a filter-output pair (u, [symbol] ).

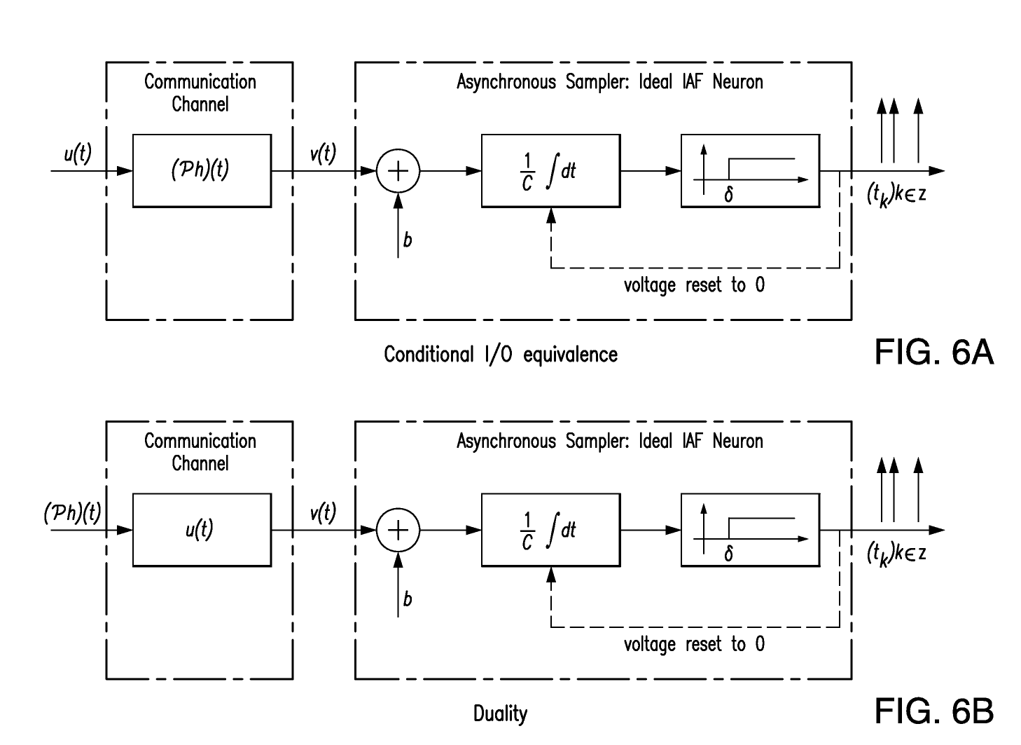

FIGS. 6a-6b illustrate a conditional duality between channel identification and time encoding. In FIG. 4a, for all u∈ [symbol] the Filter-Ideal IAF circuit with an input-filter pair (u, h) can be I/O equivalent to a Filter-Ideal IAF circuit with an input-filter pair (u, Ph). In FIG. 6b, the input-filter pair (u, Ph) in channel identification can be dual to the (Ph, u) pair in time encoding. A conditional I/O equivalence can exist between the exemplary circuit shown in FIG. 6a and the exemplary circuit shown in FIG. 3a. The equivalence can be conditional since [symbol] can be a projection on a particular input signal space and the two circuits can be I/O-equivalent only for signals in that space. The conditional I/O equivalence represents a difference between time encoding and channel identification. For example, time encoding can differ from channel identification because, unlike time encoding, the power of channel identification can depend on the rich structure of the space of test signals. Further, identifying the filter of the exemplary circuit in FIG. 6a can involve decoding the signal encoded with the exemplary circuit in FIG. 6b. The filter projection Ph can be treated as the input to the Filter-Ideal IAF circuit and the signal u can appear as the impulse response of the filter. In other words, channel identification described herein can be represented as a time decoding system, and a TDM system can be used to identify the filter projection ( [symbol] )(t) on t ∈[0,T].

Using the parameters of the asynchronous sampler, the measurements qₖ of the channel output v can be readily computed from spike times (tₖ)ₖ₌₁ⁿ using the definition of qₖ (see eq. (2) for the IAF neuron). Furthermore, as described below, for a known input signal, these measurements can be reinterpreted as measurements of the channel itself

Lemma 1. There is a function φₖ(t)=Σ_{l=-L}^{L}φ_{I,k}eₗ (t)∈ [symbol] , such that the t-transform of the Filter-Ideal IAF neuron in eq. (8) can be written as

[symbol]

[symbol]

h, φₖ [symbol] =qₖ. (9)

and φ_{l,k}=\sqrt{T} ∫ₜ_{ₖ}^{t}^{ₖ}⁺¹ u̅ₗ̅e̅ₗ̅(t)dt for all l=−L, −L+1, . . . , L and k=1, 2, . . . , n−1.

Proof The linear functional [symbol] ₖ: [symbol] → [symbol] can be defined by

[symbol]

ₖ(w)=∫ₜ_{ₖ}^{t}^{ₖ}⁺¹(u*w) (s)ds. (10)

where w∈ [symbol] is bounded. Thus, by the Riesz representation theorem there exists a function φₖ∈ [symbol] such that [symbol] ₖ(w)= [symbol] w, φₖ [symbol] , k=1, 2, . . . , n−1, and

qₖ= [symbol] ₖ( [symbol] )=∫ₜ_{ₖ}^{t}^{ₖ}⁻¹(u* [symbol] )(s)ds= [symbol] [symbol] , φₖ [symbol] . (11)

Since φₖ∈ [symbol] we have φₖ(t)=Σₗ₌₋^{L}φl,keₗ for some φ_{l,k} ∈ [symbol] , l=−L, −L+1, . . . , L. To find the latter coefficients,

$${φ}_{l , k} = 〈 {φ}_{k} {e}_{l} 〉 = \overline{〈 {e}_{l} , {φ}_{k} 〉} = \overline{{ℒ}_{k} ( {e}_{l} )} .$$

By definition of [symbol] ₖ in eq. (10),

$$\begin{matrix}{ℒ}_{k} ( {c}_{l} ) = {\int }_{{t}_{k}}^{{t}_{k + 1}} ( u * {e}_{l} ) ( t ) d t \\ = {\int }_{{t}_{k}}^{{t}_{k + 1}} {\int }_{0}^{T} {\sum }_{i = - L}^{L} {u}_{i} {e}_{i} ( s ) {e}_{l} ( t - s ) d s d t \\ = \sqrt{T} {\int }_{{t}_{k}}^{{t}_{k + 1}} {u}_{l} {e}_{l} ( t ) d t .\end{matrix} \qquad ( 12 )$$

Since qₖ=∫tₖ^{t}^{ₖ}⁺¹(u* [symbol] )(s)ds= [symbol] u, [symbol] 1_{[t}_{ₖ}_{,t}_{_{k+1]}} [symbol] , the measurements qₖ can be projections of v=u* [symbol] onto [symbol] 1_{[t}_{ₖ}_{,t}_{_{k−1]}}, k=1, 2, . . . n−1. Assuming that u is known and enough measurements are available, [symbol] can be obtained by first recovering v from these projections then deconvolving it with u. An alternative embodiment can be provided using Lemma 1, since the measurements (qₖ)ₖ₌₁ⁿ⁻¹ can also be interpreted as the projections of [symbol] onto φₖ i.e., [symbol] [symbol] , φₖ [symbol] , k=1, 2, . . . , n−1. [symbol] can be identified from the latter projections, as described below.

Lemma 2. Let u∈ [symbol] be the input to a Filter-Ideal IAF circuit with h ∈H. If the number of spikes n generated by the neuron in a time interval of length T satisfies n≧2L+2, then the filter projection [symbol] can be perfectly identified from the I/O pair (u, [symbol] ) as

$$( Ph ) ( t ) = {\sum }_{l = - L}^{L} {h}_{l} {e}_{l} ( t ) , \qquad ( 13 )$$

Writing eq. (13) for all k=1, 2, . . . , n−1, q=Φh with [q]ₖ=qₖ, [Φ]w= φ̅_̅{̅l̅,̅k̅}̅ and [h]ₗ=hₗ.This system of linear equations can be solved for h, provided that the rank r(Φ) of the matrix Φ satisfies r(Φ)=2L+1. For the latter, the number of measurements qₖ can be at least 2L+1, or equivalently, the number of spikes can be n≧2L+2. Under this condition, the solution can be computed as h=Φ+q.

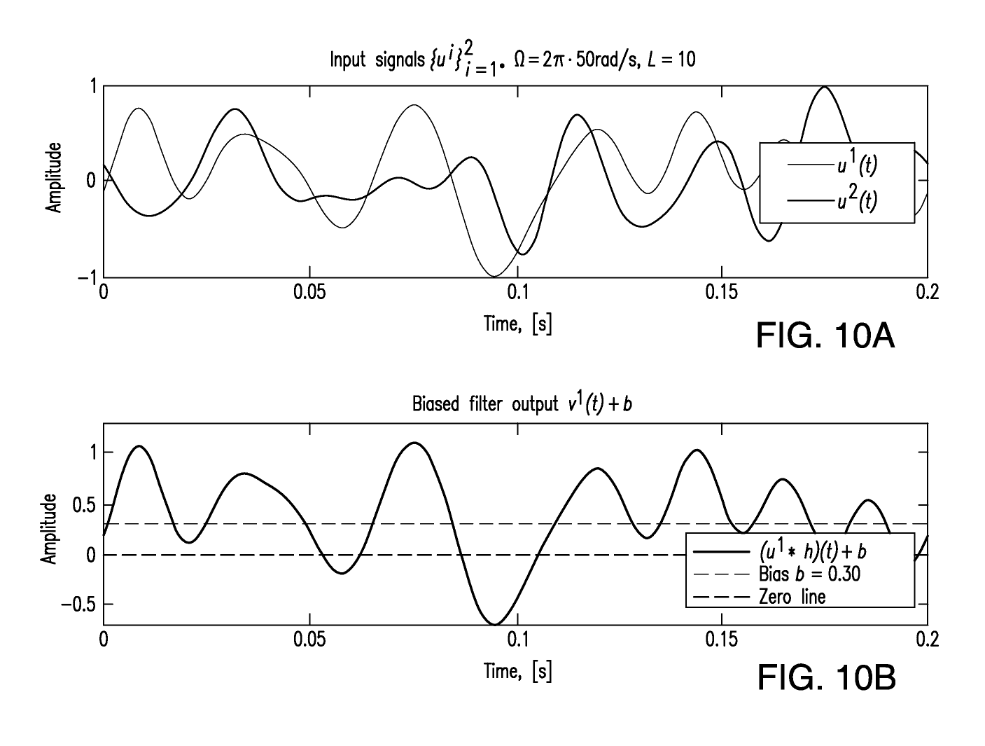

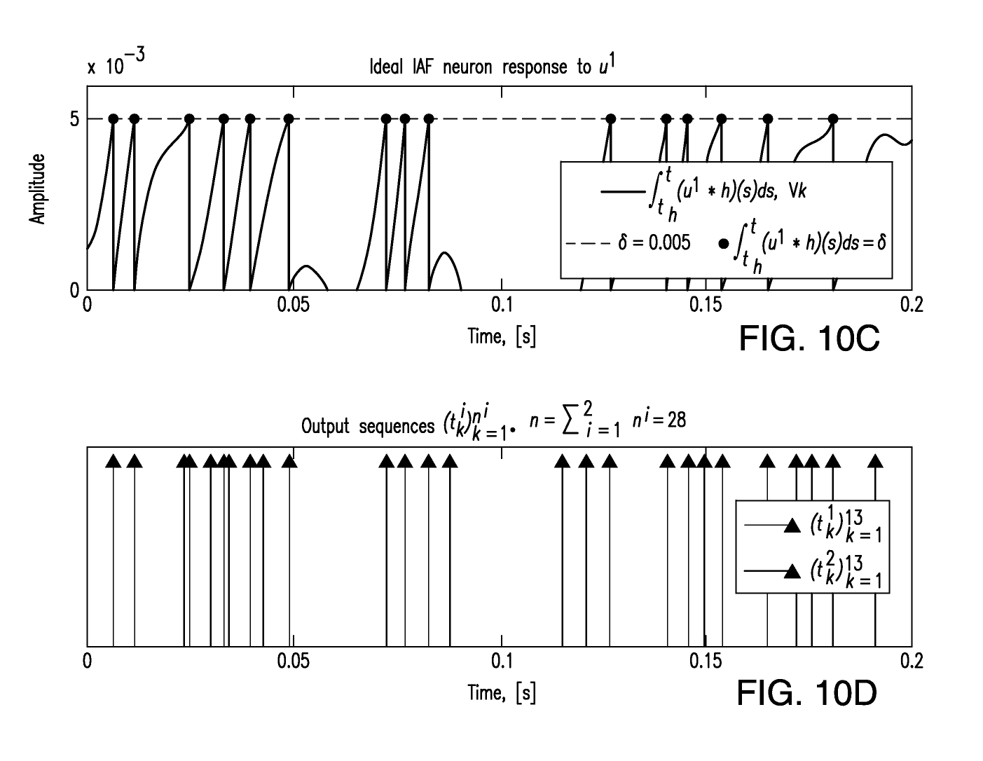

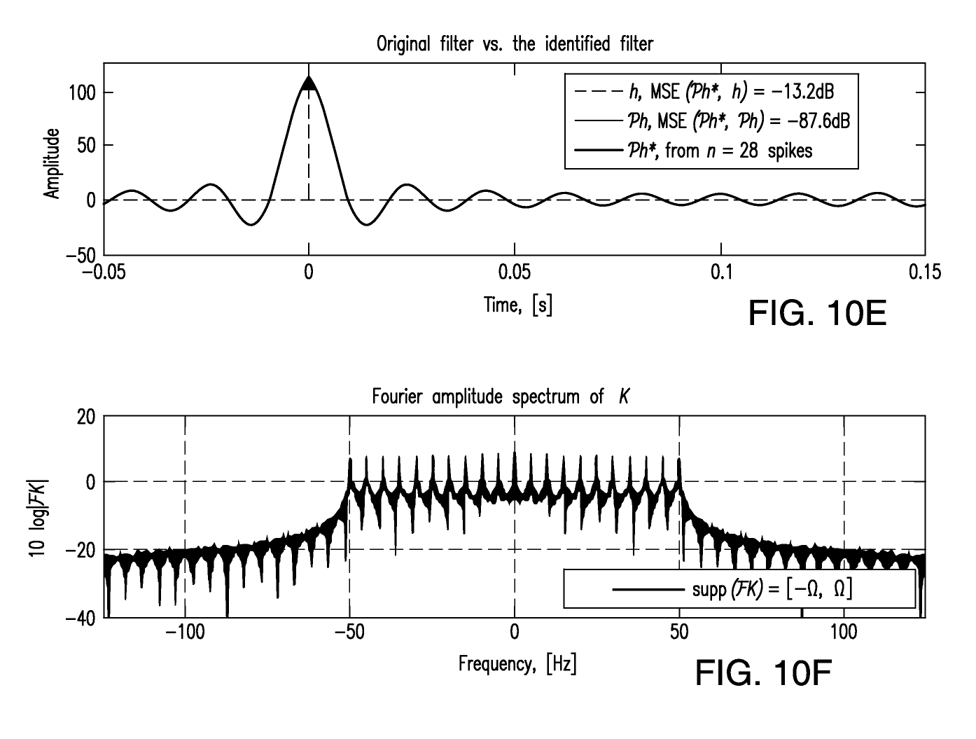

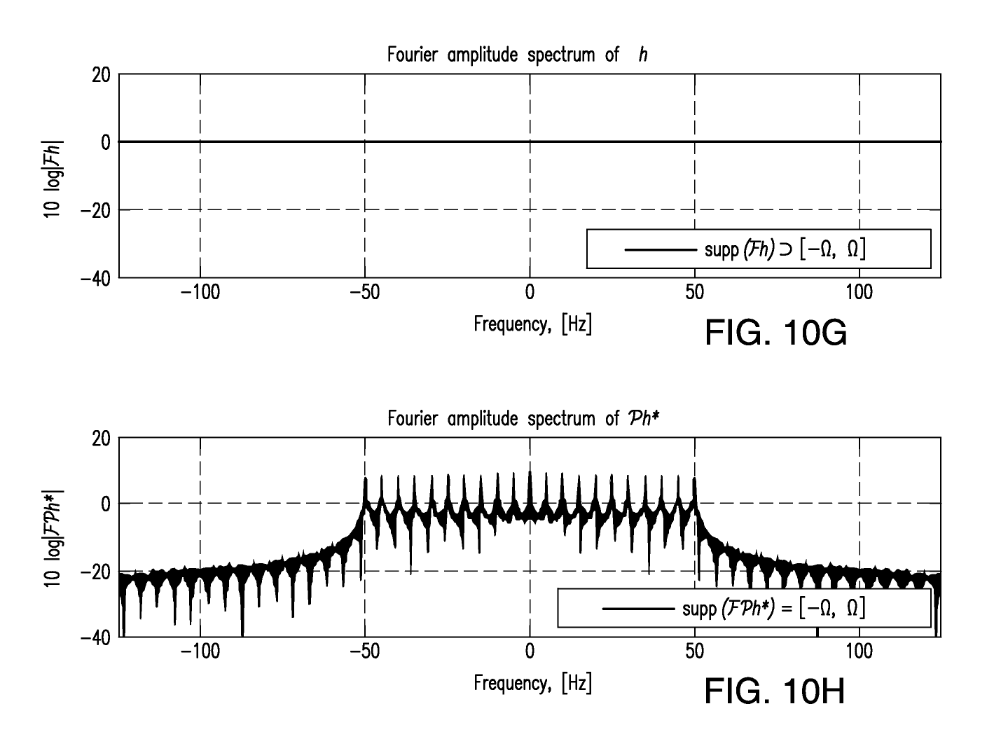

Remark 2. Referring now to the exemplary embodiment of FIG. 3a, with the signal u fed directly into the neuron, then ∫ₜ_{ₖ}^{t}^{ₖ}⁺¹(u* [symbol] )(t)(dt=∫ₜ_{ₖ}^{t}^{ₖ}⁺¹u(t)dt, for all k, k=1, 2, . . . , n−1. This can be true if ( [symbol] )(t)=K(t,0), t ∈ [symbol] . In other words, if there is no processing on the input signal u, then the kernel K(t,0) in [symbol] can be identified as [symbol] , This is shown, for example, in FIG. 10.

To ensure that the neuron produces 2L+1 measurements in a time interval of length T, tₖ₊₁−tₖ≦T/(2L+2). Since tₖ₊₁−tₖ≦Cδ/(b−c) for |v(t)|≦c<b, Cδ<(b−c)T/(2L+2). Using T=2πL/Ω and taking the limit as L→∞, Cδ<π(b−c)/Ω, also known as the Nyquist-type criterion, for a bandlimited stimulus u∈Ξ, as described further below.

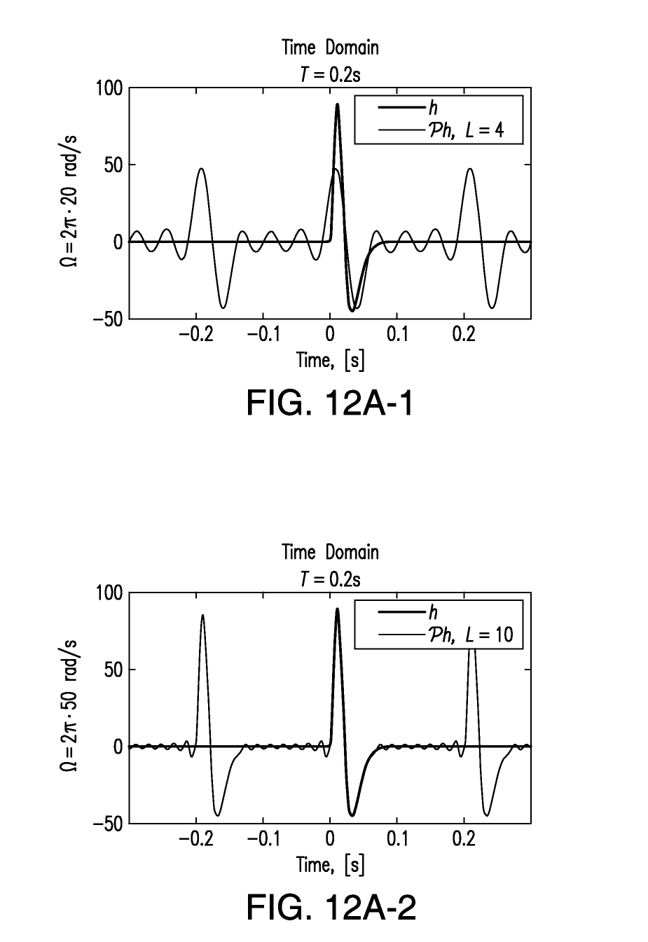

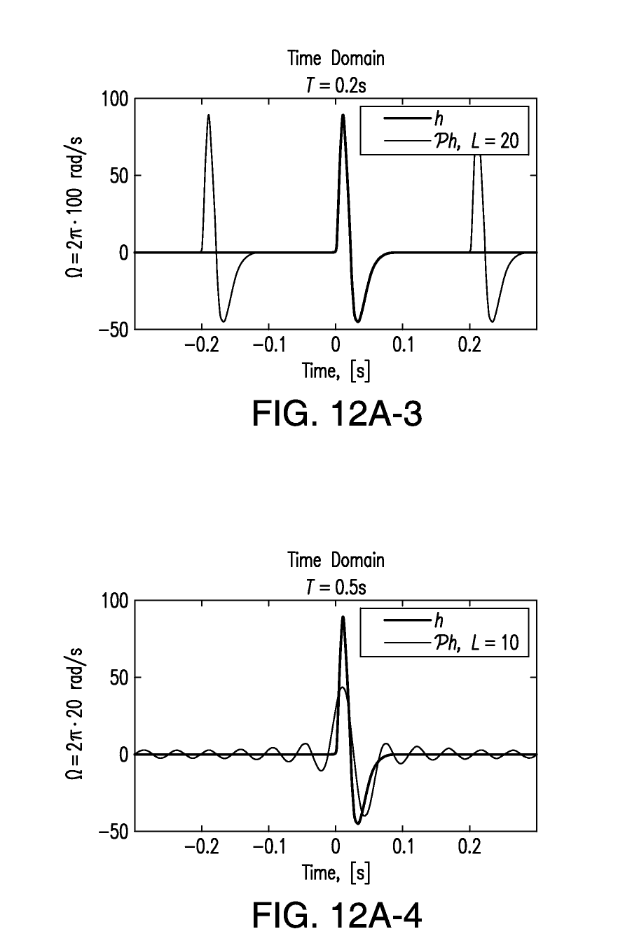

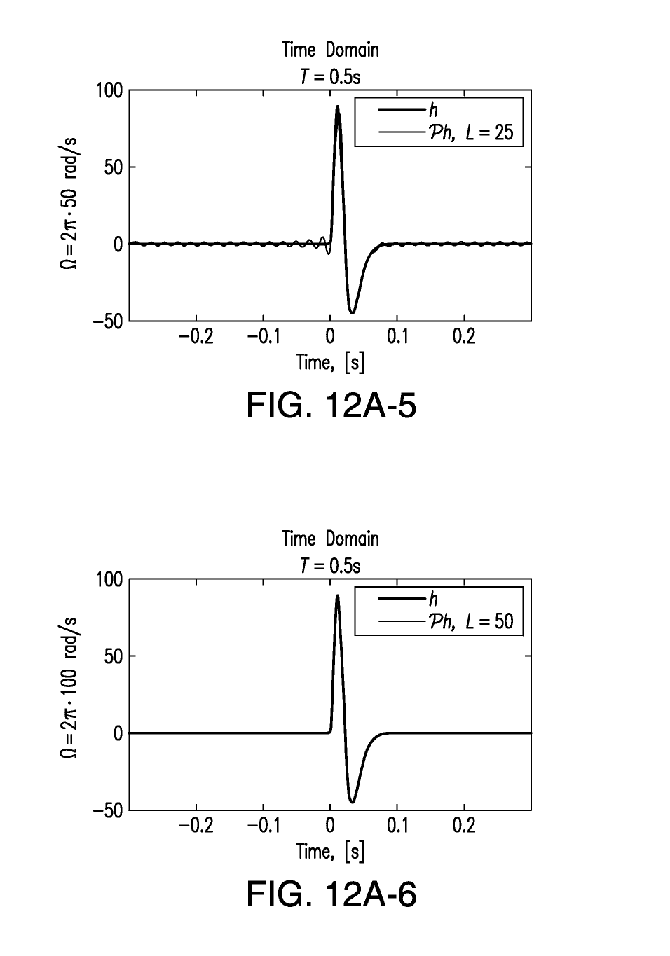

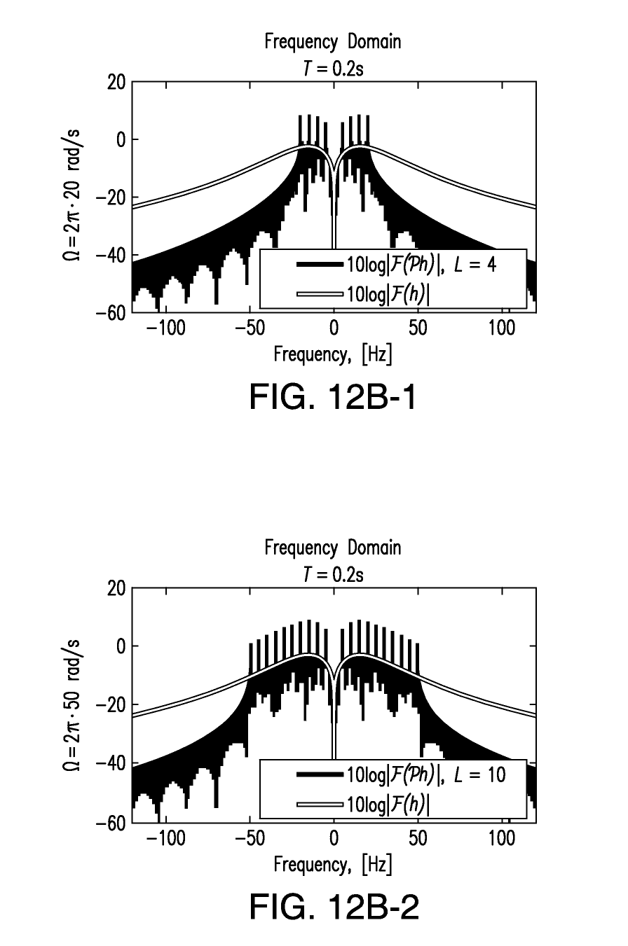

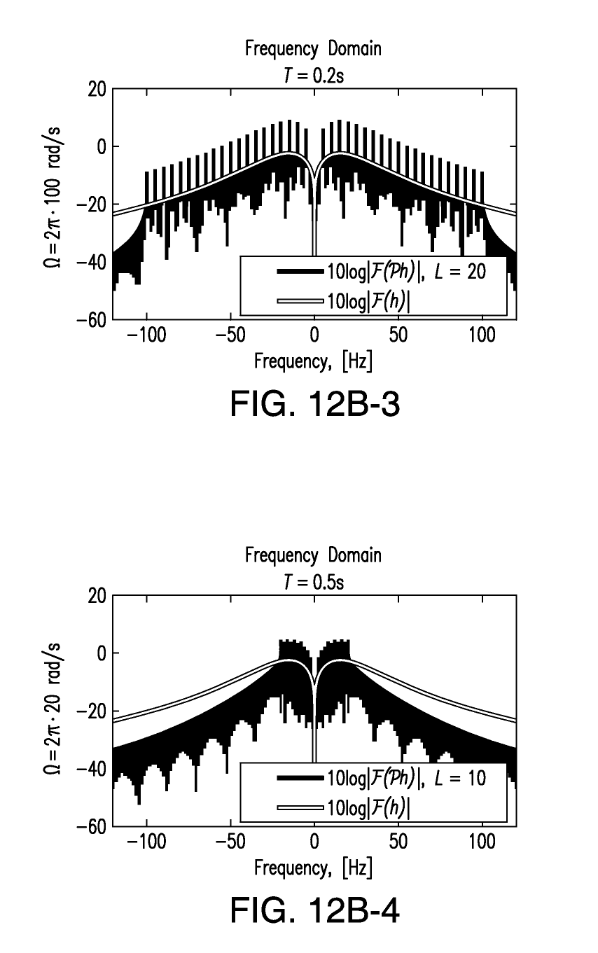

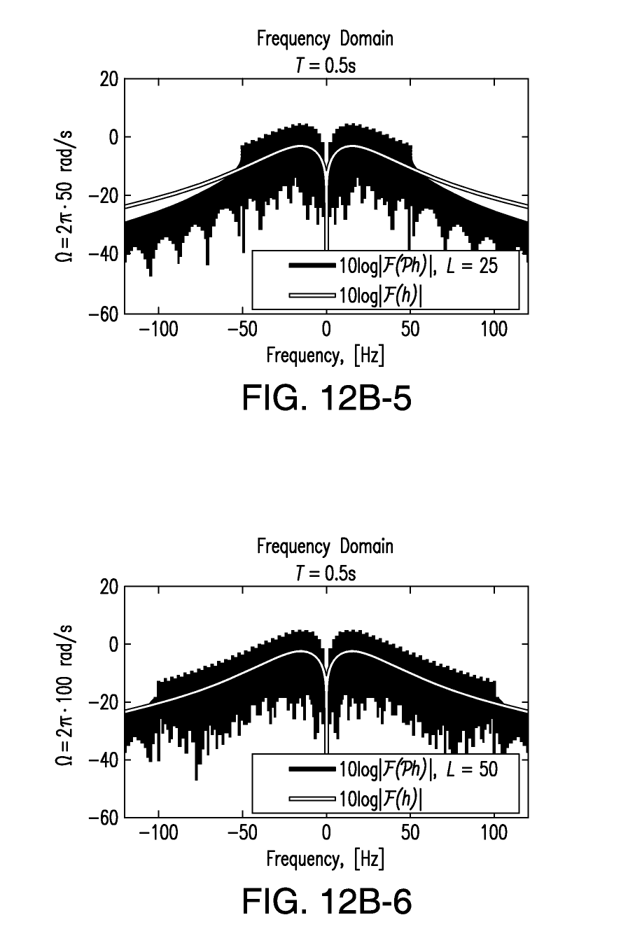

As described further below, the impulse response of the filter h can be identified. Unlike h∈H, the projection [symbol] can belong to the space [symbol] . Nevertheless, under certain conditions on h (as described below), [symbol] can approximate h arbitrarily closely on t∈[0,T], provided that both the bandwidth and the order of the signal u are sufficiently large (see also FIG. 12).

With reference to Lemma 2, if the number of spikes n produced by the exemplary system of FIG. 3a does not satisfy n≧2L+2, for example if the order L of the space [symbol] is relatively high, the system as described below can result.

Theorem 2. (SISO Channel Identification Machine)

Let {uⁱ|uⁱ ∈ [symbol] }ᵢ₌₁^{N} be a collection of N linearly independent stimuli at the input to a Filter-Ideal IAF circuit with h∈H, If the total number of spikes n=Σᵢ₌₁^{N} nⁱ generated by the neuron satisfies n≧2L+2, then the filter projection [symbol] can be identified from a collection of I/O pairs {(uⁱ, [symbol] )}ᵢ₌₁^{N} as

$$( 𝒫 h ) ( t ) = {\sum }_{l = - L}^{L} {h}_{l} {e}_{l} ( t ) , \qquad ( 14 )$$

where h=Φ⁴q. Furthermore, Φ=[Φ¹; Φ²; . . . ; Φ^{N}] and q=[q¹; q²; . . . ; q^{N}], with each Φ¹ of size (nⁱ−1)×(2L+1) and qⁱ of size (nⁱ−1)×1. The elements of matrices Φⁱ are given by

$${[ {Φ}^{i} ]}_{kl} = \{ \begin{matrix}{u}_{l}^{i} ( {t}_{k + 1}^{i} - {t}_{k}^{i} ) & l = 0 \\ \frac{{u}_{l}^{i} L \sqrt{T} ( {e}_{l} ( {t}_{k + 1}^{i} ) - {e}_{l} ( {t}_{k}^{i} ) )}{j l Ω} & l \neq 0.\end{matrix} \qquad ( 15 )$$

for all k=1, 2, . . . , n−1 l=−L+1, . . . L, and i=1, 2, . . . , N.

Proof: Since [symbol] ∈H. ( [symbol] )(t)=Σ_{l=-L}^{L}hₗeₗ(t). Furthermore, since the stimuli are linearly independent, the measurements (qₖⁱ)ₖ₌₁ⁿ_{ᵢ}⁻¹ provided by the IAF neuron can be distinct. Writing eq. (5) for a stimulus u^{t}.

$${q}_{k}^{i} = 〈 𝒫 h , {φ}_{k}^{i} 〉 = {\sum }_{l = - L}^{L} {h}_{l} \overline{{φ}_{l , k}^{i}} , \qquad ( 16 )$$

or qⁱ=Φⁱh, with [qⁱ]ₖ=qₖⁱ[Φⁱ]_{k,l}= φ̅_̅{̅l̅,̅k̅}̅ⁱ̅ and [h]ₗ=hₗ. Repeating for all i=1, . . . , N. q=Φh with Φ=[Φ¹; Φ²; . . . ; Φ^{N}] and q=[q¹; q²; . . . ; q^{N}]. This system of linear equations can be solved for h, provided that the rank r(Φ) of matrix Φ satisfies r(Φ)=2L+1. For the latter, the total number n=Σᵢ₌₁^{N}nⁱ of spikes generated in response to all N signals can satisfy n≧2L+2. Then, h=Φ+q. To find the coefficients φ̅_̅{̅l̅,̅k̅}̅ⁱ̅ . φ_{l,k}ⁱ= [symbol] ₖⁱ (̅e̅ₗ̅)̅ (see also Lemma 1).

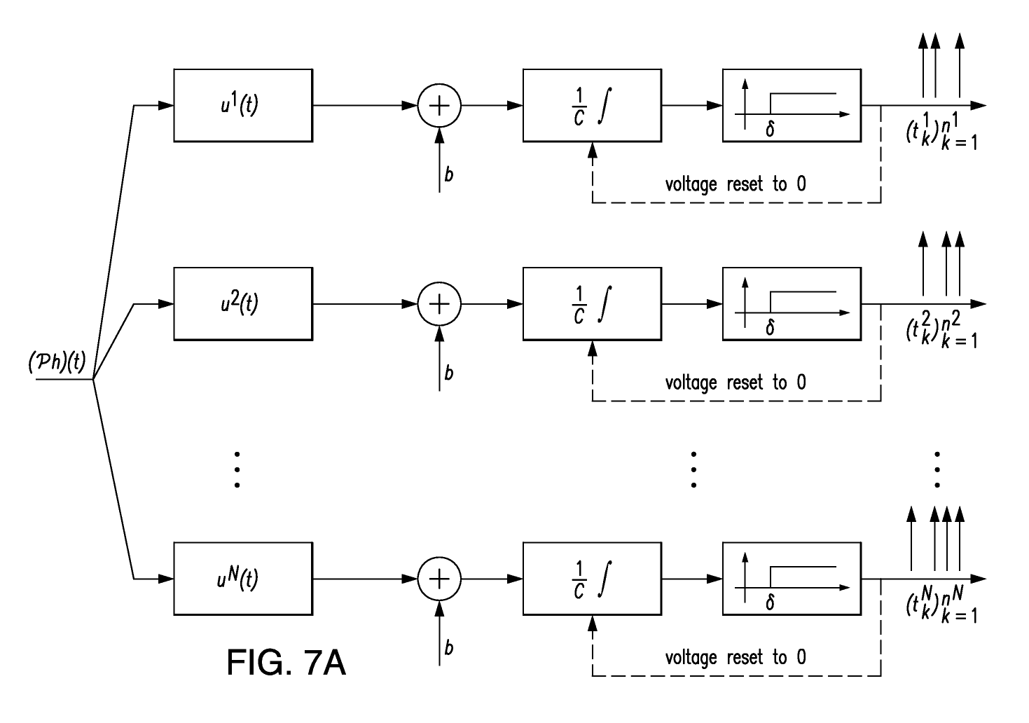

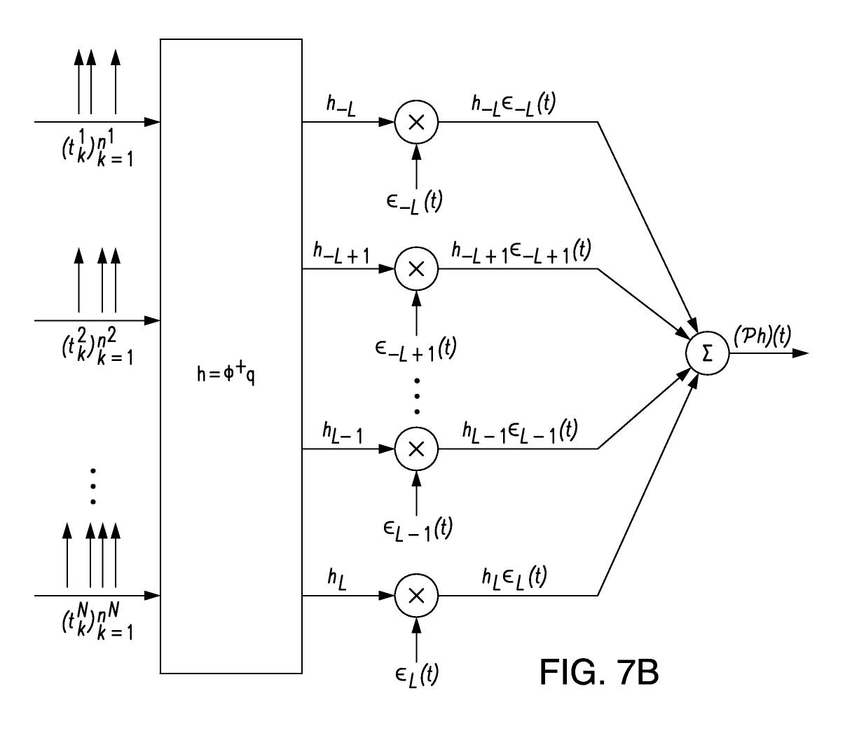

Hence, and as described further below, an exemplary embodiment of a time encoding system for channel identification of a SISO Filter-Ideal IAF neural circuit is provided, as shown in FIG. 7a. The block diagram of the SISO CIM in Theorem 2 is shown in FIG. 7b. Using the SISO CIM, multiple linearly independent test signals uⁱ∈ [symbol] , i=1, 2, . . . , N. can be introduced. When the Filter-Ideal IAF circuit is producing very few measurements of [symbol] in response to any given test signal uⁱ, more signals can be used to obtain additional measurements. This can be done, and [symbol] can be identified, because [symbol] ∈ [symbol] can be fixed. In contrast, identifying [symbol] in a two-step deconvolving procedure can require reconstructing at least one tⁱ, which is further complicated due to each tⁱ capable of being signal-dependent and capable of having a relatively small number of associated measurements.

The performance of the identification methods using Lemma 2 and Theorem 2 can be described as follows. A filter in the SISO Filter-Ideal IAF neural circuit (as shown in FIG. 3a) from a single I/O pair can be identified when the circuit produces a sufficient number of measurements in an interval of length T. The identification algorithm involving multiple I/O pairs can be shown for the case when the number of measurements produced in response to an input signal is small. The exemplary embodiment of the SISO Filter-Nonlinear Oscillator-ZCD circuit, shown in FIG. 3b, can be used to identify its filter from multiple I/O pairs.

### Example

### SISO Filter-Ideal IAF Neural Circuit, Single I/O Pair

With reference to the dendritic processing filter using the causal linear kernel,

$$h ( t ) = c {e}^{- α t} [ \frac{{( α t )}^{3}}{3 !} - \frac{{( α t )}^{5}}{5 !} ] , t ∈ [ 0 , 0.1 ] s , \qquad ( 17 )$$

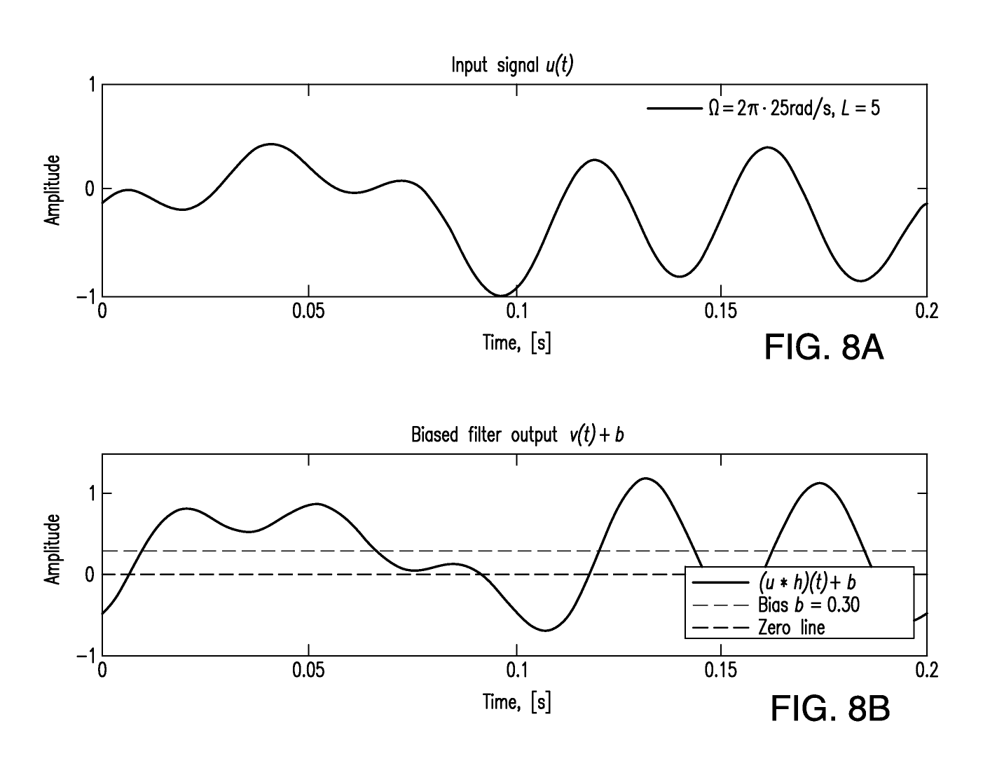

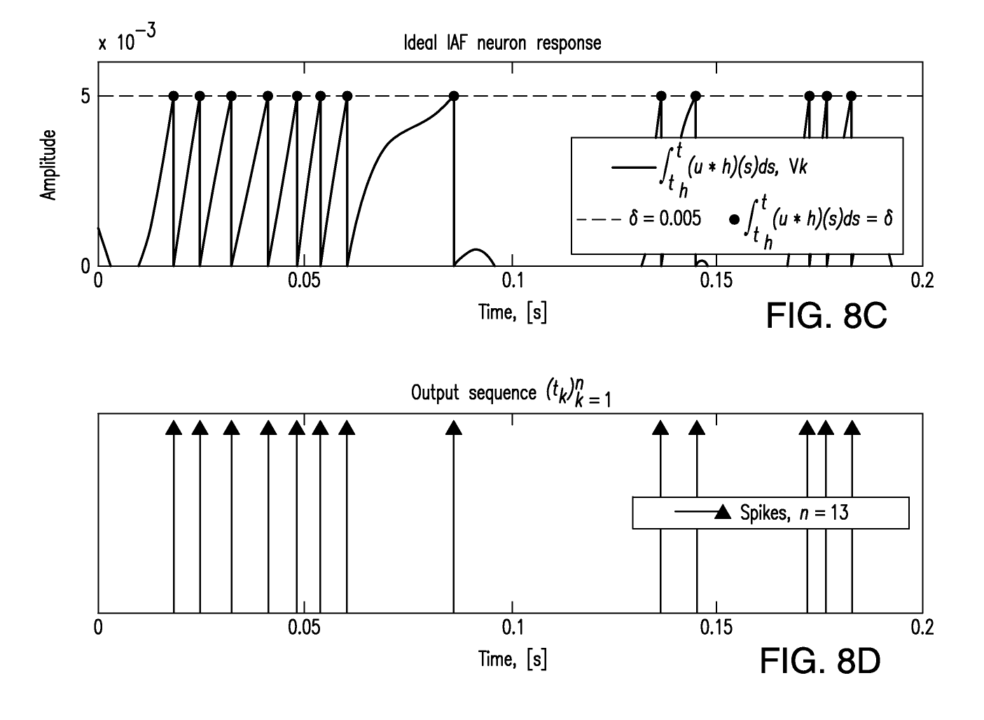

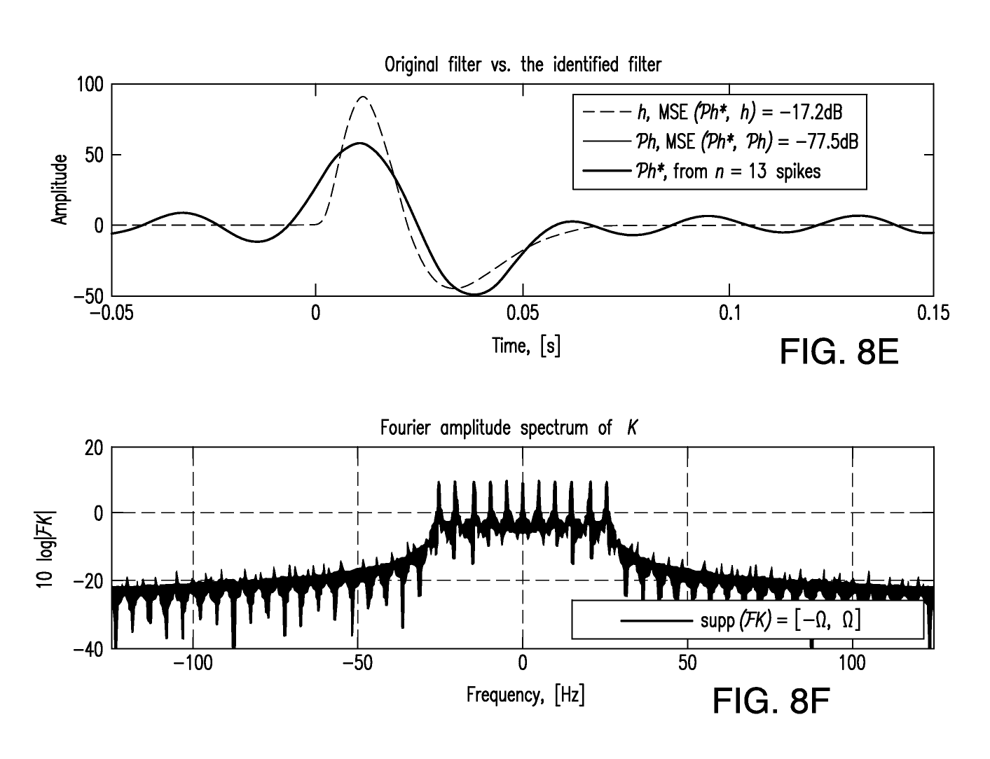

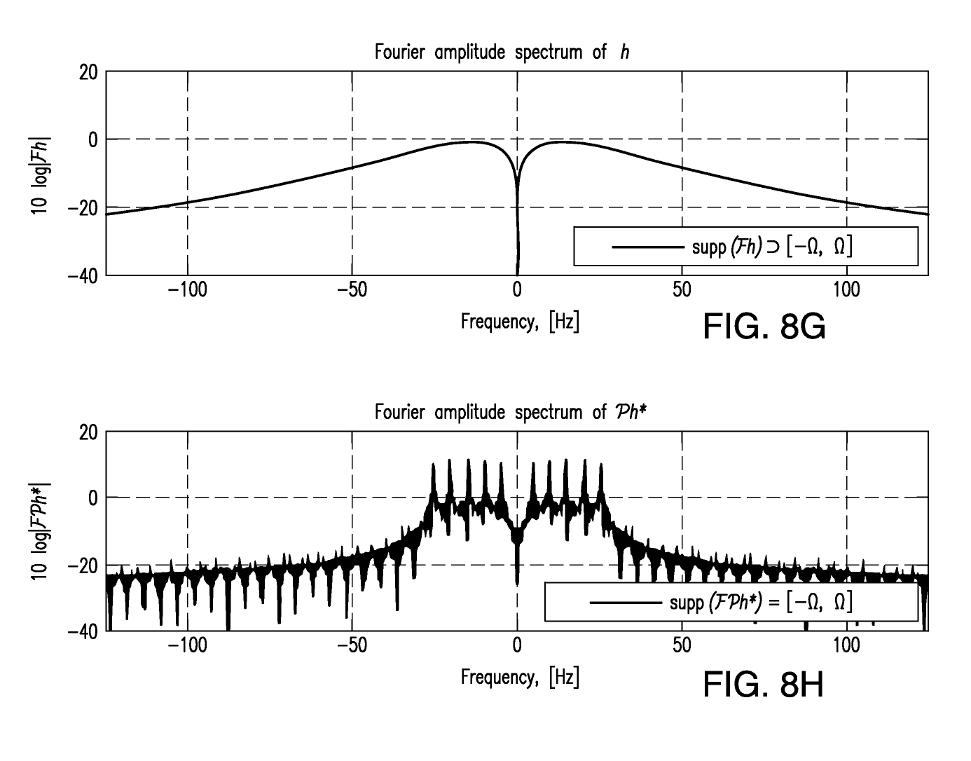

with c=3 and α=200. The general form of this kernel can be a plausible approximation to the temporal structure of a visual receptive field. Since the length of the filter support S=0.1 s, a signal with a period T≧0.1 s. can be used. As shown in FIG. 8a, a signal u that is bandlimited to 25 Hz and has a period of T=0.2 s, i.e., the order of the space L=T•Ω/(2π)=5, can be applied. The biased output of the filter u=(u*h)+b can then be fed into an ideal integrate-and-fire neuron (as shown in FIG. 8b). The bias b can produce an output of the integrator reaching the threshold value in finite time. Whenever the biased filter output is above zero (as shown in FIG. 8b), the membrane potential can be increasing (as shown in FIG. 8c). If the membrane potential ∫_{tb}^{t}[(u*h)(s)+b]ds reaches a threshold δ, a spike can be generated by the neuron at a time tₖ₊₁ and the potential can be reset to zero (as shown in FIG. 8c). The resulting spike train (tₖ)ₖ₌₁ⁿ at the output of the Filter-Ideal IAF circuit is shown in FIG. 8d.

In the exemplary circuit described above, a total of n=13 spikes can be generated in an interval of length T=0.2 s. According to Theorem 2, n=2L+2=12 or more spikes, corresponding to 2L+1=11 or more measurements, can be used to identify the projection [symbol] of the filter h relatively free of loss. Hence, in this embodiment, a single I/O pair (u, [symbol] ) can be used.

As shown in FIG. 8e, the original impulse response of the filter h, the filter projection [symbol] , and the filter [symbol] * that was identified using the algorithm in Theorem 2 can be plotted. The identified impulse response [symbol] * can be distinct from h. In contrast, the mean-squared-error (MSE) between [symbol] * and [symbol] can be relatively small, and can be equal to −77:5 dB.

The difference between [symbol] * and h is shown in FIGS. 8f-8h. Using eq. (6), [symbol] =h* K̅(̅•̅,̅ 0̅)̅, or [symbol] ( [symbol] )= [symbol] (h) [symbol] (K(•, 0)) since K̅=K. Hence, both the projection [symbol] and the identified filter [symbol] * can contain frequencies present in the reproducing kernel K, or equivalently in the input signal u. The double-sided Fourier amplitude spectrum of K(t, 0) is shown in FIG. 8f. The kernel can be bandlimited to 25 Hz and can contain 2L+1=11 distinct frequencies. On the other hand, as shown in FIG. 8g, the original filter h can be non-bandlimited since it has a finite temporal support. As a result, the input signal u explores h in a limited spectrum of [−Ω, Ω] rad/s, and can effectively project h onto the space [symbol] with Ω=2π•25 rad/s and L=5. The Fourier amplitude spectrum of the identified projection [symbol] * is shown in FIG. 8h. In other words, supp( [symbol] K)=supp( [symbol] [symbol] *)=[−Ω, Ω] but supp( [symbol] h)⊃[−Ω, Ω], or [symbol] * ∈ [symbol] but h∉ [symbol] .

### Example

### SISO Filter-Ideal 1AF Neural Circuit, Multiple I/O Pairs

The projection of h onto the space of functions that are bandlimited to 100 Hz and have the period T=0:2 s (as in the previous embodiment) can be identified. The order L of the space of input signals [symbol] can be L=T•Ω/(π)=20, and the neuron can be used to generate n=2L+2=42 or more spikes to identify the projection [symbol] relatively free of loss. If the neuron produces about 13 spikes on an interval of length T (as in the previous embodiment), a single I/O pair can not suffice. However, the projection [symbol] can still be recovered if multiple I/O pairs are used.

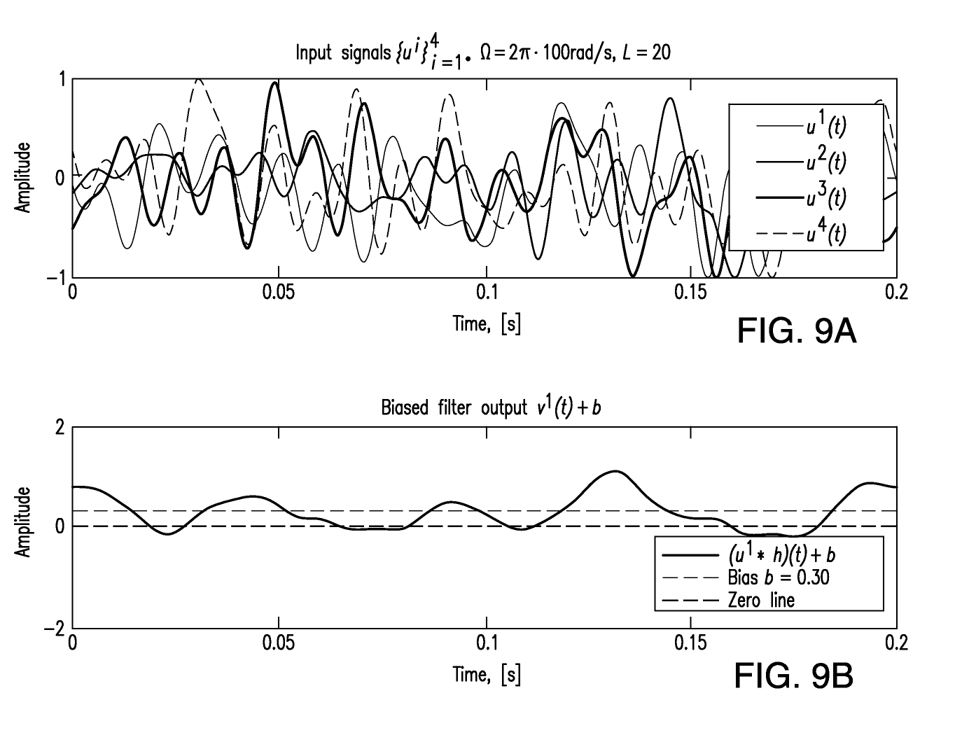

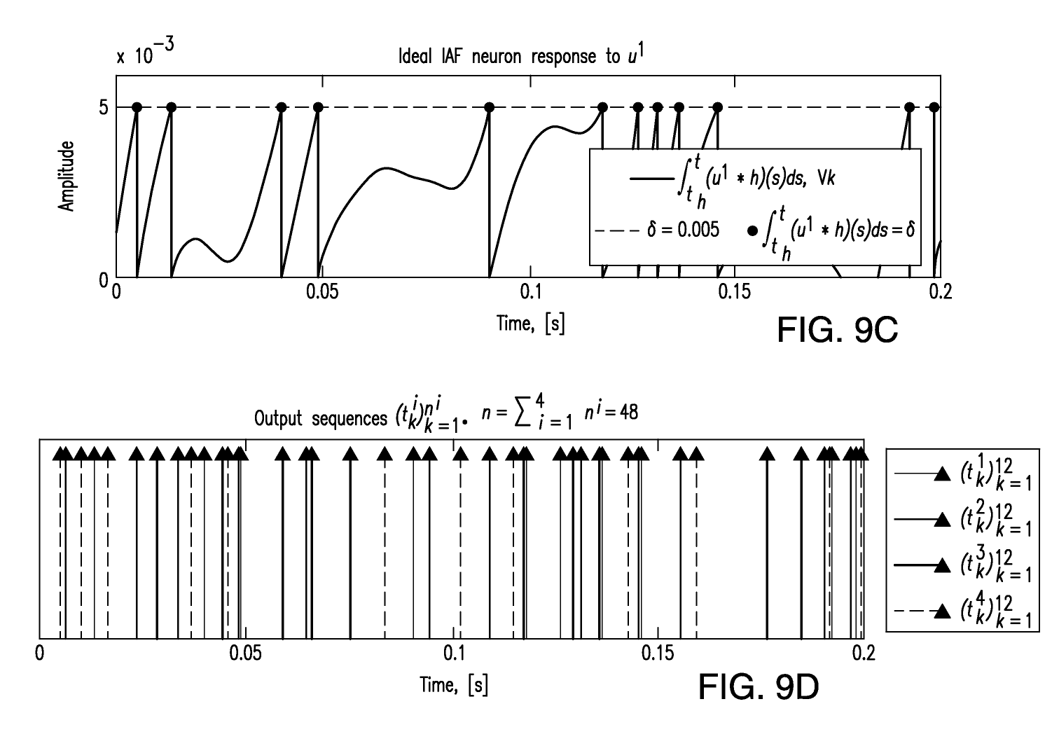

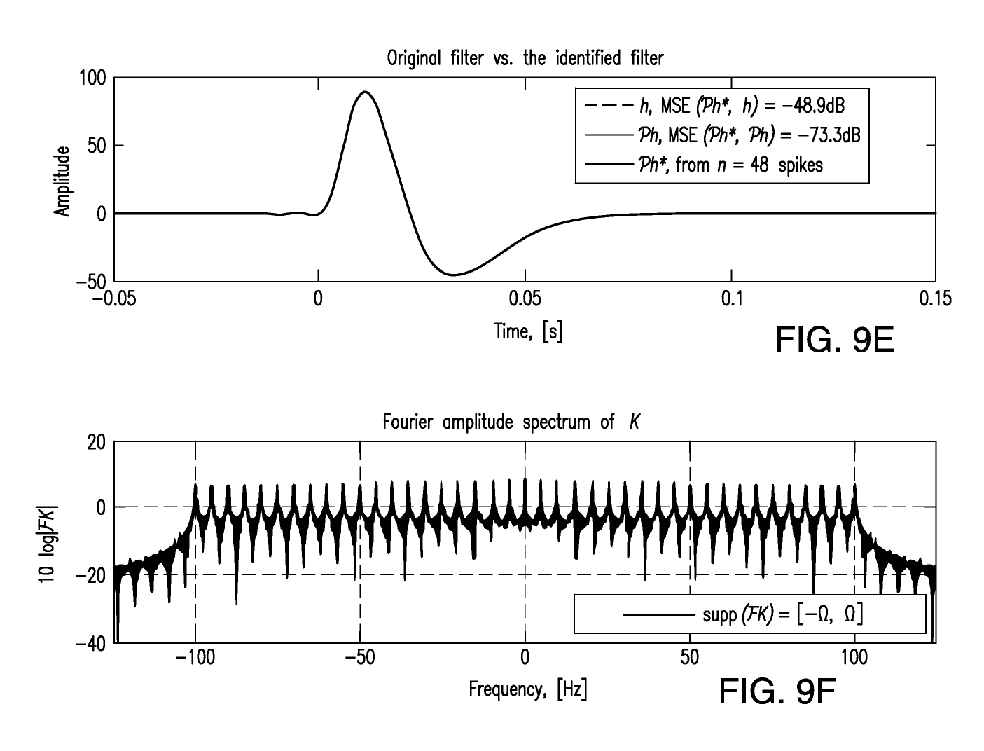

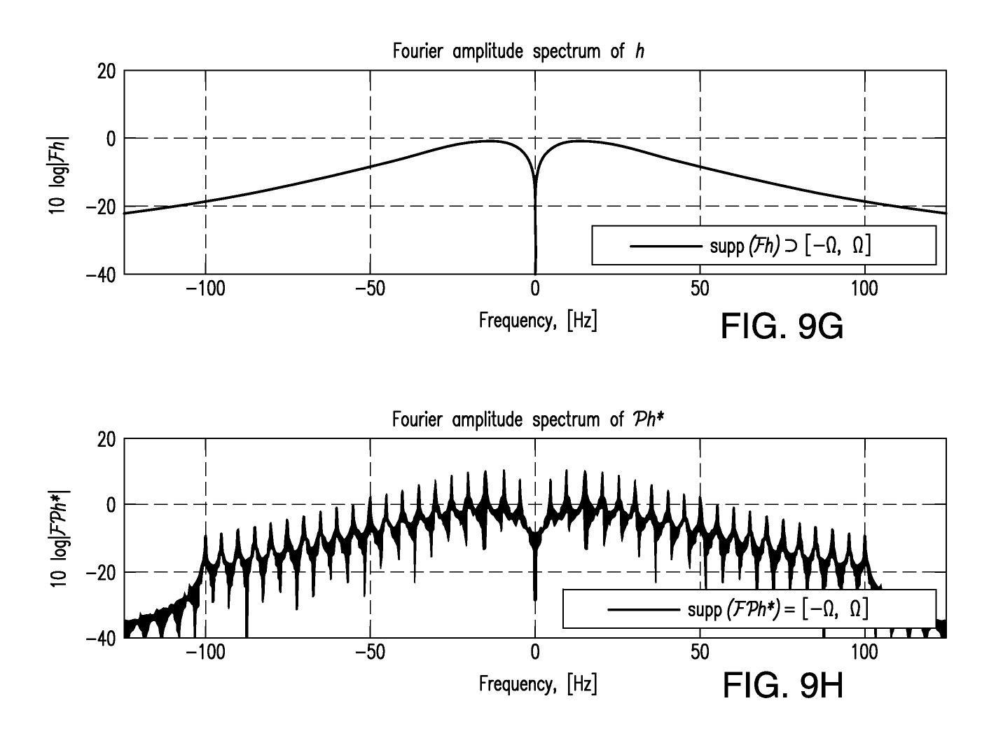

FIGS. 9a-9h show identification of the filter using Theorem 2. As shown in FIG. 9a, the input signals u¹, . . . , u⁴ can be bandlimited to 100 Hz. The order of the space L=20. FIG. 9b shows a biased output of the filter v¹(l)+h in response to the stimulus u¹. FIG. 9c shows that the filter output in FIG. 9b can be integrated by an ideal IAF neuron. As shown in FIG. 9d, the neuron generated a total of 48 spikes in response to all 4 input signals. In FIG. 9e, the identified impulse response [symbol] * is shown together with the original filter h and its projection [symbol] . The MSE between [symbol] * and [symbol] is −73:3 dB. FIGS. 7f-7h show the Fourier amplitude spectra of K, h and [symbol] *, respectively. As shown in FIGS. 9f-9h, supp( [symbol] K)=[−Ω, Ω]=supp( [symbol] [symbol] *) but supp( [symbol] h) ⊃[−Ω, Ω]. In other words, [symbol] * ∈ [symbol] but h∉ [symbol] .

### Example

### SISO Filter-Ideal IAF Neural Circuit, h(t)=δ(t)

In another exemplary embodiment, a system is provided where the channel does not alter the input signal, i.e., when h(t)=δ(t), t∈ [symbol] , which is the Dirac delta function. With reference to Remark 2, the CIM can identify the projection of δ(t) onto [symbol] i.e., the kernel K(t, 0), as shown in FIGS. 10a-10h. In FIG. 10a, input signals u¹, u² are bandlimited to 50 Hz. The order of the space L=10. FIG. 10b shows the biased output of the filter v¹(t)+b in response to the stimulus u¹. FIG. 10e shows that the filter output in FIG. 10b can be integrated by an ideal IAF neuron. As shown in FIG. 10d, the neuron generated a total of 28 spikes in response to the 2 input signals. In FIG. 10e, the identified filter [symbol] * is the kernel K(t,0) for [symbol] _{Ω,L} ¹ with Ω=2π•10 rad/s and L=10. Also shown is the original filter h=δ and its projection [symbol] δ* K̅(̅•̅,̅Ω̅)̅=K(•,Ω). The MSE between [symbol] * and [symbol] is −87.6 dB. FIGS. 10f-10h show the Fourier amplitude spectra of K, h, and [symbol] *, respectively, and [symbol] * ∈ [symbol] but h ∉ [symbol] .

### Example

### SISO Filter-Nonlinear Oscillator-ZCD Circuit, Multiple I/O Pairs

In another exemplary embodiment, a SISO circuit having a channel in cascade with a nonlinear dynamical system that has a relatively stable limit cycle is provided. The (positive) output of the channel v(t)+b can be multiplicatively coupled to the dynamical system (as shown in FIG. 3b) so that the circuit can be represented by

$$\frac{d y}{d t} = ( v ( t ) + b ) f ( y ) . \qquad ( 18 )$$

The system represented by eq. (18) followed by a zero-crossing detector can be an example of a TEM with multiplicative coupling. The TEM with multiplicative coupling can be substantially input/output equivalent to an TAF neuron with a threshold δ and substantially equal to the period of the dynamical system on a relatively stable limit cycle.

For example, a Filter-van der Pol oscillator-zero-crossing detector (Filter-van der Pol-ZCD) TEM having the van der Pal oscillator can be described by a set of equations

$$\frac{d {y}_{1}}{d t} = ( u * h + b ) [ μ ( {y}_{1} - \frac{1}{3} {y}_{1}^{3} ) - {y}_{2} ] \\ \frac{d {y}_{2}}{d t} = ( u * h + b ) {y}_{1} , \qquad ( 19 )$$

where μ is the damping coefficient. It is assumed that y₁ is the only observable state of the oscillator and the zero phase of the limit cycle is the peak of yᵢ.

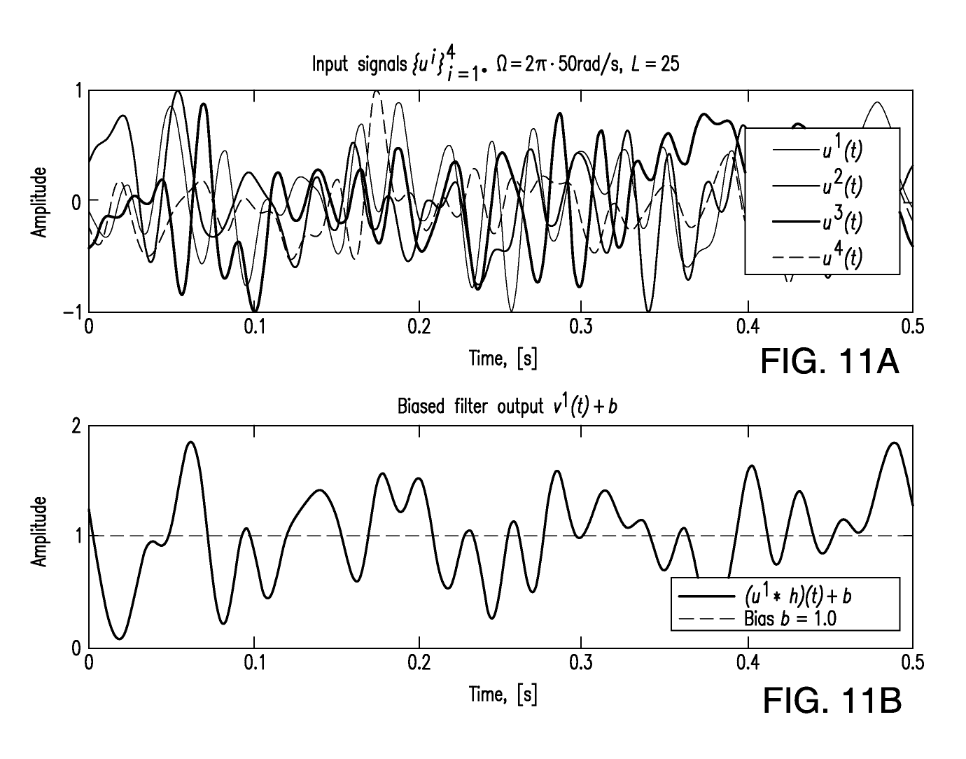

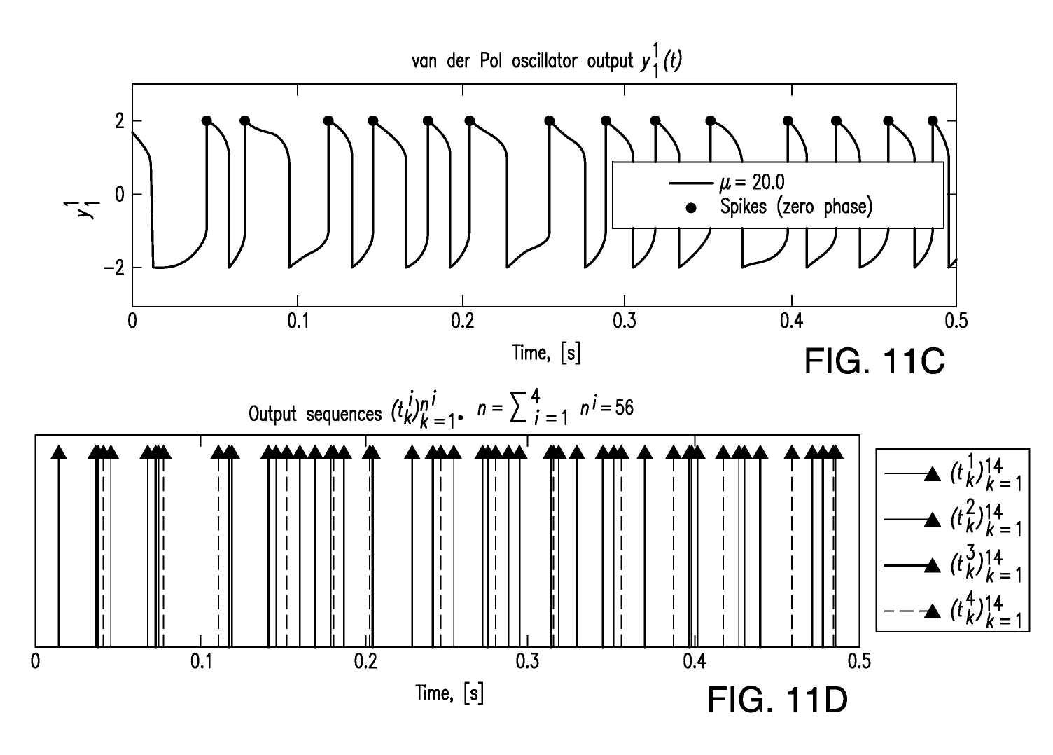

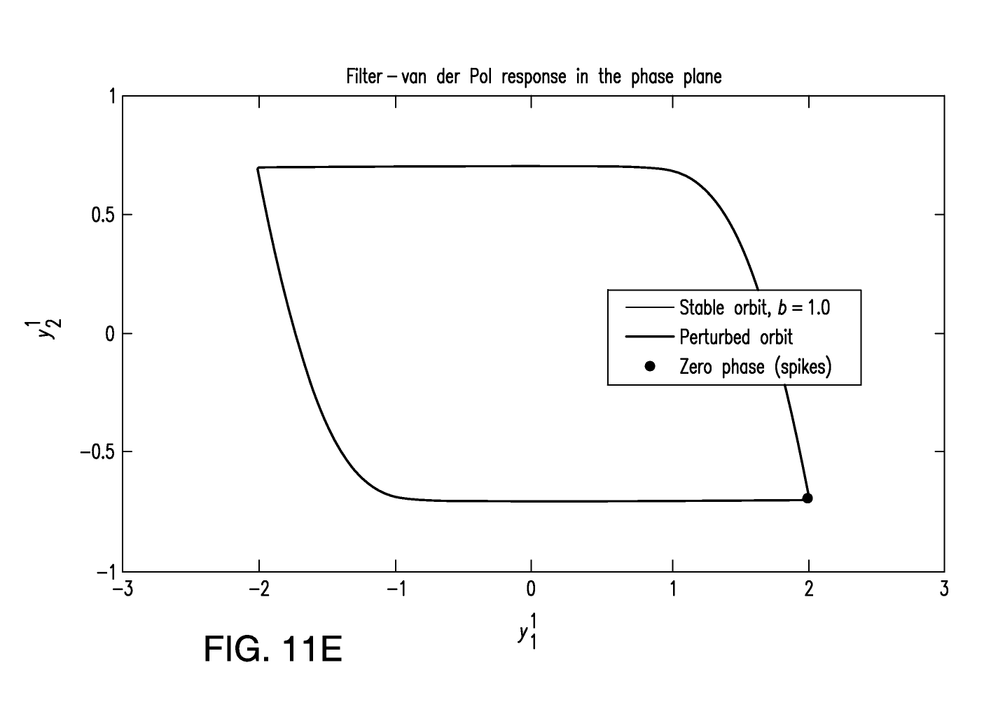

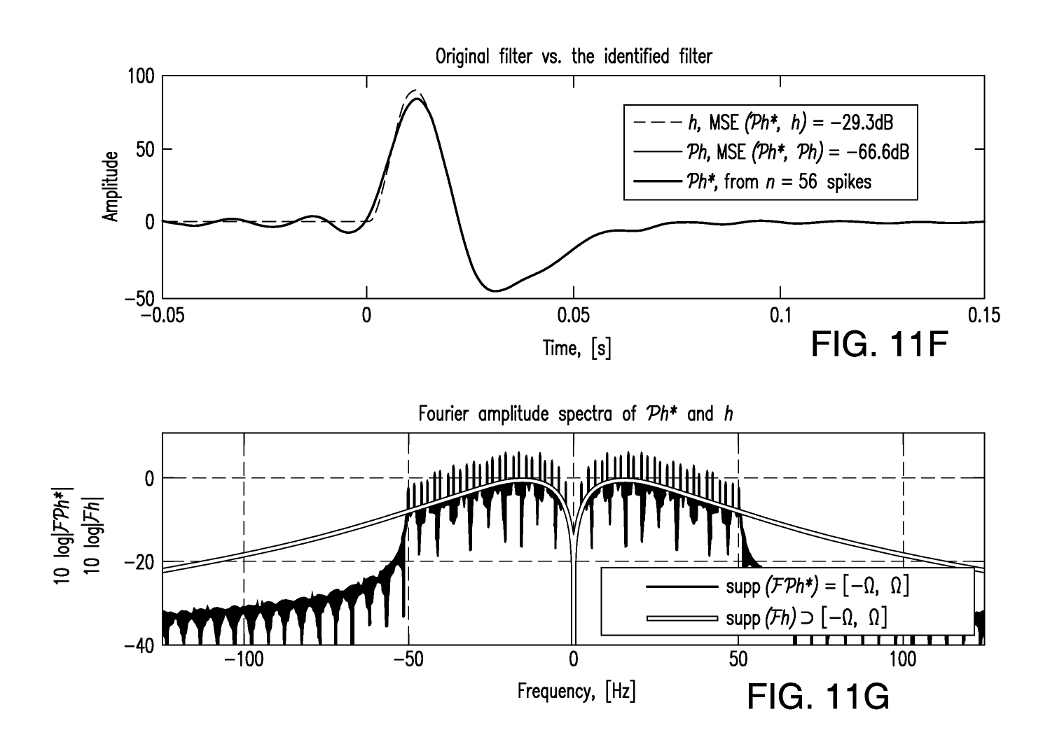

FIGS. 11a-11g show a SISO CIM used to identify the channel. Input signals (as shown in FIG. 11a) can be bandlimited to 50 Hz and can have a period T=0.5 s, i.e., L=25. In absence of a channel signal v, a substantially constant bias b=1 (as shown in FIG. 11b) can result in a period of 34.7 ms on a relatively stable limit cycle (as shown in FIG. 11e). As shown in FIGS. 11b and 9c, downward/upward deviations of v¹(t)+b in response to u¹ can result in an increased/decreased speed of the oscillator. To identify the filter projection onto a space of order L=25, relatively free of loss, n=56 zeros at the output of the zero-crossing detector can be used (as shown in FIG. 11d). This can be 4 zeros more than the rank requirement 2L+2=52 zeros, or equivalently, 2L+1=51 measurements. In FIG. 11f, the identified filter [symbol] * is shown together with the original filter h and the projection [symbol] . The MSE between the identified filter [symbol] * and the projection [symbol] is −66.6 dB. FIGS. 11f-11g show the Fourier amplitude spectra of h and [symbol] *, respectively, and [symbol] * ∈ [symbol] but h ∉ [symbol] .

According to another aspect of the disclosed subject matter, to recover the impulse response of the filter h, the CIM can be used to identify a projection [symbol] of the filter onto the input space. Under certain conditions, [symbol] can converge to h, as discussed below.

Proposition 1. If ∫₀^{T}|h(t)|²dt<∞, then [symbol] →h in the L² norm and almost everywhere on t∈[0,T] with increasing Ω, L and fixed T Moreover, if h is twice continuously differentiable, then [symbol] →h uniformly.

Proof: Fix the test signal period, i.e., assume L/Ω=const. Since L=ΩT/(2π).

$$K ( t , 0 ) = \frac{1}{T} {\sum }_{l = - L}^{L} {e}^{\frac{jΩ l}{L} t} = \frac{1}{T} {\sum }_{l = - L}^{L} {e}^{\frac{j2π l}{T} t} . \qquad ( 20 )$$

### Using eq. (6),

$$\begin{matrix}( 𝒫 h ) ( t ) = {\int }_{0}^{T} [ \frac{1}{T} {\sum }_{l = - L}^{L} {e}^{\frac{j2π l}{T} ( t - s )} ] h ( s ) d s \\ = {\sum }_{l = - L}^{L} [ \frac{1}{T} {\int }_{0}^{T} h ( s ) {e}^{- \frac{j2π l}{T} s} d s ] {e}^{\frac{j2π l}{T} t} = \\ = {\sum }_{l = - L}^{L} h ( l ) {e}^{\frac{j2π l}{T} t} = {S}_{L} ( h ) ( t ) ,\end{matrix} \qquad ( 21 )$$

where S_{L}(h) is the L^{h} partial sum of the Fourier series of h and h(l) is the l^{th} Fourier coefficient. Hence, convergence of [symbol] to h can be represented by the convergence of the Fourier series of h. The result follows from Carleson's theorem.

Remark 3. More generally, if ∫₀^{T}|h(t)|^{P}dt<∞, then [symbol] →h in the L^{P} norm and almost everywhere on t∈[0,T] with increasing Ω, L and fixed T by Hunt's theorem.

From Proposition 1, under suitable conditions for h∈H, [symbol] approximates h arbitrarily closely (in the L² norm, or MSE sense), using a suitable choice of Ω and L. Since the number of measurements needed to identify the projection [symbol] can increase linearly with L, single channel identification can produce a countably infinite number of time encoding systems in order to identify the impulse response of the filter with arbitrary precision. Further, h and [symbol] can be compared in time and frequency domains for multiple values of and L, as shown in FIGS. 12a-12b.

FIG. 12a shows h and its projection [symbol] for several values of Ω and L in the time domain: Ω=2π•20 rad/s, 2π•50 rad/s and 2π•100 rad/s in the top, middle, and bottom rows, respectively. The period Tis fixed at T=0.2 s in the left column and T=0.5 s in the right column. FIG. 12b shows Fourier amplitude spectra of h and [symbol] for the same values of Ω and L as in FIG. 12a. The differentiating filter h can remove the zero-frequency (dc) coefficient corresponding to l=0, as shown in FIG. 12b.

According to another aspect of the disclosed subject matter, a method for identification of a bank of M filters with impulse responses h^{m}=m=1, 2, . . . , M.

Referring to the exemplary MISO ASDM-based circuit in FIG. 3c, a multidimensional signal u=[u¹(t), u²(t), . . . , u^{M}(t)]^{T}. t∈[0,T], can be transformed into a single time sequence (tₖ)ₖ₌₁ⁿ; or alternatively a plurality of time sequences by multiple devices. The circuit is also an exemplary embodiment of a TEM and (assuming z(t₁)=b) its t-transform can be given by

$${\int }_{{t}_{k}}^{{t}_{k + 1}} {\sum }_{m = 1}^{M} ( {u}^{m} * {h}^{m} ) ( s ) d s = 〈 v , {φ}_{k} 〉 = {q}_{k} , \qquad ( 22 )$$

where v=Σₘ(u^{m}*h^{m}(t), φₖ∈ [symbol] with φₖ=Σₗφ_{l,k,}eₗ(t) and qₖ=(−1)^{k}[2Cδ−b(tₖ₊₁−tₖ)]. As discussed above, an exemplary method to identify filters h^{m}, m=1, 2, . . . , M, can include identifying them one-by-one, such as in Theorem 2. For example, identification can be achieved by applying signals of the form u=[0, . . . , 0, u^{m}, 0, . . . , 0] to identify the filter h^{m}. However, many applications, for example early olfaction, can be unsuitable for this method of system identification. An alternative embodiment of a method to identify all the filters substantially simultaneously is provided below.

Theorem 3. (MISO Channel Identification Machine)

Let {uⁱ|nⁱ∈ [symbol] ^{M}}ᵢ₌₁^{N} be a collection of N linearly-independent vector-valued signals at the input of a MISO Filter-Asynchronous Sigma/Delta Modulator (Filter-ASDM) circuit with filters h^{m}∈H, m=1, . . . , M. The filter projections [symbol] ^{m} can be suitably identified from a collection of I/O pairs {(uⁱ [symbol] ⁱ)}ᵢ₌₁^{N} as

$$( 𝒫 {h}^{m} ) ( t ) = {\sum }_{l = - L}^{L} {h}_{l}^{m} {e}_{l} ( t ) , \qquad ( 23 )$$

m=1, .. . , M. The coefficients hₗ^{m} can be given by h=Φ+q with q=[q¹, q², . . . , q^{N}]^{T}, [qⁱ]ₖ=qₖⁱ and h=[h₋ₜ¹, . . . , h_{-L}^{M}, h_{-L+1}¹, . . . , h_{-L+1}^{M},hₗ¹, . . . , hₗ¹. . . , hₗ^{M]}^{T}, provided that the matrix Φ has rank r(Φ)=M(2L+1). The matrix Φ can be given by

$$Φ = [ \begin{matrix}{Φ}^{1} & 0 & … & 0 \\ 0 & {Φ}^{2} & … & 0 \\ ⋮ & ⋮ & ⋱ & ⋮ \\ 0 & 0 & … & {Φ}^{N}\end{matrix} ] [ \begin{matrix}{U}^{1} \\ {U}^{2} \\ ⋮ \\ {U}^{N}\end{matrix} ] , with \\ {U}^{i} = [ \begin{matrix}{u}_{- L}^{i} & 0 & … & 0 \\ 0 & {u}_{- L + 1}^{i} & … & 0 \\ ⋮ & ⋮ & ⋱ & ⋮ \\ 0 & 0 & … & {u}_{L}^{i}\end{matrix} ] , \qquad ( 24 )$$

where uₗⁱ=[uₗⁱ¹, uₗⁱ², . . . , uₗ^{iM}], i=1, 2, . . . , N. Finally, the elements of matrix Φⁱ can be given by

$${[ {Φ}^{i} ]}_{kl} = \{ \begin{matrix}( {t}_{k + 1}^{i} - {t}_{k}^{i} ) , & l = 0 \\ \frac{L \sqrt{T} ( {e}_{l} ( {t}_{k + 1}^{i} ) - {e}_{l} ( {t}_{k}^{i} ) )}{j l Ω} & l \neq 0.\end{matrix} \qquad ( 25 )$$

Proof Since [symbol] ^{m}∈ [symbol] for all m=1, . . . , M. ( [symbol] ^{m})(t)=Σ_{l=-L}^{L}hₗ^{m}eₗ(t). Hence, for the m^{th} component of the stimulus uⁱ, (u^{im}*h^{m})(t)=(u^{im}* [symbol] ^{m})(t)=\sqrt{T}Σ_{l=-L}^{L}hᵢ^{m}uₗ^{m}eₗ(t) and

$${v}^{i} ( t ) = {\sum }_{m = 1}^{M} \sqrt{T} {\sum }_{l = - L}^{L} {h}_{l}^{m} {u}_{l}^{i m} {e}_{l} ( t ) . \qquad ( 26 )$$

Using the definition of φₖⁱ=Σ_{l=-L}^{L}φ_{l,}ⁱeₗ(t) , and substituting eq. (26) into the t-transform of eq. (22),

$${q}_{k}^{i} = 〈 {v}^{i} , {φ}_{k}^{i} 〉 = {\sum }_{m = 1}^{M} {\sum }_{l = - L}^{L} \sqrt{T} {h}_{l}^{m} {u}_{l}^{i m} \overline{{φ}_{l , k}^{i}} \qquad ( 27 )$$

or qⁱ=ΦⁱUⁱh with [qⁱ]ₖ=qₖⁱ, [Φⁱ]ₖₗ=\sqrt{T•φ_{l,k}ⁱ}, Uⁱ=diag(u_{-L}ⁱ, . . . , u_{L}ⁱ), uₗⁱ=[uₗⁱ¹, . . . , uₗ^{iM}] and h=[h_{-L}¹, . . . , h_{-L}^{M}, h_{-L+1}¹, . . . , h_{-L+1}^{M}, . . . , h_{L}¹, . . . , h_{L}^{M}]^{T}. Repeating for all stimuli uⁱ, i=1, . . . , N, q=Φh with Φ as shown in eq. (24). This system of linear equations can be solved for h, provided that the rank of Φ satisfies the condition r(Φ)=M(2L+1) To find the coefficients φ̅_̅{̅l̅,̅k̅}̅ⁱ̅, φ_{l,k}ⁱ= [symbol] , which provides the result as discussed above.

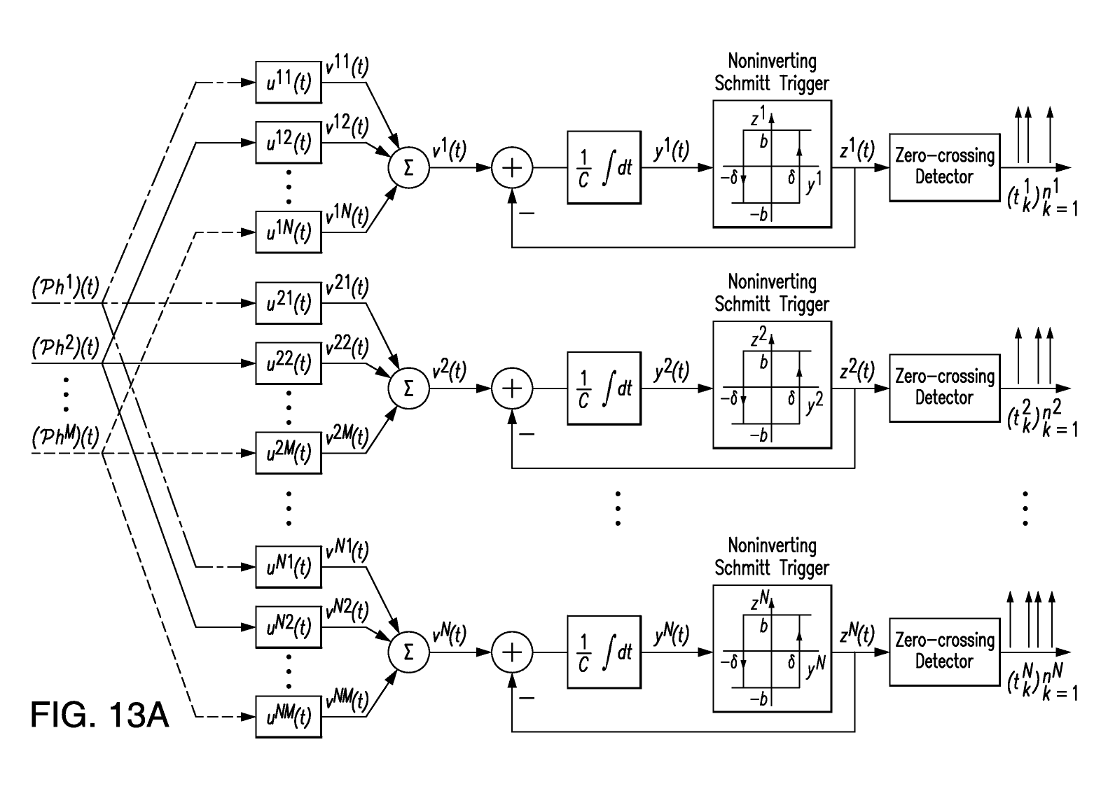

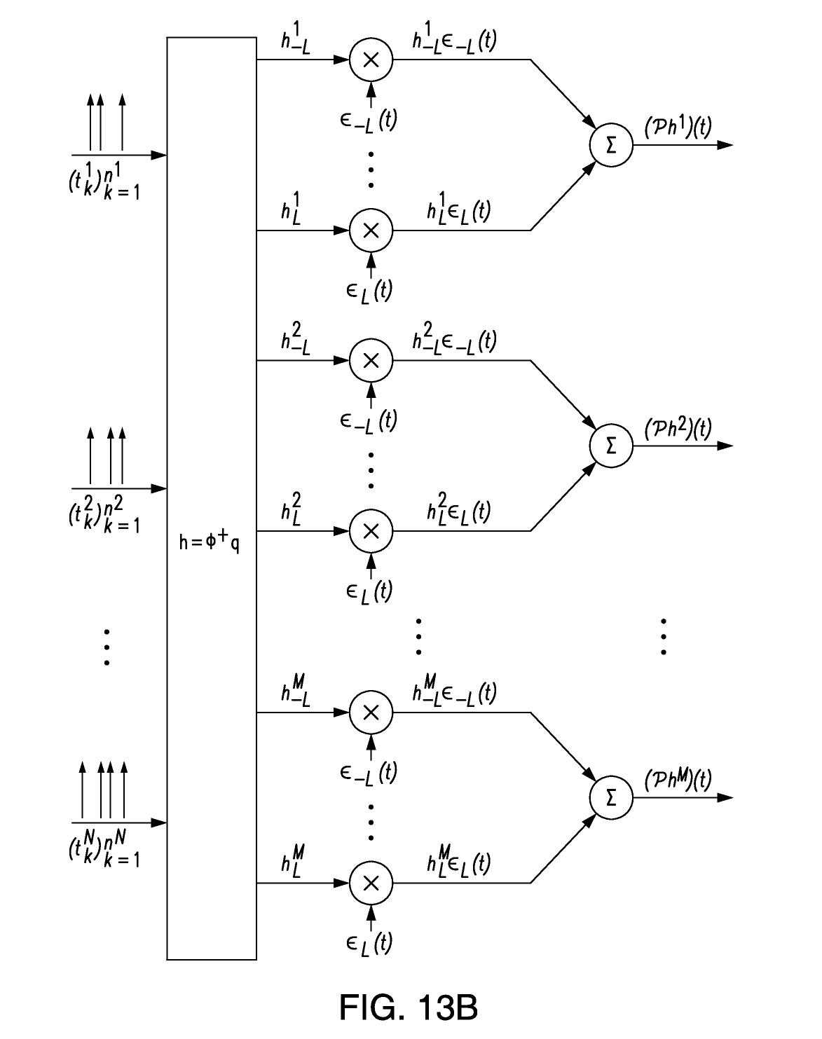

FIG. 13a shows an exemplary MIMO time-encoding interpretation of channel identification for an exemplary MISO Filter-ASDM-ZCD circuit (shown in FIG. 3c), thereby showing conditional duality between MIMO time encoding and MISO channel identification. FIG. 13b shows a block diagram of an exemplary MISO channel identification machine.

Remark 4. Using eq. (26), vⁱ=Σ_{l=-L}^{L}vₗⁱeₗ(t) with vₗⁱ=\sqrt{T}Σ_{m≦1}^{M}hₗ^{m}uₗ^{im}. For all i=1 , . . . , N, vₗ=Uₗhₗ, where [Uₗ]ᵢₘ=\sqrt{T}uₗ^{im}•hₗ=[hₗⁱ, hₗ², . . . hₗ ^{M}]^{T} and vₗ=[vₗ¹, vₗ², . . . , vₗ^{N}]^{T}. To identify the multidimensional channel, this system of equations can be solved for every l. It can also be that N≧M, i.e., the number N of test signals uⁱ can be greater than the number of signal components M.

Remark 5. The rank condition r(Φ)=M(2L+1) can be satisfied by increasing the number N of input signals uⁱ. For example, if on average the system is providing v measurements in a time interval t∈[0,T], then the number of test signals N can be at least N=[M(2L+1)/v].

### Example

### MISO Filter-ASDM-ZCD Circuit

Results for identifying the channel in the exemplary MISO Filter-ASD114-ZCD circuit of FIG. 3c are described below. Three exemplary filters used can be, for example and without

$${h}^{1} ( t ) = c {e}^{- α t} [ \frac{{( α t )}^{3}}{3 !} - \frac{{( α t )}^{5}}{5 !} ] , \\ {h}^{2} ( t ) = {h}^{1} ( t - β ) , \\ {h}^{3} ( t ) = - {h}^{1} ( t ) , \qquad ( 28 )$$

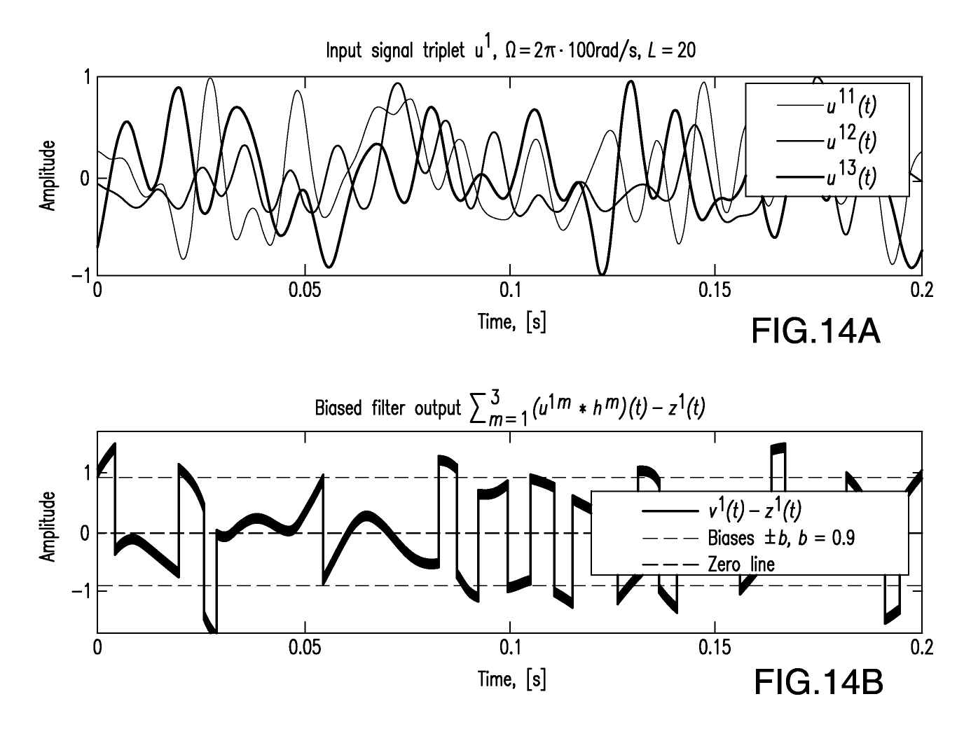

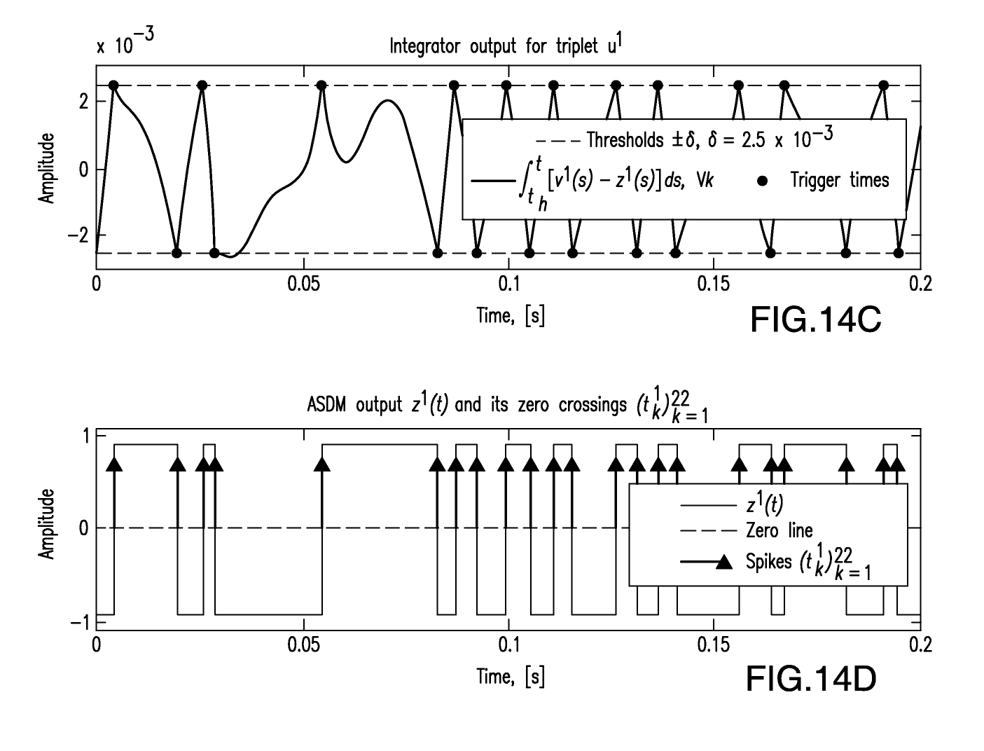

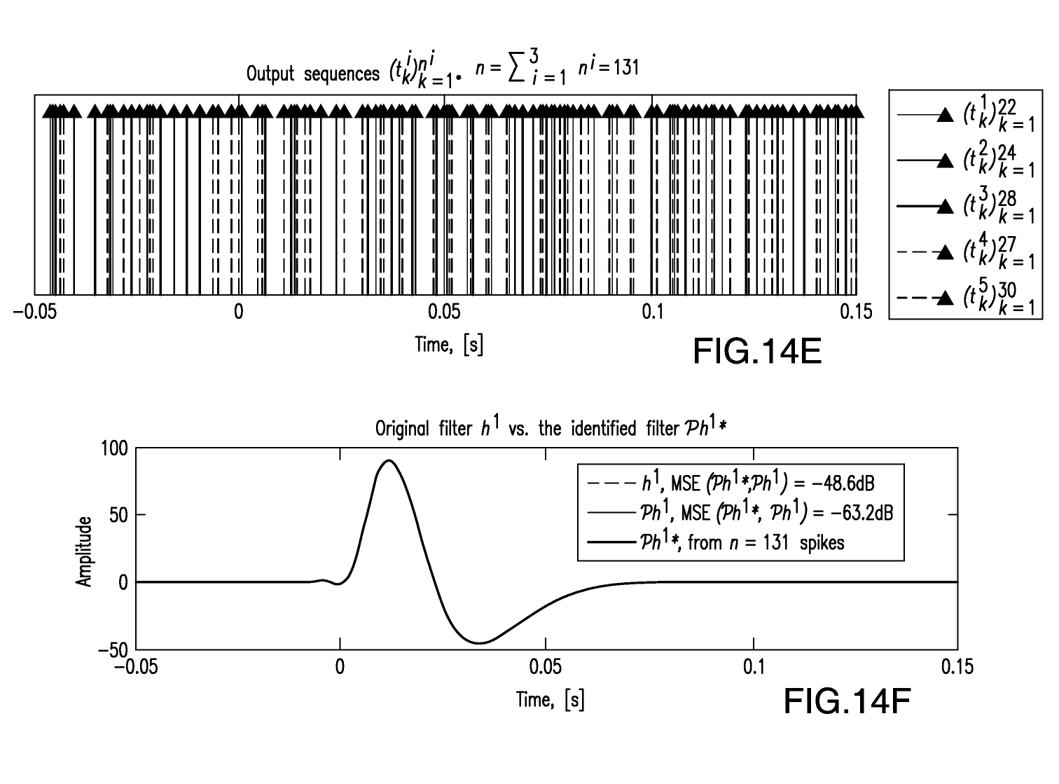

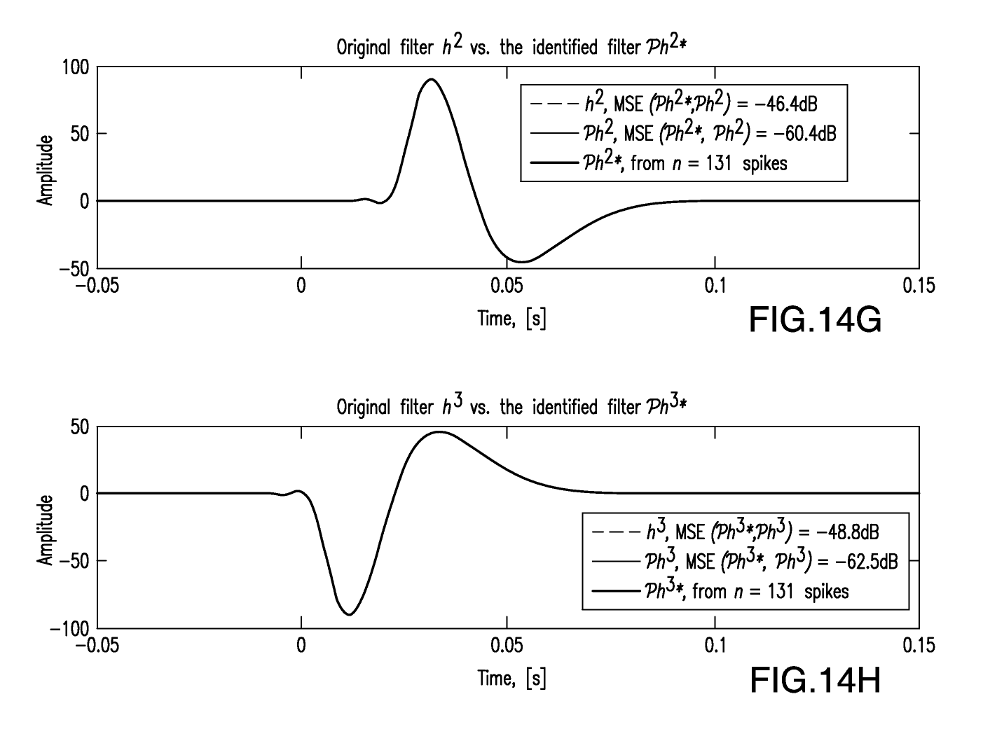

with t∈[0, 0.1]s, c=3 and α=200 and β=20 ms. Signals can be bandlimited to 100 Hz and have a period of T=0.2 s, and thus, the order of the space L=20. Using Theorem 3, the ASDM can generate at least M(2L+2)=126 trigger times to identify the projections [symbol] ¹, [symbol] ², and [symbol] ³ substantially free of loss. N can equal 5 different triplets uⁱ=[uⁱ¹, uⁱ², uⁱ³], i=1, . . . , 5, to generate 131 trigger times. A single such triplet u¹ is shown in FIG. 14a. The corresponding biased aggregate channel output v¹(t)−z¹(t) is shown in FIG. 14b. Since the Schmitt trigger output z(t) can switch between +b and −b (as shown in FIG. 14d), the signal v¹(t)−z¹(t) can be piece-wise continuous. FIG. 14c shows the integrator output. When z(t)=−b, the channel output can be positively biased and the integrator output ∫tₜₖ^{t}[v¹(s)−z(s)]ds can be compared against a threshold +δ. When that threshold is reached, the Schmitt trigger output can switch to z(t)=b, and the negatively-biased channel output can be compared to a threshold −δ. Passing the ASDM output z¹(t) through a zero-crossing device (as shown in FIG. 14d), a corresponding sequence of trigger times (tₖ¹)ₖ₌₁²² can be obtained. The set of all 131 trigger times is shown in FIG. 14e. Three identified filters [symbol] ^{1*}• [symbol] ^{2*} and [symbol] ^{3*} are plotted in FIGS. 14f-14h, respectively. The MSE between filter projections and filters recovered by the algorithm in Theorem 3 is on the order of −60 dB.

### Example

### MISO Filter-HH/MC Circuit

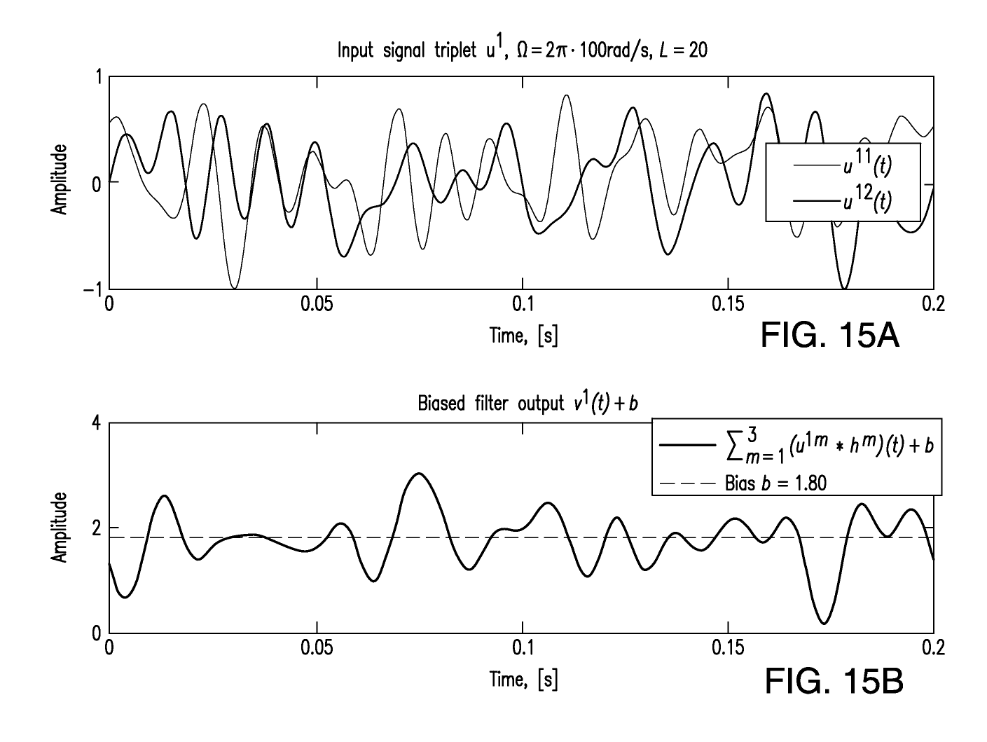

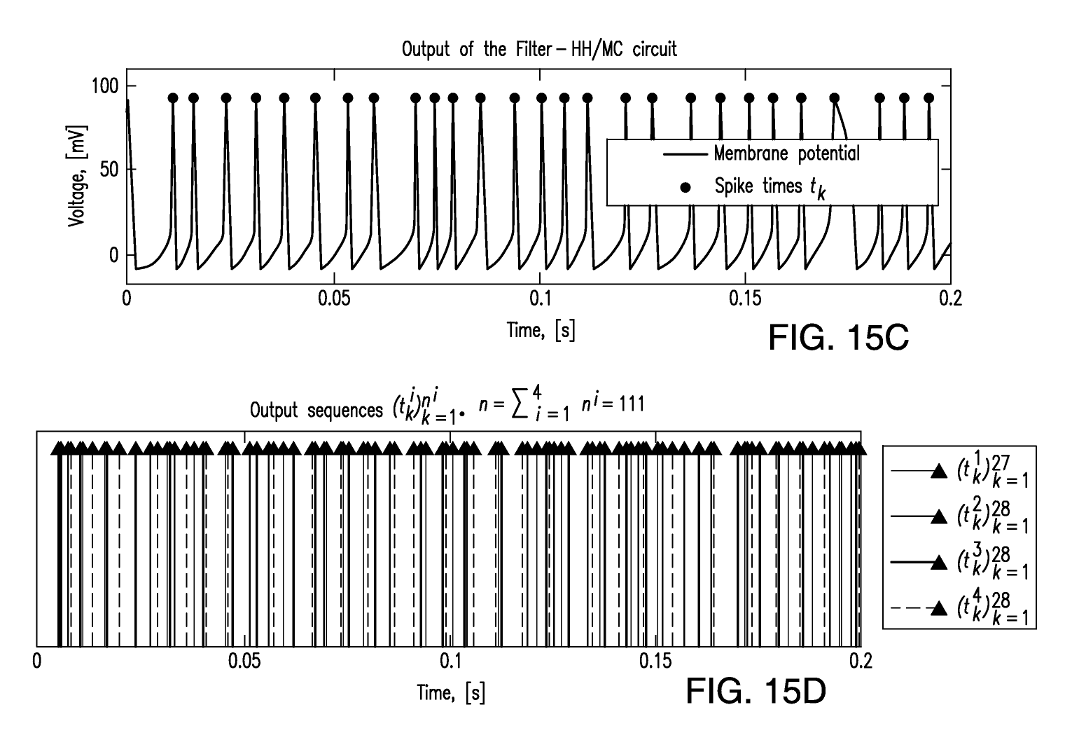

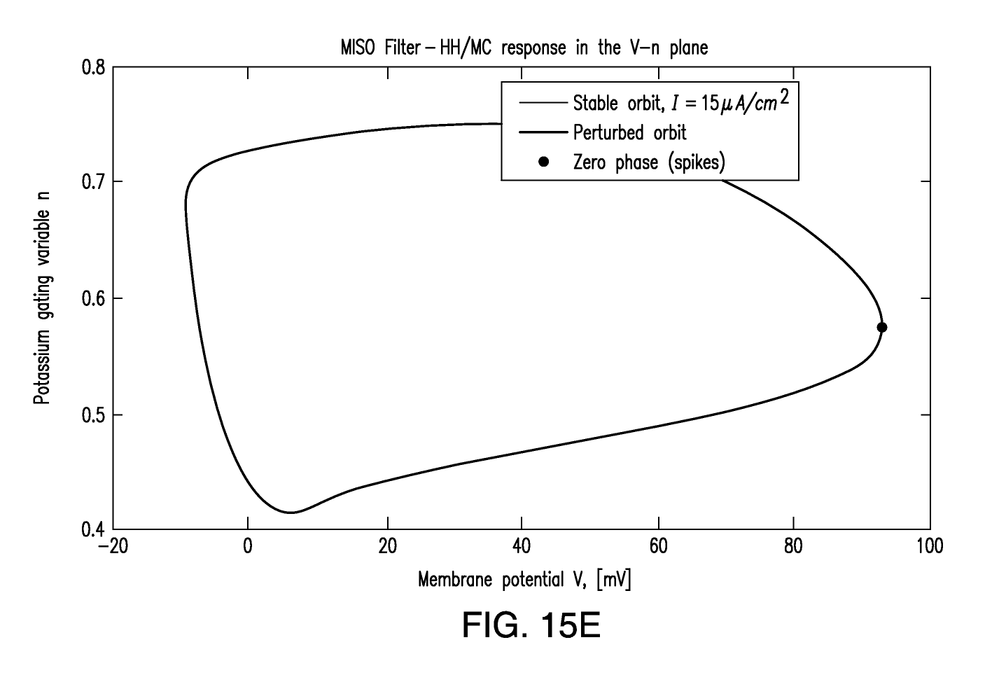

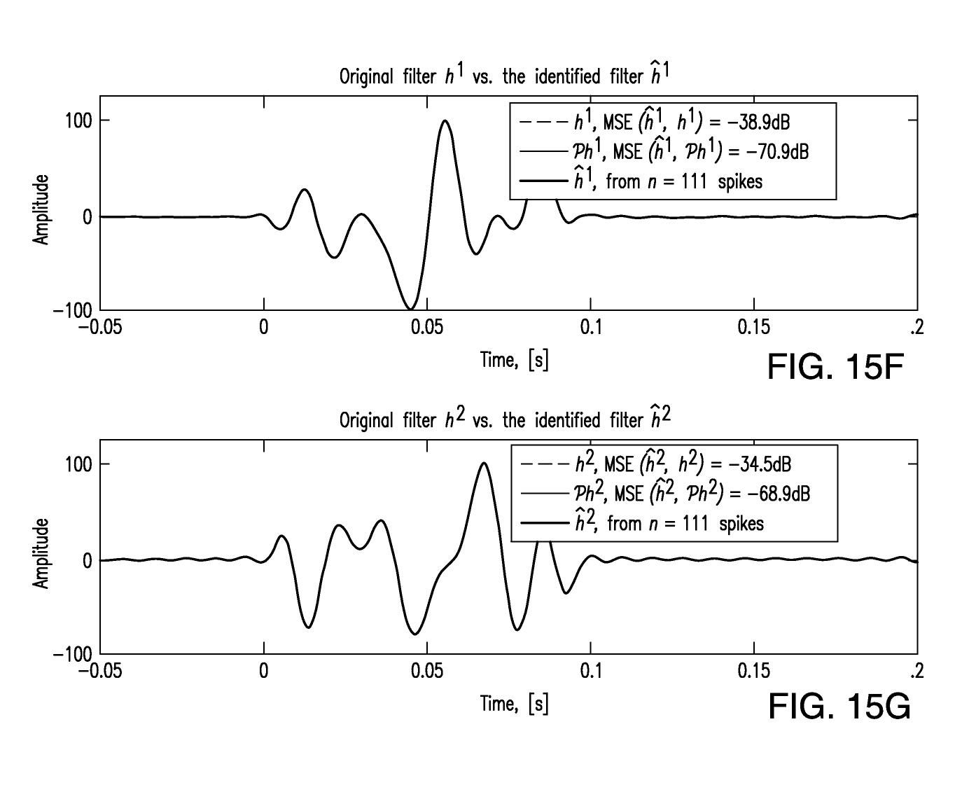

Results for identifying the channel in the exemplary MISO Filter-HH/MC circuit of FIG. 4 are described below. With reference to FIGS. 15a-15g, signals sent to the MISO Filter-HH/MC circuit can be bandlimited to 100 Hz and have a period of T=0.2 s, and thus, the order of the space L=20. An input signal triplet u¹ is shown in FIG. 15a. The corresponding biased filter output v¹(t)+b is shown in FIG. 15b. FIG. 15c shows the circuit output. The set of 111 trigger times is shown in FIG. 15d. The phase response of the MISO Filter-HH/MC in the V-n plane is shown in FIG. 15e. Two identified filters h¹ and h² are plotted in FIGS. 15f-15g, respectively. The MSE between filter projections and filters recovered by the algorithm in Theorem 3 is on the order of −70 dB.

According to another aspect of the disclosed subject matter, the results presented above are generalized in two areas. In one embodiment, a class of signal spaces for test signals is provided. In another embodiment, channel models with noisy observations are provided.

Previous embodiments described herein provide channel identification for particular spaces of input signals, for example in the space of trigonometric polynomials. The finite-dimensionality of this space and the relative simplicity of the associated inner products make the spaces suitable for implementation of a SISO CIM or MISO CIM. However, fundamentally the identification methodology can rely on the geometry of the Hilbert space of test signals. Computational tractability can be based on kernel representations in an RKHS.

Theorem 4. Let {uⁱ|uⁱ∈ [symbol] (I)}ᵢ₌₁^{N} be a collection N of linearly independent and bounded stimuli at the input of a Filter-Asynchronous Sampler circuit with a linear processing filter h∈H and the t-transform

[symbol]

ₖⁱ( [symbol] )=qₖⁱ (29)

where [symbol] ₖⁱ: [symbol] → [symbol] is a bounded linear functional mapping [symbol] into a measurement qₖⁱ. Then there is a set of sampling functions {(φₖⁱ)k∈ [symbol] }ᵢ₌₁^{N}, in [symbol] such that

qₖⁱ= [symbol] [symbol] , φₖⁱ [symbol] , (30)

for all k∈ [symbol] , i=1, 2, . . . , N. Furthermore, if [symbol] is an RKHS with a kernel K(s,t), s, t∈I, then φₖⁱ(t)= [symbol] . Let the set of representation functions {(ψₖⁱ)k∈ [symbol] }ᵢ₌₁^{N}, span the Hilbert space [symbol] . Then

$$( Ph ) ( t ) = {\sum }_{i = 1}^{N} {\sum }_{h ∈ ℤ} {h}_{k}^{t} {ψ}_{k}^{i} ( t ) . \qquad ( 31 )$$

If {(φₖⁱ)k∈ [symbol] }ᵢ₌₁^{N} and {(φₖⁱ)k∈ [symbol] }ᵢ₌₁^{N} are orthogonal bases or frames for [symbol] then the filter coefficients amount to h=Φ+q, where h=[h¹, h², h^{N}]^{T} with [hⁱ]ₖ=hₖⁱ, [Φ^{ij}]ᵢₖ= [symbol] φₖⁱ, φₖⁱ [symbol] and [q¹, q², . . . , q^{N}]^{T} with [qⁱ]ₗ=qₖⁱ for all i, j=1, 2, . . . , N and k, l∈ [symbol] .

Proof: By the Riesz representation theorem, since the linear functional [symbol] ₖ: [symbol] → [symbol] can be bounded, there can be a set of sampling functions {(φₖⁱ)k∈ [symbol] }ᵢ₌₁^{N} in [symbol] such that [symbol] ₖⁱ( [symbol] )= [symbol] [symbol] , φₖⁱ [symbol] . If [symbol] is an RKHS, a sampling function φₖⁱ can be computed using the reproducing property of the kernel K as in

φₖⁱ(t)= [symbol] φₖⁱ, K(•,t) [symbol] ≡ [symbol] = [symbol] . (32)

Finally, writing all inner products [symbol] φₖⁱ, [symbol] [symbol] =qₖⁱ yields, with reference to the notation above, a system of linear equations Φh=q and the filter coefficients amount to h=Φ+q.

### Example

### Paley-Wiener Space

In an exemplary embodiment, the Paley-Wiener space, which is relatively closely related to the space of trigonometric polynomials, is considered. For example, the finite-dimensional space [symbol] can be a discretized version of the infinite-dimensional Paley-Wiener space

Ξ={u∈ [symbol] ²( [symbol] )|supp( [symbol] u) ⊂ [−Ω, Ω]} (33)

in the frequency domain. An element u∈ [symbol] can have a line spectrum at frequencies lΩ/L. l=−L, −L+1, . . . , L. This spectrum can become relatively dense in [−Ω, Ω] as L→∞. The space Ξ with an inner product [symbol] •, • [symbol] : Ξ×Ξ→ [symbol] given by

[symbol]

u,w [symbol] = [symbol] u(t)w(t)dt (34)

can also be an RKHS with an RK

$$K ( s , t ) = \frac{sin ( Ω ( t - s ) )}{π ( t - s )} . \qquad ( 35 )$$

with t,s∈ [symbol] . Defining the projection of the filter h onto Ξ as

( [symbol] ) (t)= [symbol] (s) K̅(̅s̅,̅t̅)̅ds, (36)

Lemma 1 holds with φₖ∈Ξ and Theorem 2 can be applied as discussed below.

Proposition 2. Let {uⁱ|supp( [symbol] uⁱ)=[−Ω, Ω]}ᵢ₌₁^{N} be a collection of N linearly independent and bounded stimuli at the input of a Filter-Ideal IAF neural circuit with a dendritic processing filter h∈H. If

$${\sum }_{j = 1}^{N} \frac{b}{C δ} > \frac{Ω}{π} ,$$

then ( [symbol] )(t) can be suitably identified from the collection of I/O pairs {(uⁱ, [symbol] )}ᵢ₌₁^{N} as

$$( Ph ) ( t ) = {\sum }_{i = 1}^{N} {\sum }_{k ∈ ℤ} {h}_{k}^{i} {ψ}_{k}^{i} ( t ) , \qquad ( 37 )$$

where ψₖⁱ(t)=K(t,tₖⁱ), i=1, 2, . . . , N, and k∈ [symbol] . Furthermore, h=Φ+q, where h=[h¹, h², . . . , h^{N}]^{T} with [hⁱ]ₖ=hₖⁱ, [Φ^{ij}]ₗₖ=∫ [symbol] uⁱ(s−tₖ^{j})ds and q=[q¹, q², . . . q^{N}]^{T} with [qⁱ]ₗ=Co−b(tₗ₊₁ⁱ−tₗⁱ) for all i,j=1, 2, . . . , N, and k,l∈ [symbol] .

Proof As discussed above, the spikes(tₖⁱ)k∈ [symbol] in response to each test signal uⁱ, i=1, 2, . . . N, can represent distinct measurements qₖ= [symbol] φₖⁱ, [symbol] [symbol] of ( [symbol] )(t). Thus, the {(qₖⁱ)k∈ [symbol] }ᵢ₌₁^{N}, s can be projections of [symbol] onto {(φₖⁱ)k∈ [symbol] }ᵢ₌₁^{N}, where

φₖⁱ(t)= [symbol] ₖ(K(•, t))=∫ₜ_{ₖ}_{^{l}}^{t}^{ₖ₊₁}_{ₗ}∫_{R}uⁱ(z) K(s−z,t)dzds=∫ₜ_{ₖ}_{^{l}}^{t}^{ₖ₊₁}_{ₗ}uⁱ(s−t)ds . (38)

Since the signals can be linearly independent and bounded, if

$${\sum }_{j = 1}^{N} \frac{b}{C δ} > \frac{Ω}{π} ,$$

or equivalently if the number of test signals

$$N > \frac{Ω C δ}{π b} ,$$

the set of functions {(ψₖⁱ)k∈ [symbol] }ᵢ₌₁^{N} with ψₖⁱ(t)=K(t,tₖⁱ). can be a frame for Ξ. Hence,

$$( Ph ) ( t ) = {\sum }_{i = 1}^{N} {\sum }_{k ∈ ℤ} {h}_{k}^{i} {ψ}_{k}^{i} ( t ) . \qquad ( 39 )$$

If the set of functions {(φₖⁱ)k∈ [symbol] }ᵢ₌₁^{N} can form a frame for Ξ, the coefficients hₖⁱ, k∈ [symbol] , i=1, 2, . . . , N, can be found by taking the inner product of eq. (39) with each element of {φₗⁱ(t)}ᵢ₌₁^{N}:

$$\begin{matrix}〈 {φ}_{l}^{i} , Ph 〉 = {\sum }_{k ∈ ℤ} {h}_{k}^{1} 〈 {φ}_{l}^{2} , {ψ}_{k}^{1} 〉 + {\sum }_{k ∈ ℤ} {h}_{k}^{2} 〈 {φ}_{l}^{i} , {ψ}_{k}^{2} 〉 + … + \\ {\sum }_{k ∈ ℤ} {h}_{k}^{N} 〈 {φ}_{l}^{i} , {ψ}_{k}^{N} 〉 \\ ≡ {q}_{l}^{i} .\end{matrix} \qquad ( 40 )$$

for i=1, 2, . . . , N, l∈ [symbol] . Letting [Φ^{ij}]ₗₖ= [symbol] φₗⁱ, φₖ^{j} [symbol] .

$${q}_{l}^{i} = {\sum }_{k ∈ ℤ} {[ {Φ}^{i 1} ]}_{lk} {h}_{k}^{1} + {\sum }_{k ∈ ℤ} {[ {Φ}^{i 2} ]}_{ik} {h}_{k}^{2} + … + {\sum }_{k ∈ ℤ} {[ {Φ}^{iN} ]}_{lk} {h}_{k}^{N} , \qquad ( 41 )$$

for i=1, 2, . . . , N, l∈ [symbol] . Writing eq. (41) in matrix form, q=Φh with

[Φ^{ij}]ₗₖ= [symbol] φₗⁱ, φₖ^{j} [symbol] = [symbol] φₗⁱ(•), K(•, tₖ^{j}) [symbol] =φₗⁱ(tₖ^{j})=∫_{μ}^{μ+1}uⁱ(s−tₖⁱ) ds (42)

Furthermore, the coefficients hₖⁱ, i=i, 2, . . . , N and k ∈ [symbol] , can amount to h=Φ+q.

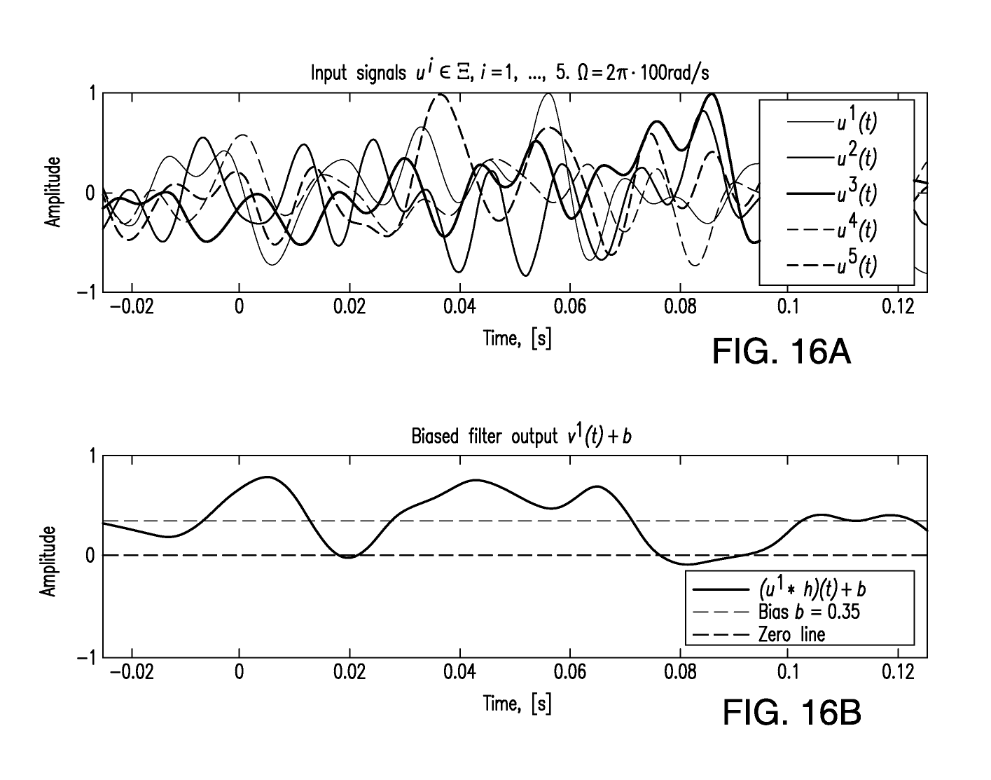

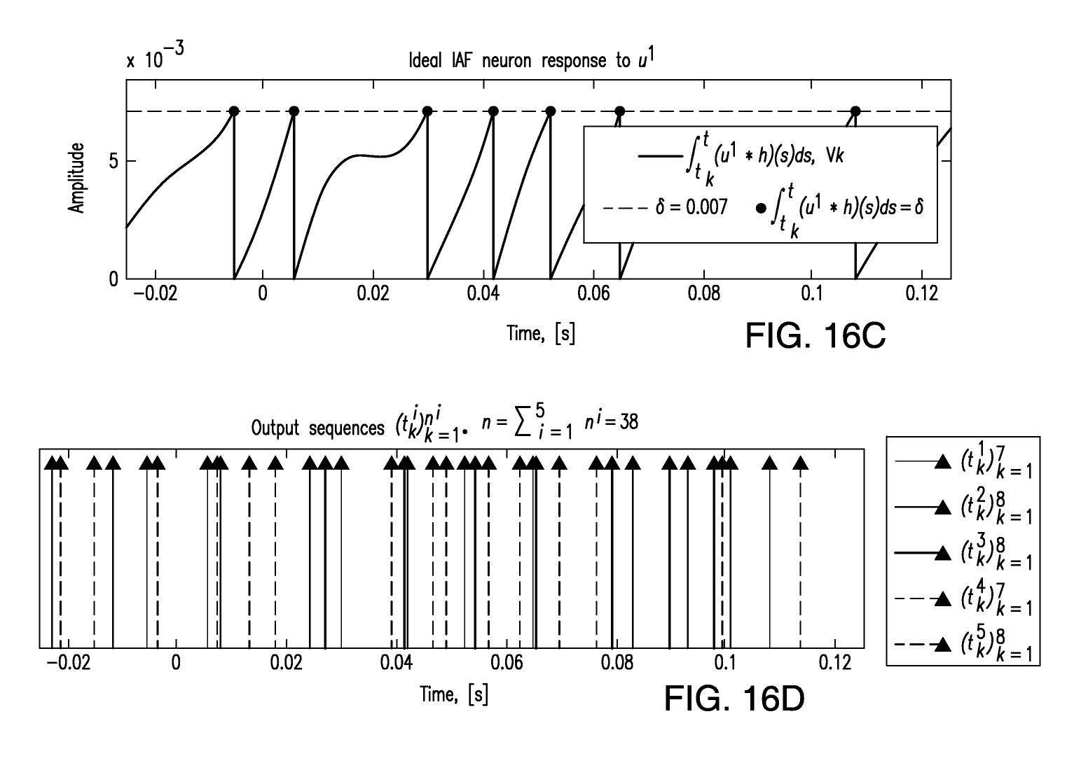

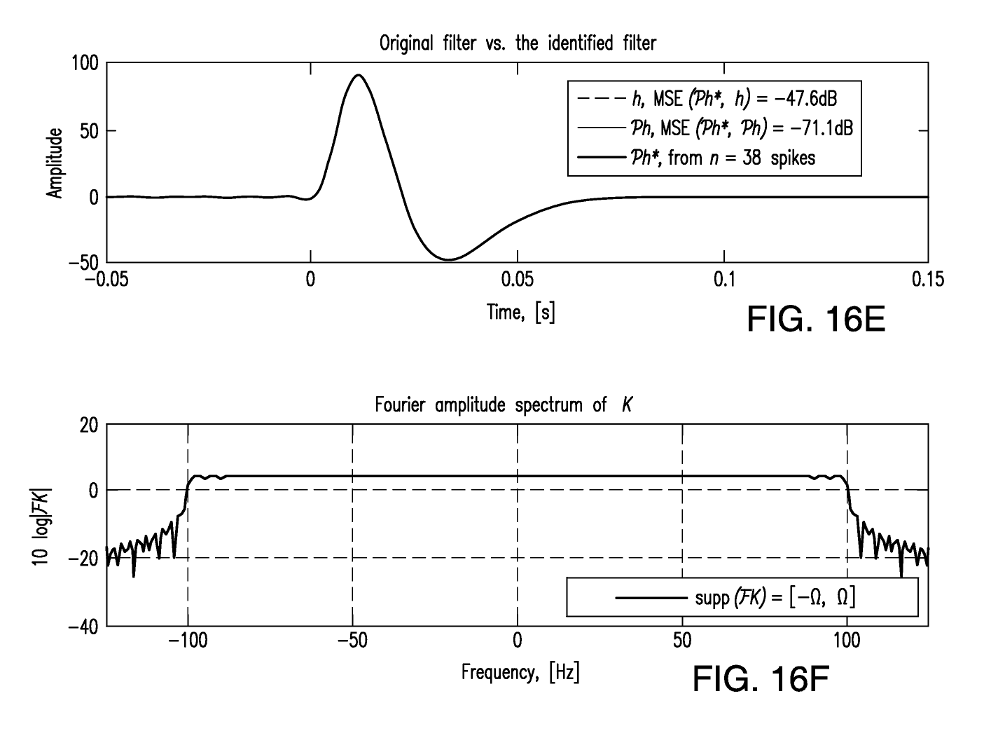

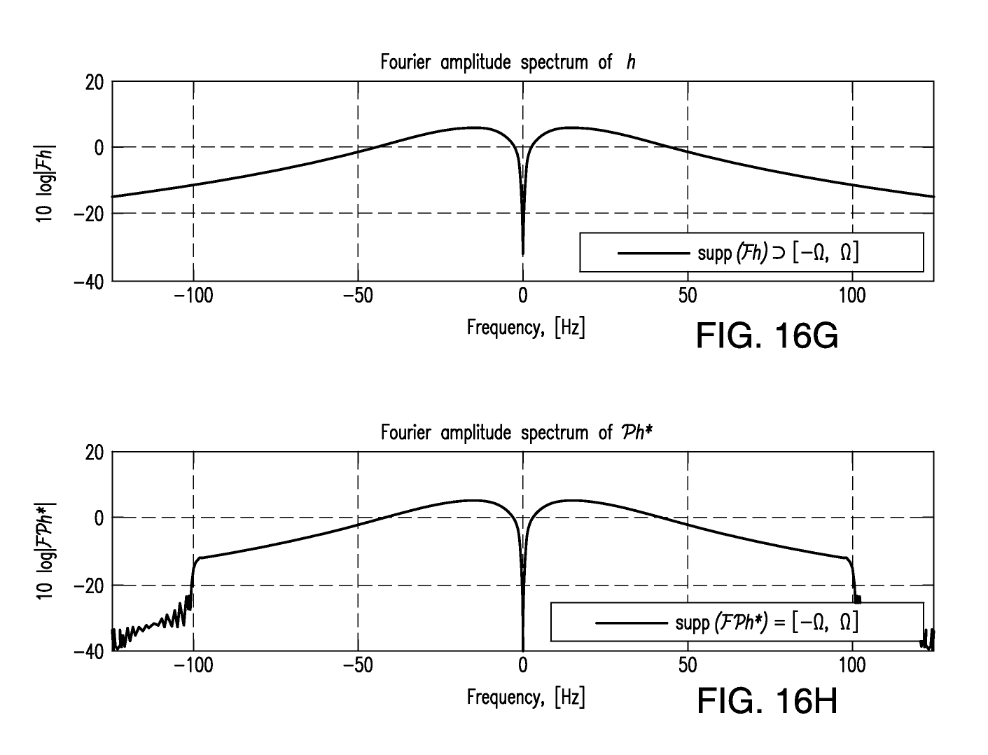

Results of a SISO CIM for a Paley-Wiener space of test signals is shown in FIGS. 16a-16h. As shown in FIG. 16a, and in contrast to FIG. 9a, input signals uⁱ∈Ξ, i=1, . . . , 5. Input signals u¹, . . . u⁵ can be bandlimited to 100 Hz. FIG. 16b shows biased output of the filter) u¹(t)+b in response to the stimulus u¹. As shown in FIG. 16c, the filter output in FIG. 16b is integrated by an ideal IAF neuron. As shown in FIG. 16d, the neuron generated 38 spikes in response to the 5 input signals. In FIG. 16e, the identified impulse response of the filter [symbol] * is shown with the original filter h and its projection [symbol] . The MSE between the identified filter [symbol] * and the projection [symbol] is −71.1 dB. FIGS. 16f-16h show Fourier amplitude spectra of K, h, and [symbol] *, respectively. In contrast to FIGS. 8a-8h, K and [symbol] * do not exhibit a discrete (line) spectrum. [symbol] * ∈Ξ but h ∉Ξ.

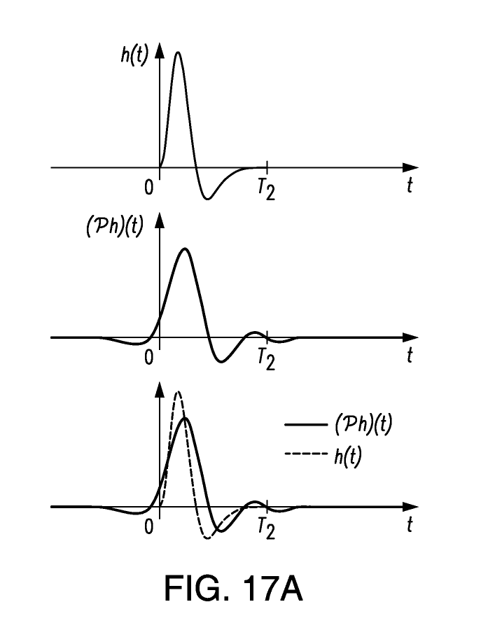

In an alternative embodiment of the disclosed subject matter, a plurality of temporal windows of a test signal can be used to identify a filter, as an alternative or in addition to using a plurality of test signals, as shown in FIGS. 17-20. FIGS. 17a-17b show a change of coordinates according to the disclosed subject matter. FIG. 17a shows an example of a causal impulse response h(t) with supp(h)=[T₁, T₂], T₁=0 (top), a projection [symbol] of h onto some Ξ (middle), and h (t) and ( [symbol] )(t) plotted on the same set of axes (bottom). FIG. 17b shows an input signals u(t) with supp( [symbol] u)=[−Ω, Ω] (top), light shaded spikes from a temporal window W=(τ₁, τ₂) used to construct ĥ(t) (middle), and [symbol] approximated by ĥ(t) on |t∈[T₁, T₂] using spike times (tₖ−τ+T)k:tₖ∈W.

For a SIMO TEM with a common input signal u∈Ξ and a vector filtering kernel h(t)=[h¹(t), h²(t), . . . , h^{N}(t)]^{T}, the stimulus u(t) can be reconstructed from a collection of spike times {(tₖ¹)k∈ [symbol] , . . . , (tₖ^{N})k∈ [symbol] } using a multiple-input single-output (MISO) time decoding machine (TDM). The recovery is given by u(t)=Σᵢ₌₁^{N}Σ_{k∈} [symbol] cₖ^{j}ψₖ^{j}(t), where ψₖ^{j}(t)=g (t−tₖ^{j}), c=G+q and [G^{ij}]ₗₖ= [symbol] φₗⁱ, ψₖ^{j} [symbol] = [symbol] g*1_{[t}_{ₗ}_{ⁱ}_{·t}_{ₗ}_{ⁱ⁺}]*\check{h}ⁱ, g(·−tₖ^{j}) [symbol] =∫ₜ_{ₗ}^{ᵢ}^{t}^{ₗ₊₁}^{ⁱ}(hⁱ*g)(s−tₖ^{j})ds.

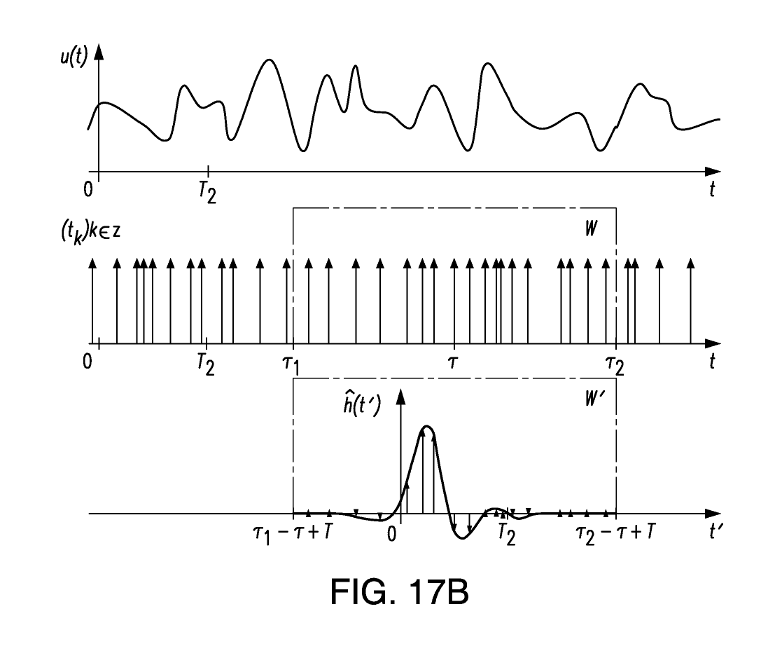

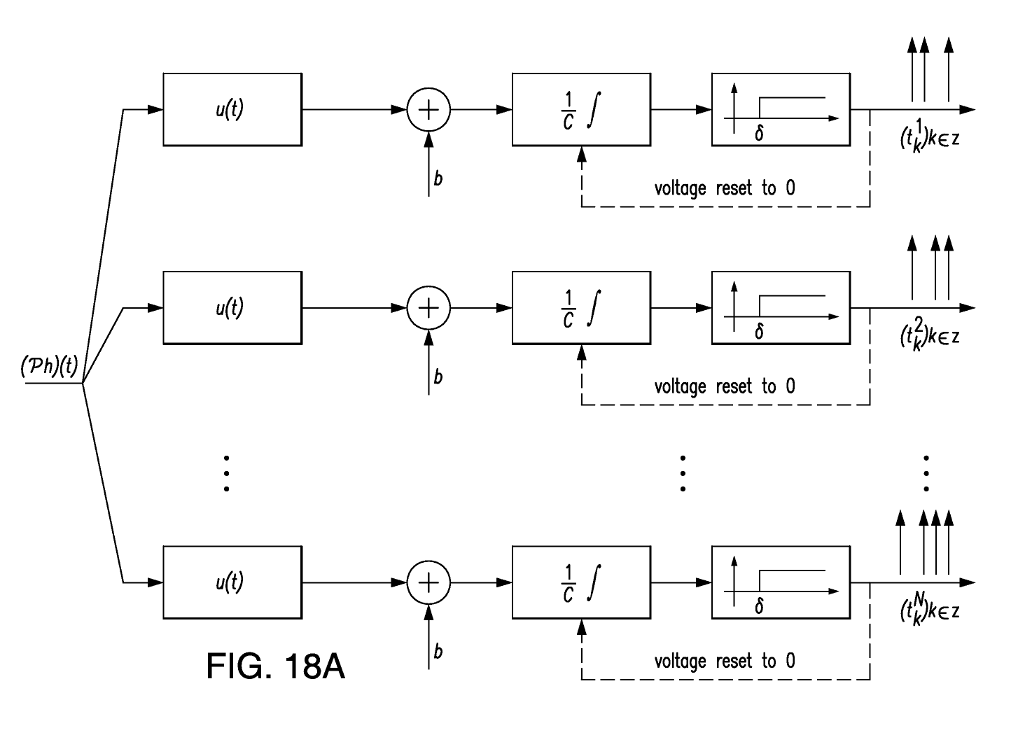

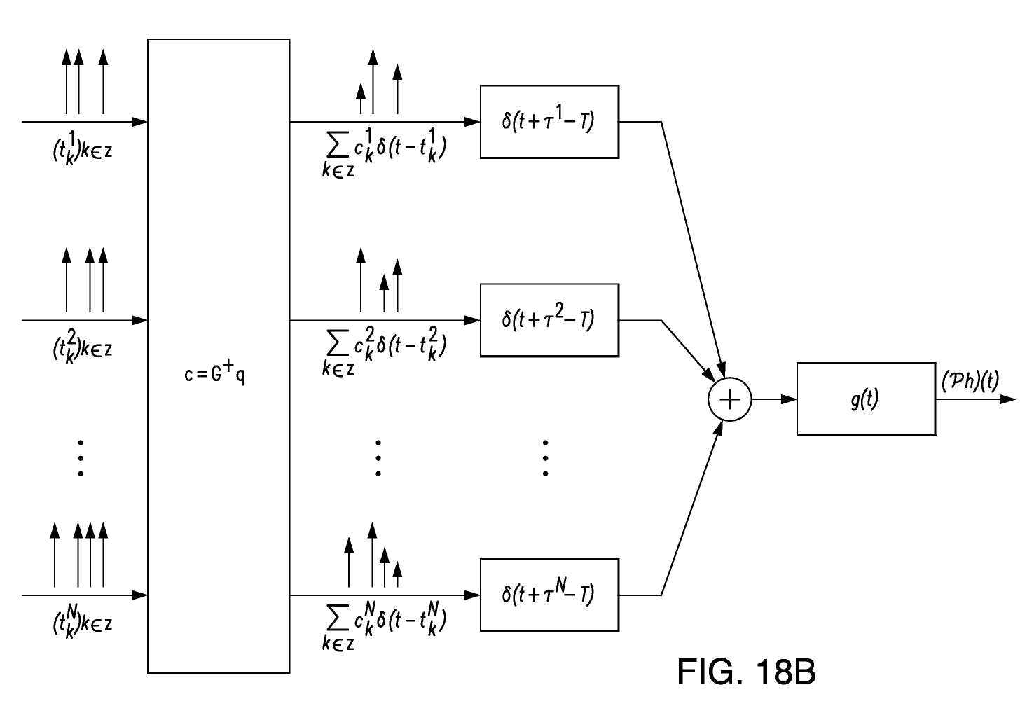

From a systems identification point of view, [symbol] ∈Ξ encoded using a SIMO TEM with a vector filtering kernel given by [h]ᵢ=u, for i=1, 2, . . . , N, as shown in FIG. 18a. A block diagram of the identification algorithm is shown in FIG. 18b.

The disclosed subject matter described herein can be applied to other spiking neuron models. For example, for a leaky IAF neuron,

$${[ {q}^{i} ]}_{l} = C δ - bRC [ 1 - exp ( \frac{{t}_{l}^{i} - {t}_{l + 1}^{i}}{RC} ) ] , \\ {and \\ [ {G}^{ij} ]}_{lk} = {\int }_{{t}_{l}^{i}}^{{t}_{l + 1}^{i}} u ( s - ( {t}_{k}^{j} - {τ}^{j} + T ) ) exp ( \frac{s - {t}_{l + 1}^{i}}{RC} ) d s .$$

Similarly, for a TAF neuron with a bias b and a threshold δ,[qⁱ]ₗ=δ−b, and [G^{ij}]ₗₖ=u(tₗ^{i-(t}ₖ^{j-τ}^{j}+T)).

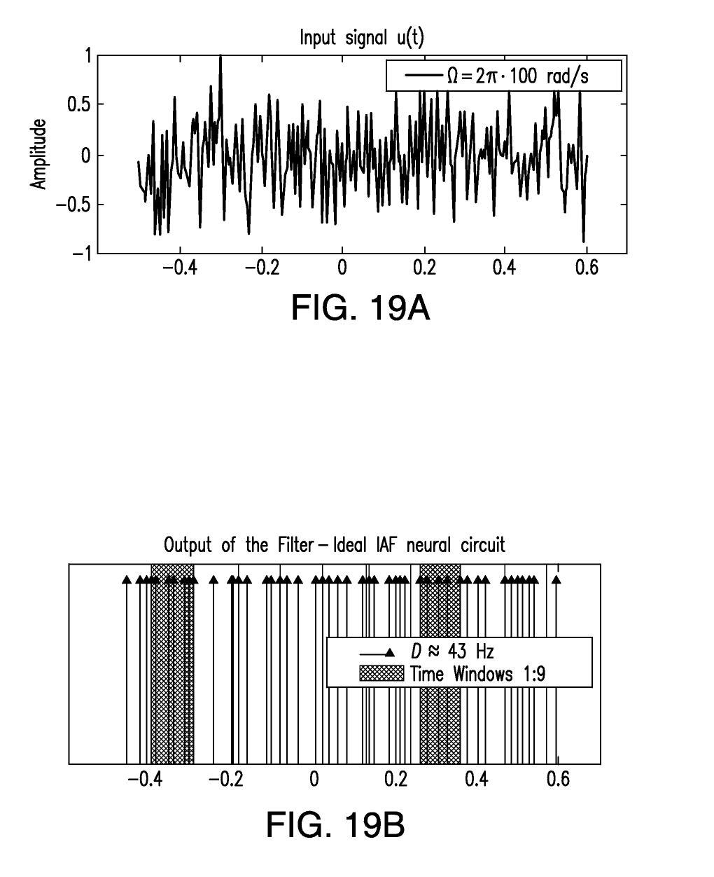

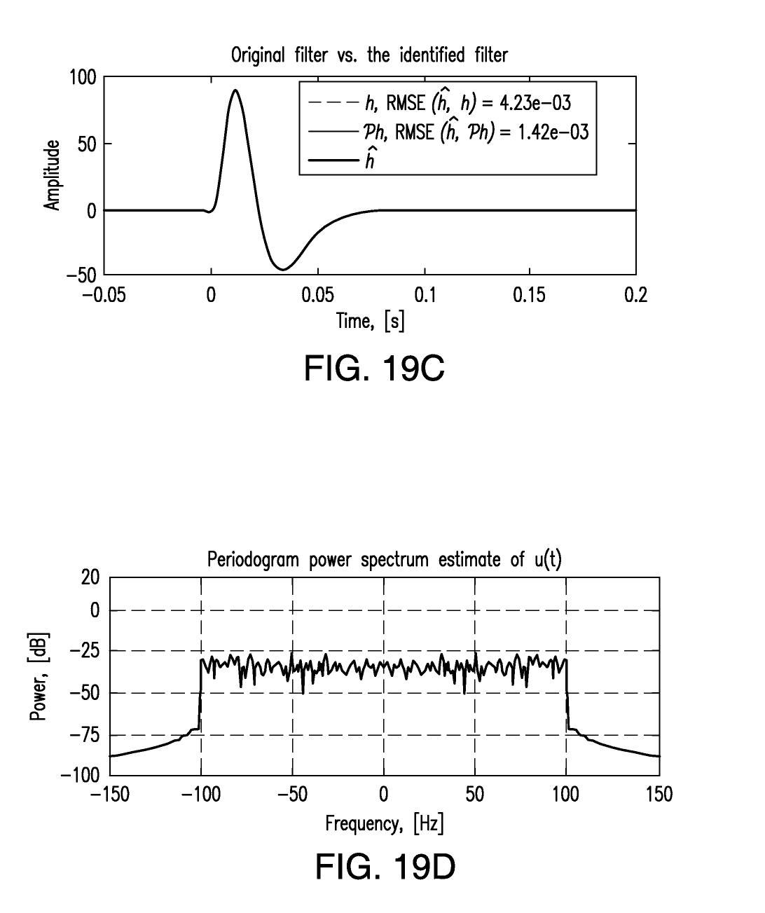

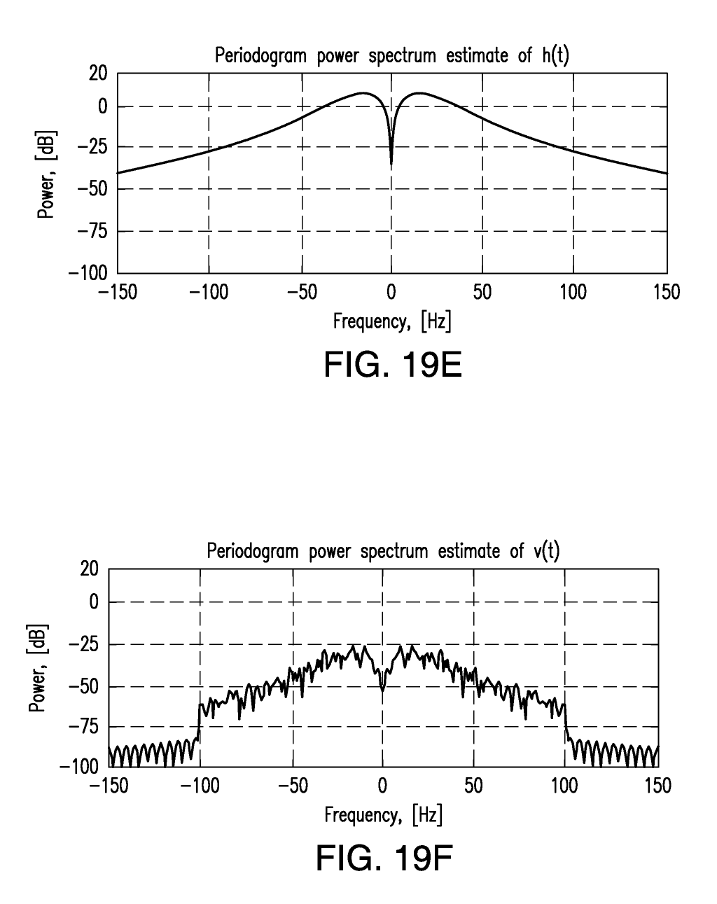

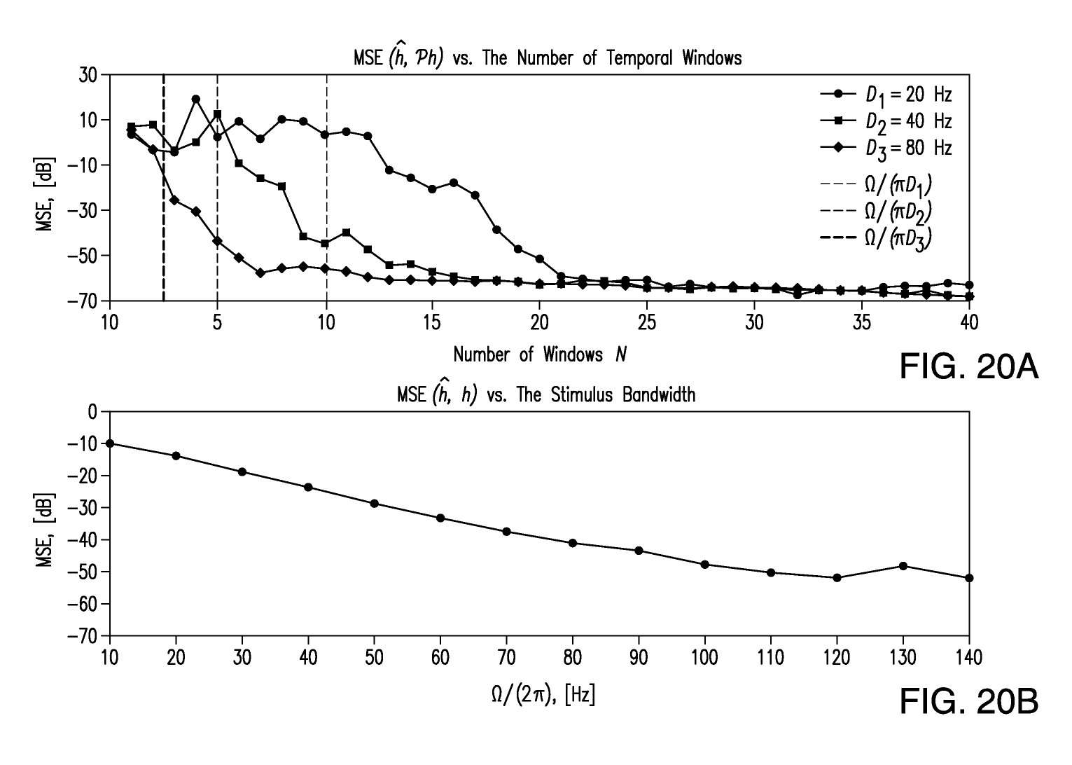

FIGS. 19-20 further describe the performance of this alternative embodiment of the disclosed subject matter. A dendritic processing filter using a causal linear kernel h(t)=ce^{-αt} [(αt)³/3!−(αt)⁵/5!] with t∈[0,0.1s], c=3 and α=200 is modeled. The general form of this kernel can approximate the temporal structure of a visual receptive field, In FIG. 19a, the stimulus is bandlimited to Ω=π•100 rad/s. Although the kernel h can have an infinite bandwidth (having a finite temporal support), the effective bandwidth of the kernel Ω≈2π•100 rad/s. As shown in FIGS. 19a-19f, kernel h can be nearly reconstructed itself.

FIGS. 19a-19f show certain aspects of this alternative embodiment of identifying dendritic processing in a Filter-ideal IAF neural circuit, where Ω=π•100 rad/s, FIG. 19a shows signal u(t) at the input to the circuit. FIG. 19b shows the output of the circuit is a set of spikes at times (tₖ)_{k∈} [symbol] . The spike density D≈43 Hz. In this example, only 43 spikes from 9 temporal windows are used to construct ĥ. FIG. 19c shows the RMSE between ĥ and [symbol] is 1.42×10⁻³. The RMSE between ĥ and h is 4.23×10³. FIG. 19d shows the spectral estimate of u∈Ξ showing that supp( [symbol] u)=[−Ω, Ω].l FIG. 19e shows the spectral estimate of h showing that h∈Ξ. FIG. 19f shows the spectral estimate of v=u*h showing to what extent the signal u explores h.

In FIGS. 20a-20b, the filter identification error is evaluated as a function of the number of temporal windows Nand the stimulus bandwidth Ω. By increasing N, the projection [symbol] of h can be approximated with arbitrary precision (as shown in FIG. 20a). The estimate h can converge to [symbol] faster for a higher average spike rate (spike density D) of the neuron. At the same time, by increasing the stimulus bandwidth Ω, h itself can be approximated with arbitrary precision (as shown in FIG. 20b).

FIGS. 20a-20b show the kernel identification error of an exemplary embodiment of the disclosed subject matter. FIG. 20a shows MSE(h [symbol] ) as a function of the number of temporal windows N. The bigger the spike density D of the neuron, the faster the algorithm converges. The impulse response h is the same as in FIGS. 19a-19f, and the stimulus bandwidth is Ω=2π•100 rad/s.FIG. 20b shows MSE(ĥ,h) as a function of the stimulus bandwidth Ω. The bigger the bandwidth, the better the estimate ĥ can approximate h itself. Significant improvement can not be seen for Ω>2π•100 rad/s, which is roughly the effective bandwidth of h.

If parameters of a spiking neuron model or a sampler are not known, additional input signals can be used to derive a circuit that is Ξ-I/O-equivalent to the original circuit. For example, considering the circuit of FIG. 15(a), rewriting the t-transform obtains

$$\frac{1}{b} {\int }_{{t}_{k}}^{{t}_{k + 1}} ( u * h ) ( s ) d s = \frac{C δ}{b} - ( {t}_{k + 1} - {t}_{k} ) {\int }_{{t}_{k}}^{{t}_{k + 1}} ( u * {h}^{′} ) ( s ) d s = {q}_{k}^{′} . \\ where$$

$${h}^{′} ( t ) = h ( t ) / b \cdot t ∈ ℝ$$

$$and$$

$${q}_{k}^{′} = C δ / b - ( {t}_{k + 1} - {t}_{k} ) .$$

In the exemplary embodiments above, it can be assumed that the I/O system was relatively noiseless. Noise can be introduced at least by the channel or the sampler. With reference to the t-transform of eq. (5), the analysis described in the previous embodiments can be suitably extended to I/O systems with relatively noisy measurements.

Recall that the t-transform of an IAF neuron can be given by

∫ₜ_{ₖ}^{t}^{ₖ}⁺¹(u*h(t)dt= [symbol] [symbol] ,φₖ [symbol] =qₖ, k=1, 2, . . . , n−1, (43)

where n is the number of spikes generated by the neuron in an interval of length T. The measurements qₖ can be obtained by applying a piece-wise linear operator on the channel output v=u*h. If either th e channel or the sampler introduce an error, a noise term [symbol] can be added to the t-transform:

[symbol]

[symbol]

,φₖ [symbol] =qₖ+εₖ. (44)

Here, εₖ˜ [symbol] (0, σ²), k=1, 2, . . . , n−1. are i.i.d

In the presence of noise, identifying the projection [symbol] can introduce a certain amount of error. However, an estimate [symbol] of [symbol] can be suitable for an appropriately defined cost function. For example, a bi-criterion Tikhonov regularization problem can be formulated

$${min}_{\hat{Ph} ∈ H} {\sum }_{i = 1}^{N} {\sum }_{k = 1}^{n - 1} {( ( , {φ}_{k}^{i} ) - {q}_{k}^{i} )}^{2} + λ {‖ ‖}_{H}^{2} , \qquad ( 45 )$$

where the scalar λ>0 can provide a trade-off between the faithfulness of the identified filter projection [symbol] to measurements (qₖ)ₖ₌₁ⁿ⁻and its norm ∥ [symbol] ∥ [symbol] .

Theorem 5. Equation (19) can be solved explicitly in analytical form. A suitable solution can be achieved by

$$( ) ( t ) = {\sum }_{l = - L}^{L} {h}_{l} {e}_{l} ( t ) . \qquad ( 46 )$$

with h=(Φ^{H}Φ'λI)⁻¹Φ^{H}q, Φ=[Φ¹, Φ², . . . ; Φ^{N] and Φ}ⁱ, i=1, 2, . . . , N, as defined in eq. (15).

Proof: Since the minimizer [symbol] can be in [symbol] it can be of the form given in eq. (46). Substituting this into eq. (45),

$${min}_{h ∈ {ℂ}^{2 L + 1}} {‖ Φ h - q ‖}_{{R}^{n - 1}}^{2} + λ {‖ h ‖}_{{C}^{2 L - 1}}^{2} , \qquad ( 47 )$$

where Φ=[Φ¹, Φ², . . . ; Φ^{N}] with Φⁱ, i=1, 2, . . . , N, as defined in eq. (15). This quadratic optimization problem can be solved analytically by expressing the objective as a convex quadratic function J(h)=h^{H}Φ^{H}Φh−q^{H}Φh+q^{H}q+λh^{H}h with H denoting the conjugate transpose. A vector h can minimize J if ∇J=2(Φ^{H}Φ+λI)h−2Φ^{H}q=0, i.e., h=(Φ^{H}Φ+λI)⁻¹Φ^{H}q.

Remark 6. As described above, identification of the projection ( [symbol] )(t)=Σ_{l=-L}^{L}hₗeₗ(t) can amount to finding [symbol] h∈ [symbol] such that the sum of the residuals ( [symbol] [symbol] , Φₖ [symbol] −qₖ)² can be minimized In other words, an unconstrained convex optimization problem of the form

$${min}_{ph ∈ H} {\sum }_{i = 1}^{N} {\sum }_{k = 1}^{n - 1} {( 〈 Ph , {φ}_{k}^{i} 〉 - {q}_{k}^{i} )}^{2} {min}_{h ∈ {ℂ}^{2 L - 1}} {‖ Φ h - q ‖}_{{ℝ}^{n - 1}}^{2} . \qquad ( 48 )$$

where h=[h_{-L}, . . . , h_{L]} and Φ=[Φ¹; Φ²; . . . ; Φ^{N}] with Φⁱ, i=1, 2, . . . , N, as defined in eq. (15).

### Example

### Noisy SISO Filter-IAF Neural Circuit

In an exemplary embodiment, noise can be added to the measurements(qₖⁱ)ₖ₌₁⁻¹, i=1, 2, by the neuron, and the noise can be represented by introducing randomized thresholds that are normally distributed with a mean δ and a standard deviation 0.1δ, i.e., δₖ˜ [symbol] (δ, (0.1δ)²):

∫ₜ_{ₖ}^{k}⁺¹(uⁱ*h)(t)dt=Cδₖ−b(tₖ₊₁ⁱ−tₖⁱ)=[Cδ−b(tₖ₊₁ⁱ−tₖⁱ)]+C(δₖ−δ)=qₖⁱ+εₖⁱ, (49)

Thus, the randomized thresholds can result in additive noise εₖⁱ˜ [symbol] (0,(0.1Cδ)²), i=1,2.

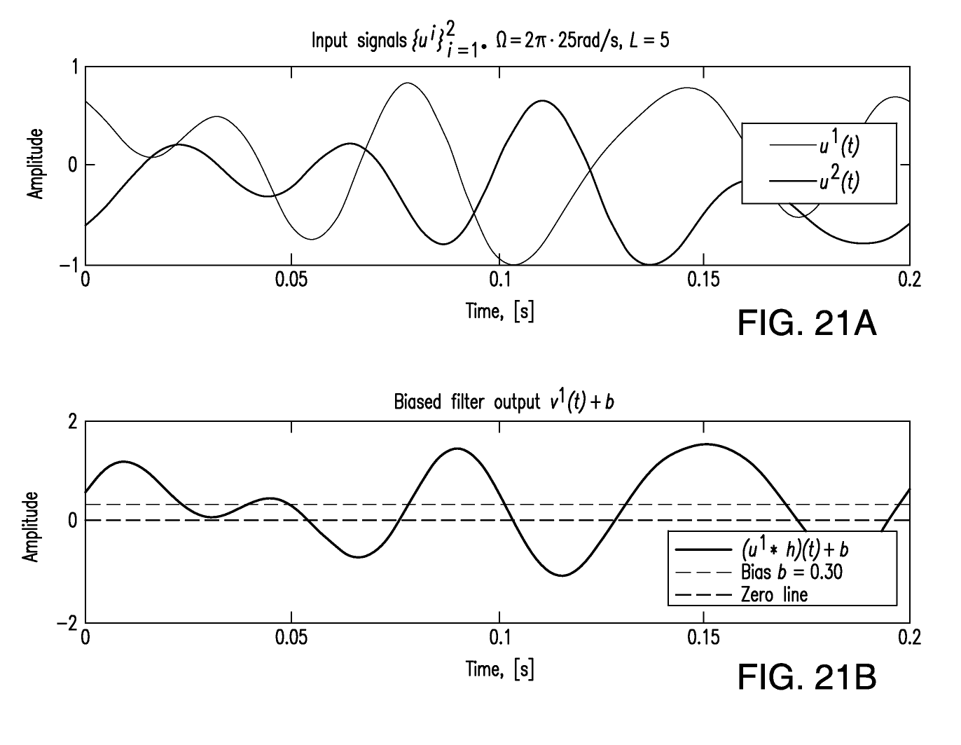

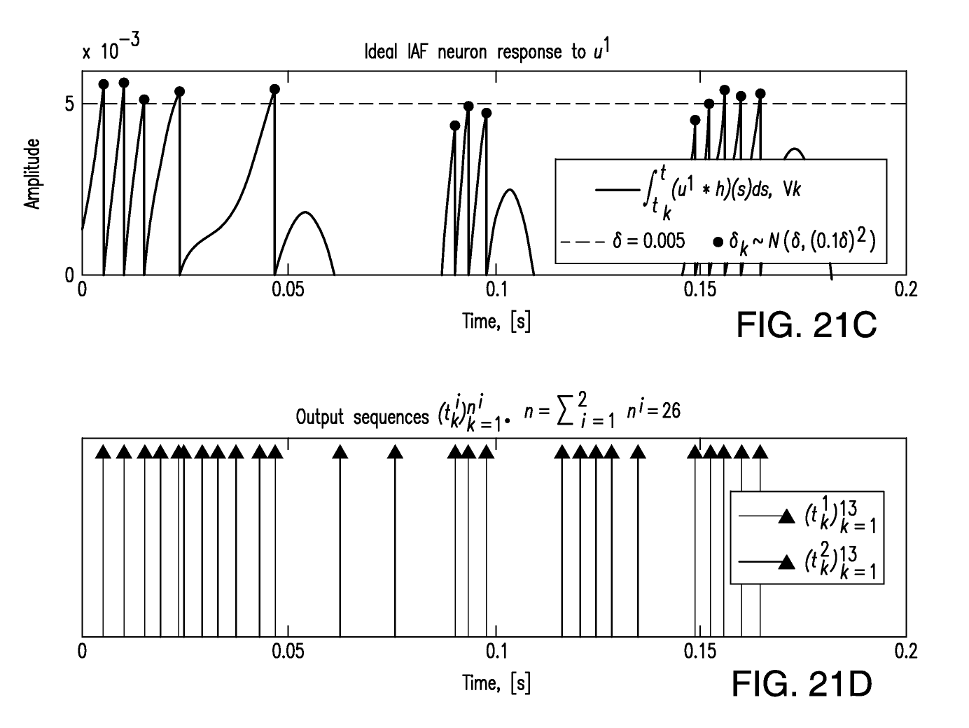

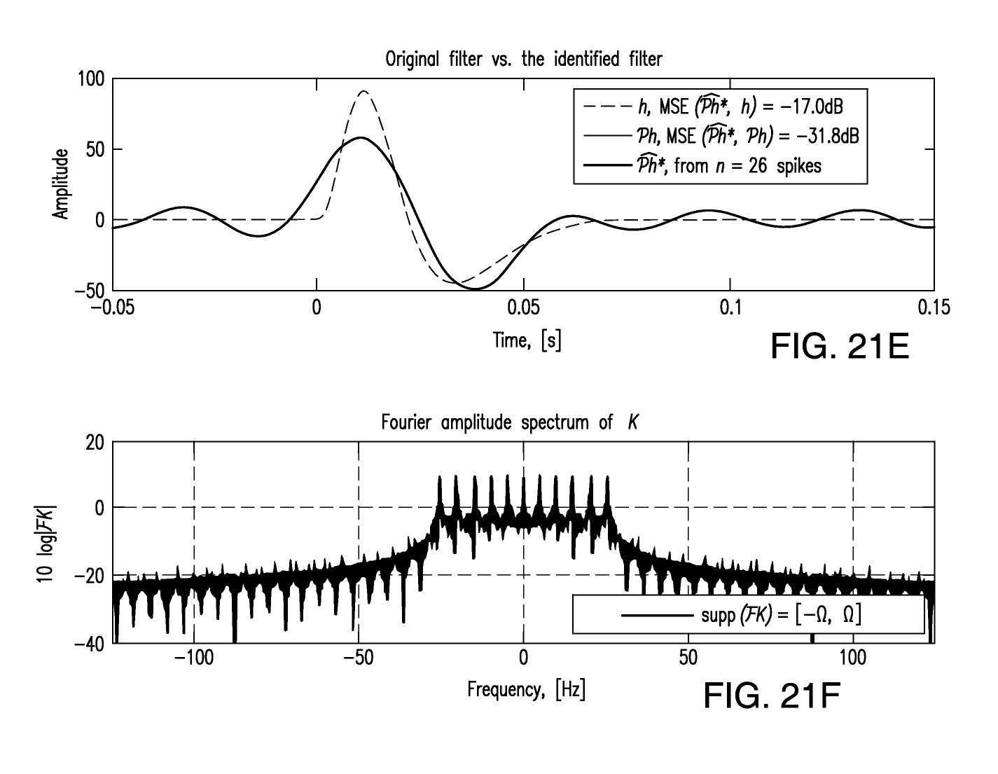

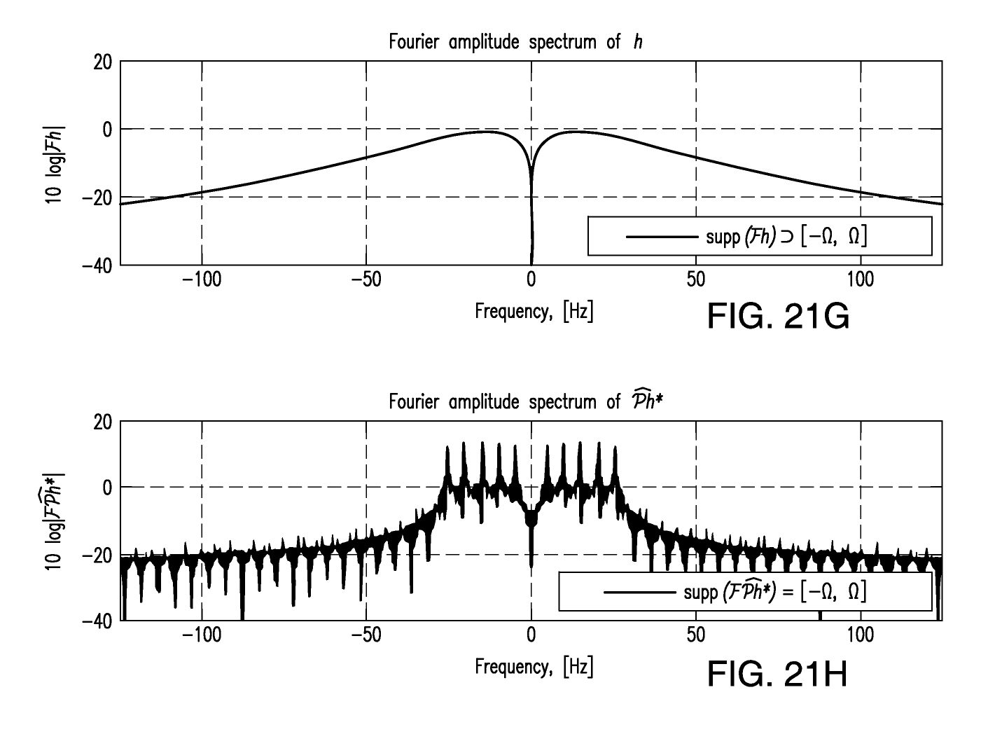

FIGS. 21a-21h show results of noisy channel identification in an exemplary SISO Filter-IAF circuit using multiple I/O pairs. FIG. 21a shows two stimuli, represented as input signals u¹•u² that can be used to probe the Filter-IAF circuit, Both stimuli can be bandlimited to 25 Hz and can have a period T=0.2 s, such that the order of the space can be L=5. The response of the neuron to a biased filter output v¹(t)+b of FIG. 21b is shown in FIG. 21c. The thresholds shown in FIG. 21c are randomized with δₖ˜ [symbol] , δ, (0.1δ)²). As shown in FIG. 21d, the neuron can produce at least 26 spikes in response to the stimuli. In FIG. 21e, the estimate [symbol] * is shown with the original filter h and its projection [symbol] . The MSE of identification is −31.8 dB. In FIGS. 21a-21h, deviations in thresholds δₖaround the mean value of δ=0.05 are shown. FIGS. 21f-21h show Fourier amplitude spectra of K, h, and [symbol] * supp ( [symbol] K)=[−Ω, Ω]=supp( [symbol] [symbol] *) but supp( [symbol] h)⊃[−Ω, Ω], so [symbol] * ∈ [symbol] but h∉ [symbol] . Although a significant amount of noise can be introduced into the system, a suitable estimate [symbol] *, can be identified, which is relatively close to the true projection [symbol] .

As an example and not by way of limitation, as shown in FIG. 22, the computer system having architecture 2100 can provide functionality as a result of processor(s) 2101 executing software embodied in one or more tangible, computer-readable media, such as memory 2103. The software implementing various embodiments of the present disclosure can be stored in memory 2103 and executed by processor(s) 2101. A computer-readable medium can include one or more memory devices, according to particular needs. Memory 2103 can read the software from one or more other computer-readable media, such as mass storage device(s) 2135 or from one or more other sources via communication interface. The software can cause processor(s) 2101 to execute particular processes or particular parts of particular processes described herein, including defining data structures stored in memory 2103 and modifying such data structures according to the processes defined by the software. An exemplary input device 2133 can be, for example, a sensor to provide signal data to the input interface 2123. An exemplary output device 2134 can be, for example, a wire or wireless transmitter or other suitable device for providing a signal from the output interface 2124. In addition or as an alternative, the computer system can provide functionality as logic hardwired or otherwise embodied in a circuit, including but not limited to an integrated circuit or FPGA, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The foregoing merely illustrates the principles of the disclosed subject matter. Various modifications and alterations to the described embodiments will be apparent to those skilled in the art in view of the teachings herein. It will be appreciated that those skilled in the art will be able to devise numerous modifications which, although not explicitly described herein, embody its principles and are thus within its spirit and scope.

1. A method for identification of at least one parameter of a sampling system, comprising:
transmitting at least one input signal to at least one channel of the sampling system;
measuring at least one output signal of the sampling system in response to sampling of the at least one input signal by the receiver; and
determining, using a processor, the at least one parameter of the sampling system using the at least one input signal and the at least one output signal of the sampling system.

2. The method of claim 1, wherein at least one input signal comprises a single input signal, and determining the at least one parameter of the sampling system includes:
measuring a plurality of windows of a single output signal in response to sampling of the single input signal; and
determining, using a processor, the at least one parameter of the sampling system using the single input signal and the plurality of windows of the single output signal.

3. The method of claim 1, wherein the sampling system comprises a time encoding machine (TEM) and the output signal comprises a time sequence.

4. The method of claim 3, wherein the TEM comprises a filter and the at least one parameter comprises an impulse response of the filter.

5. The method of claim 1, further comprising initializing a counter to an initial value.

6. The method of claim 5, wherein determining the at least one parameter of the sampling system includes determining measurements of filter projections using the at least one input signal and the output signal.

7. The method of claim 6, further comprising determining whether a number of measurements of the filter projections is greater than or equal to a threshold value.

8. The method of claim 7, further comprising, if the number of measurements of filter projections is greater than or equal to the threshold value, determining coefficients representing the filter.

9. The method of claim 8, further comprising identifying a projection of the filter onto an input space.

10. The method of claim 9, further comprising approximating the original filter using the projection projected on a new input signal or a new input signal space.

11. The method of claim 7, further comprising, if the number of measurements of filter projections is less than the threshold value,
incrementing the counter;
transmitting at least one further input signal to at least one channel of the sampling system;
measuring at least one further output signal of the sampling system in response to sampling of the at least one further input signal by the receiver; and
determining, using a processor, the at least one parameter of the sampling system using the at least one input signal, the at least one further input signal, the output signal and the at least one further output signal.

12. A system for identification of at least one parameter relating to a sampling system in response to at least one input signal, comprising:
a sampling system having at least one input channel and adapted to receive the at least one input signal thereon and an output channel to generate at least one output signal corresponding to the received at least one input signal; and
a processor, coupled to the sampling system, for transmitting the at least one input signal to the sampling system, measuring the at least one output signal of the sampling system, and determining the at least one parameter of the sampling system using the at least one input signal and the at least one output signal.

13. The system of claim 12, wherein sampling system comprises a time encoding machine (TEM) and the at least one output signal comprises a time sequence.

14. The system of claim 12, wherein the at least one input channel is a single input channel.

15. The system of claim 12, wherein the at least one input channel is a plurality of input channels.

16. The system of claim 12, wherein the at least one input signal is an element of a Hilbert space.

17. The system of claim 16, wherein the at least one input signal is an element of a Reproducing Kernel Hilbert space.

18. The system of claim 17, wherein the at least one input signal is an element of a space of trigonometric polynomial signals.

19. The system of claim 17, wherein the at least one input signal is an element of a Paley-Wiener space.

20. The system of claim 17, wherein the at least one input signal is an element of a Sobolev space.

21. The system of claim 13, wherein the TEM comprises a filter and the at least one parameter comprises an impulse response of the filter.

22. The system of claim 13, wherein the TEM comprises an integrate-and-fire neuron in series with the filter.

23. The system of claim 13, wherein the TEM comprises a Hodgkin-Huxley neuron in series with the filter.

24. The system of claim 13, wherein the TEM comprises an irregular sampling system.

25. The system of claim 23, the Hodgkin-Huxley neuron having multiplicative coupling.

26. The system of claim 12, further comprising a counter initialized to an initial value.

27. The system of claim 26, wherein the processor is adapted to determine measurements of filter projections using the at least one input signal and the at least one output signal.

28. The system of claim 27, wherein the processor is adapted to determine whether a number of measurements of the filter projections is greater than or equal to a threshold value.

29. The system of claim 28, wherein the processor is adapted to determine coefficients representing the filter if the number of measurements of filter projections is greater than or equal to the threshold value.

30. The system of claim 29, wherein the processor is adapted to identify a projection of the filter onto an input space.

31. The system of claim 30, wherein the processor is adapted to recover the filter using the projection projected on a new input signal or a new input signal space.

32. The system of claim 28, wherein the processor is adapted to, if the number of measurements of filter projections is less than the threshold value,
increment the counter;
transmit at least one further input signal to at least one channel of the sampling system;
measure at least one further output signal of the sampling system in response to sampling of the at least one further input signal by the receiver;
and determine the at least one parameter of the sampling system using the at least one input signal, the at least one further input signal, the at least one output signal and the at least one further output signal.

33. A system for identification of at least one parameter relating to a sampling system in response to at least one input signal, comprising:
a sampling system having at least one input channel and adapted to receive the at least one input signal thereon and an output channel to generate an output signal corresponding to the received at least one input signal;
means for transmitting the at least one input signal to the sampling system;
means for measuring the at least one output signal of the sampling system; and
means for determining the at least one parameter of the sampling system using the at least one input signal and the at least one output signal.
